(19) United States
(12) Patent Application Publication
(10) Pub. No.: US 2005/0202355 A1
(43) Pub. Date: Sep. 15, 2005

(54) Photothermographic material

(75) Inventor: Yasuhiro Yoshioka, Kanagawa (JP)

Correspondence Address: TAIYO CORPORATION, 2111 JEFFERSON DAVIS HIGHWAY, #412, NORTH, ARLINGTON, VA, 22202, US

(73) Assignee: FUJI PHOTO FILM CO., LTD.

(21) Appl. No.: 11/071,436

(22) Filed: Mar. 4, 2005

(30) Foreign Application Priority Data
Mar. 8, 2004 (JP) 2004-064834

(51) Int. Cl. G03C 1/00

(52) U.S. Cl. 430/619

(57) ABSTRACT

A photothermographic material, which includes: a support; and image forming layers containing a photosensitive silver halide, a non-photosensitive organic silver salt, a reducing agent, a polyhalogen compound, and a binder, on the support, wherein the number of the image forming layers provided is at least 2, at least one layer of the image forming layers contains a reducing agent represented by the following formula (I), and at least one layer of the other image forming layers contains a reducing agent represented by the following formula (II):

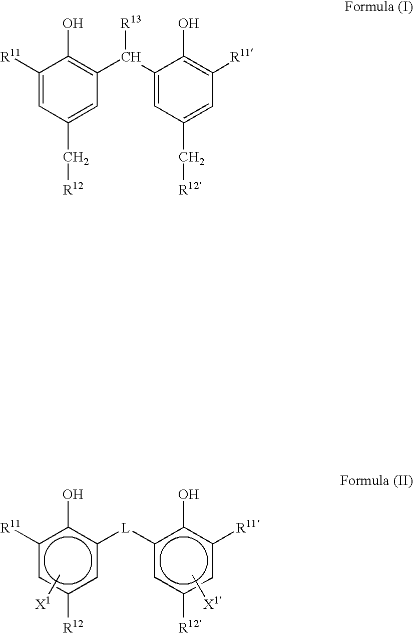

### CROSS-REFERENCE TO RELATED APPLICATIONS

This application claims priority under 35USC 119 from Japanese Patent Application No 2004-64834, the disclosure of which is incorporated herein by reference.

### BACKGROUND OF THE PRESENT INVENTION

1. Field of the Invention

The present invention relates to a photothermographic material.

2. Description of the Related Art

Reduction in the amount of processing solution waste has been strongly desired in recent years in the medical field from the viewpoints of environmental protection and space saving. Under such circumstances, technologies related to photosensitive thermal developing photographic materials for medical diagnosis and photography which can be exposed to light efficiently with a laser image setter or a laser imager, and can form a clear black image having high resolution and sharpness have been demanded. With such photosensitive photothermographic photographic materials, it is possible to supply to customers a heat development treatment system which does not requiore the use of solvent-base processing chemicals, is simpler, and does not harm the environment.

Although similar requirements also exist in the field of general image forming materials, an image for medical use is required to have high image quality excellent in sharpness and graininess, because fine representation is required. In addition, medical images are characterized in that images exhibiting a blue black image tone are preferred from the viewpoint of ease of medical diagnosis. Currently, various hard copy systems utilizing pigments or dyes such as inkjet printers and apparatuses for electrophotography have been marketed as general image forming systems. However, there is no system that is satisfactory as an output system for medical images.

A thermal image formation system utilizing an organic silver salt is described in a large number of documents. In particular, a photothermographic material generally has an image forming layer in which a catalytically active amount of a photocatalyst (e.g., silver halide), a reducing agent, a reducible silver salt (e.g., organic silver salt), and, if required, a color toner for controlling the color tone of silver are dispersed in a binder matrix. The photothermographic material is, after having been imagewise exposed, heated to a high temperature (for example, to 80° C. or higher) to form black silver images through an oxidation-reduction reaction between the silver halide or the reducible silver salt (which functions as an oxidizing agent) and the reducing agent therein. The oxidation-reduction reaction is accelerated by the catalytic action of a latent image of the silver halide generated through exposure. As a result, a black silver image is formed in an exposed area. Fuji Medical Dry Imager FM-DP L has been distributed as a medical image formation system using a photothermographic material.

Although the photothermographic material contains the foregoing components therein, the amount of silver, in particular, the silver amount is a very important concern for manufacturers. In a photothermographic material capable of providing a high-density image with a small silver amount, it is possible to economize with regard to the silver amount necessary for maintaining a given optical density, and the emulsion amount necessary for coating is reduced. Therefore, the burden of coating and drying is reduced, and productivity is ultimately improved. Further, the reduction of the silver amount enables a reduction in the cost of the photosensitive material. However, it is very difficult to maintain or improve photographic performance while reducing the silver amount. Thus, there has been a demand for an effective technology for improvement in this regard.

As one means for solving this problem, a “silver-saving agent” described in Japanese Patent Application Laid-Open (JP-A No.) No. 2002-6443 and JP-A No. 2002-131864 has been discovered. Addition of the silver-saving agent can reduce the silver amount, and can improve image density.

However, the silver-saving agent contains a specific structure of a hydrazine derivative compound, an olefin compound, or the like, and also has a function as a nucleating agent in terms of structure. Namely, the result is as if a nucleating agent has been added therein, whereby the storage stability is reduced, and thus the occurrence of fogging and the deterioration of print-out performance have come to be regarded as problems. Further, when the nucleating agent is used, a latent image grows significantly around the substance serving as a nucleus, whereby a black silver image is formed. As a result, the graininess of image quality tends to be deteriorated.

It is very difficult to improve the graininess of image quality while improving image density. Thus, there has been a great demand for solving this problem.

### SUMMARY OF THE INVENTION

It is therefore an object of the present invention to provide a photothermographic material which achieves both a high image density and improvement of graininess of image quality.

A first aspect of the present invention is to provide a photothermographic material, comprising: a support; and image forming layers containing a photosensitive silver halide, a non-photosensitive organic silver salt, a reducing agent, and a binder, provided on the support, wherein: the number of the image forming layers provided is at least two, different layers of the image forming layers each independently contain a different reducing agent, at least one layer of the image forming layers contains a reducing agent represented by the following formula (I); and at least one layer of the other image forming layers contains a reducing agent represented by the following formula (II):

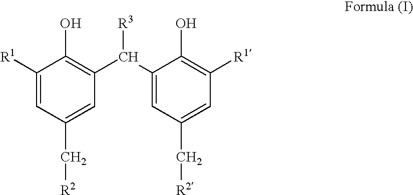

where in the formula, R¹ and R^{1′} each independently represent a secondary or tertiary alkyl group having 3 to 20 carbon atoms; R² and R^{2′} each independently represent hydrogen atom or a group linked via a nitrogen, oxygen, phosphorus, or sulfur atom; and R³ denotes hydrogen atom or an alkyl group having 1 to 20 carbon atoms:

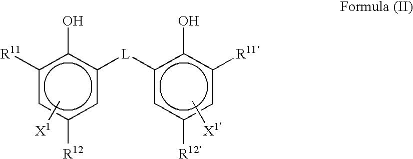

where in the formula, R¹¹ and R^{11′} each independently represent an alkyl group having 1 to 20 carbon atoms; R¹² and R^{12′} each independently represent hydrogen atom or a substituent substitutable on a benzene ring; L represents an —S— group or a —CHR¹³—group; R¹³ represents hydrogen atom or an alkyl group having 1 to 20 carbon atoms; and X¹ and X^{1′} each independently represent hydrogen atom or a group substitutable on a benzene ring.

### DETAILED DESCRIPTION OF THE INVENTION

As a result of a close study, the present inventors successfully increased image density while enhancing the graininess by providing two or more image forming layers and adopting such a design as to effect nucleation at a portion subjected to a large amount of exposure.

In the present invention, one image forming layer is configured to have an increased sensitivity, and to react sensitively to light. The other image forming layers are configured to have a reduced sensitivity, and to undergo nucleation at a portion subjected to a large amount of exposure, resulting in the formation of a black image. Thus, in the present invention, in the two or more image forming layers, the functions are shared among the respective layers. In the photothermographic material of the invention, having the foregoing configuration, fogging is less likely to occur at a portion subjected to a small amount of exposure, and an image corresponding to the exposure amount is produced with fidelity while reflecting a slight difference in exposure amount. At the portion subjected to a large amount of exposure, a high-density black image is sharply depicted. When a nucleating agent is used, a latent image grows significantly around a substance serving as a nucleus. As a result, the graininess of image quality tends to be deteriorated. However, at the portion subjected to a large amount of exposure, the graininess is less likely to become a problem. Therefore, in the photothermographic material of the invention, the depicted image is also very excellent in graininess, in contrast to a case where a monolayered structure is adopted and a nucleating agent is used.

Further study regarding a nucleating agent in such a configuration has shown that a reducing agent having a specific structure has a nucleating function. One image forming layer is allowed to contain a reducing agent exhibiting a nucleating effect, and the other image forming layer is allowed to contain a reducing agent which is less likely to cause nucleation (or, which produces a smaller nucleating function than the one reducing agent even when it does cause nucleation). This results in a photothermographic material providing high image density and excellent graininess of image quality.

In particular, it is very effective in the present invention to provide two or more image forming layers having different sensitivities, and moreover, to adjust the relationship between the reducing agent having a nucleating function and the reducing agent exhibiting a small nucleating function as described above.

The photothermographic material of the invention includes: a support; and image forming layers containing a photosensitive silver halide, a non-photosensitive organic silver salt, a reducing agent, and a binder, provided on the support, characterized in that the number of the image forming layers provided is at least 2, different layers of the image forming layers each independently contain a different reducing agent, and at least one layer of the image forming layers contains the reducing agent represented by the formula (I), and at least one layer of the other image forming layers contains the reducing agent represented by the formula (II).

First, the layer configuration of the photothermographic material of the invention will be described. Then, the constituent components of the respective layers will be described.

1. Layer Configuration

The photothermographic material of the invention has at least two image forming layers. At least two image forming layers are preferably disposed adjacent to each other. Further, at least the two layers of the image forming layers each independently contain a different reducing agent. One image forming layer contains a reducing agent represented by the formula (I), and the other image forming layer contains a reducing agent represented by the formula (II).

The order of layout of the respective image forming layers does not matter. However, the image forming layer with a high sensitivity is preferably disposed closer to an exposure light source. In the present invention, the sensitivity denotes the inverse of an exposure amount capable of providing an optical density of a minimum image density (Dmin)+2.0. When the the sensitivity of photothermographic material including two or more image forming layers provided therein is determined, calculation is carried out in the following manner. A sample, from which the silver halide other than that contained in the image forming layer targeted for determination is removed, is manufactured, and then, exposed and developed. The density of the resulting image is determined by means of a Macbeth densitometer.

In the two or more image forming layers which have different sensitivities, preferably, the image forming layer on the high sensitivity side contains the reducing agent represented by the formula (II), and the image forming layer on the low sensitivity side contains the reducing agent represented by the formula (I).

As Parameters affecting sensitivity may include, for example, the grain size of silver halide, spectral sensitization, chemical sensitization, and the like. In addition, parameters affecting the apparent sensitivity, may include the addition of a thermal solvent, changing of the type of a polyhalogen or the type of a development accelerator, and the like.

Specific examples of a case where the sensitivity is increased may include a cases where (1) the grain size of the silver halide is increased; (2) spectral sensitization/chemical sensitization is performed on the silver halide; (3) a thermal solvent is added; (4) the amount of a polyhalogen to be added is reduced; and (5) the amount of a development accelerator to be added is increased. Preferably, additives of the cases (1) to (5) or the like are used for the one image forming layer, resulting in a high sensitivity image forming layer, and additive which have undergone the reverse formulation from the cases (1) to (5) are used to form a low sensitivity image forming layer. Then, it is preferable to include the foregoing polyhalogen compound content and the development accelerator.

In general, a non-photosensitive layers can be classified according to their positions into (a) a surface protective layer to be provided on the image forming layer (on the side more distant from the support); (b) an intermediate layer to be provided between a plurality of image forming layers or between an image forming layer and the protective layer; (c) an undercoat layer to be provided between an image forming layer and the support; and (d) a back layer to be provided on a side opposite from the image forming layers.

In the present invention, as the non-photosensitive layers, the second surface protective layer (a), the intermediate layer (b), the undercoat layer (c), and the back layer (d) may also be respectively provided. These may each independently be composed of a monolayer or a plurality of layers.

Alternatively, a layer serving as an optical filter may also be provided and may be provided as the non-photosensitive layer (a) or (b). An antihalation layer may be provided in the photosensitive material as the layer (c) or (d).

The photothermographic material of the invention may be either a single-sided type having image forming layers on only one side of the support, or a double-sided type having image forming layers on both sides of the support. In the case of the double-sided type, it is acceptable that the reducing agent represented by the formula (I) is used for one side, and that the reducing agent represented by the formula (II) is used for the other side. Alternatively, it is also acceptable that the image forming layer containing the reducing agent represented by the formula (I) and the other image forming layer containing the reducing agent represented by the formula (II) are disposed on the one side.

A multicolor photosensitive thermal developing photographic material may be configured such that it contains a combination of these two layers for each color, or may contain all ingredients in a single layer as described in U.S. Pat. No. 4,708,928. In the case of a multiple-dye multicolor photosensitive thermal developing photographic material, respective emulsion layers are generally kept in such a relation as to be distinct from each other by using a functional or nonfunctional barrier layer between the respective photosensitive layers as described in U.S. Pat. No. 4,460,681.

(1) Single-Sided Photothermographic Material

In the case of the single-sided type, the back layer is preferably provided on the side (which is hereinafter referred to as a back side) of the support opposite to the side having the image forming layer.

The single-sided photothermographic material in the present invention can be used as a mammographic X-ray sensitive material. It is important that the single-sided photothermographic material to be used for the object of the invention is designed so as to provide an image with a contrast within a proper range.

In the case of the preferred constituent features as the mammographic X-ray sensitive material, JP-A Nos. 5-45807, 10-62881, 10-54900, and 11-109564 can serve as references, the disclosures of which are incorporated by reference herein.

(2) Double Sided Type Photothermographic Material

The photothermographic material of the invention can be preferably used for an image formation method for recording an X-ray image using an X-ray intensifying screen.

The process of forming an image using the photothermographic material includes the following steps:
(a) a step of setting the photothermographic material between a pair of X-ray intensifying screens, and thereby obtaining an assembly for image formation;
(b) a step of arranging a specimen between the assembly and an X ray source;
(c) a step of irradiating the specimen with an X ray having an energy level within a range of 25 kVp to 125 kVp;
(d) a step of taking out the photothermographic material from the assembly; and
(e) a step of heating the photothermographic material taken at a temperature within a range of 90° C. or more to 180° C. or less.

The photothermographic material for use in the assembly in the present invention is preferably prepared so as to provide, when subjected to stepwise exposure with an X ray and heat development, an image having a characteristic curve on rectangular coordinates equal in coordinate unit length of the optical density (D) and the exposure amount (logE), in which the mean gamma (γ) formed between the point of the minimum density (Dmin)+density 0.1 and the point of the minimum density (Dmin)+density 0.5 is 0.5 to 0.9, and the mean gamma (γ) formed between the point of the minimum density (Dmin)+density 1.2 and the point of the minimum density (Dmin)+density 1.6 is 3.2 to 4.0. Use of the photothermographic material having such a characteristic curve for the X ray photographing system can result in an X-ray image having excellent photographic properties such as a very elongated leg and high gamma in the medium density region. The photographic properties advantageously result in the favorable descriptive property of the low density region such as the mediastinum portion or the shadow of the heart, which allows a small amount of X-rays to be transmitted therethrough, also the easy-to-view density of the image of the lung field which allows a large amount of X-rays to be transmitted therethrough, and the favorable contrast.

The photothermographic material having the foregoing preferred characteristic curve can be manufactured with ease in the following manner. For example, each of the image forming layers on both sides is composed of two or more layers of silver halide emulsion layers having mutually different sensitivities. Particularly, each image forming layer is preferably formed by using a high sensitivity emulsion for the upper layer, and using an emulsion having a low sensitivity and hard photographic properties for the lower layer. The difference in sensitivity of the silver halide emulsion between the respective layers when such image forming layers composed of two layers are used is 1.5 times or more and 20 times or less, and preferably 2 times or more to 15 times or less. Incidentally, the ratio of the amounts of the emulsions to be used for forming the respective layers varies according to the difference in sensitivity between the emulsions to be used and the covering power. In general, the larger the sensitivity difference is, the more the ratio of the emulsion on the high sensitivity side to be used is reduced. For example, the preferred ratio of the respective emulsions to be used when the sensitivity difference is two times is controlled so as to be a value within a range of 1:20 or more to 1:50 or less in terms of the ratio of high sensitivity emulsion to low sensitivity emulsion in the silver equivalent amount in the case where the covering powers are roughly equal.

For the techniques of crossover cut (double-sided photosensitive material) and antihalation (single-sided photosensitive material), the dyes or the dyes and the mordants described in JP-A No. 2-68539, the disclosure of which is incorporated by reference herein, line 1 in the lower left column, page 13, to line 9 in the lower left column, page 14, may be used.

Then, the fluorescent intensifying paper (radiation intensifying screen) of the invention will be described. The radiation intensifying screen is composed, as a basic structure, of a support and a phosphor layer formed on one side thereof. The phosphor layer is a layer containing a phosphor dispersed in a binder. A transparent protective layer is generally provided on the surface of the phosphor layer opposite to the support (the surface on the side not facing the support) to protect the phosphor layer from chemical change in quality and physical impact.

In the present invention, as preferred phosphors, mention may be made of the following ones: tungstate type phosphors (CaWO₄, MgWO₄, CaWO₄:Pb, and the like), terbium-activated rare earth element oxysulfide type phosphors (Y₂O₂S:Tb, Gd₂O₂S:Tb, La₂O₂S:Tb, (Y,Gd)₂O₂S:Tb, (Y,Gd)O₂S:Tb, Tm, and the like), terbium-activated rare earth element phosphate type phosphors (YPO₄:Tb, GdPO₄:Tb, LaPO₄:Tb, and the like) terbium-activated rare earth element oxyhalide type phosphors (LaOBr:Tb, LaOBr:Tb, Tm, LaOCl:Tb, LaOCl:Tb, Tm, LaOBr:Tb, GdOBr:Tb, GdOCl:Tb, and the like), thulium-activated rare earth element oxyhalide type phosphors (LaOBr:Tm, LaOCl:Tm, and the like), a barium sulfate type phosphors (BaSO₄:Pb, BaSO₄:Eu²⁺, (Ba, Sr)SO₄:Eu²⁺, and the like), bivalent europium-activated alkaline earth metal phosphate type phosphors ((Ba₂PO₄)₂:Eu²⁺, (Ba₂PO₄)₂:Eu²⁺, and the like), bivalent europium-activated alkaline earth metal fluorohalide type phosphors (BaFCl:Eu²⁺, BaFBr:Eu²⁺, BaFCl:Eu²⁺, Tb, BaFBr:Eu²⁺, Tb, BaF₂.BaCl.KCl:Eu²⁺, (Ba, Mg)F₂.BaCl.KCl:Eu²⁺, and the like), iodide type phosphors (CsI:Na, CsI:Tl, NaI, KI:Tl, and the like), sulfide type phosphors (ZnS:Ag, (Zn, Cd) S:Ag, (Zn, Cd)S:Cu, (Zn, Cd)S:Cu, Al, and the like), hafnium phosphate type phosphors (HfP₂O₇:Cu, and the like), and YTaO₄, and the ones obtained by adding various activators thereto as luminescent centers. However, the phosphors for use in the present invention are not limited thereto, and any phosphors are usable so long as they are the phosphors showing light emission in the visible or near-ultraviolet region through irradiation with a radiation.

The fluorescent intensifying paper for use in the present invention is preferably filled with a phosphor in a gradient particle diameter structure. In particular, preferably, large-diameter phosphor particles are applied on the surface protective layer side, and small-diameter phosphor particles are applied on the support side. Preferably, the diameter of the small-diameter particle is in the range of 0.5 μm or more to 2.0 μm or less, and the diameter of the large-diameter particle is in the range of 10 μm or more to 30 μm or less.

As an image formation method using the photothermographic material of the invention, a method for forming an image by the combination with a phosphor having a main peak at 400 nm or less may be preferably used. A method for forming an image by the combination with a phosphor having a main peak at 380 nm or less is further preferably used. Either of the double-sided photosensitive material and the single-sided photosensitive material may be used in the form of an assembly. As the screen having a main light emission peak at 400 nm or less, the screens described in JP-A No. 6-11804 and WO 93/01521, and the like are used, but the usable screens are not limited thereto. As the techniques of ultraviolet crossover cut (double-sided photosensitive material) and antihalation (single-sided photosensitive material), the techniques described in JP-A No. 8-76307 are usable. The ultraviolet absorbing dyes are in particular preferably the dyes described in JP-A No. 2001-144030, the disclosure of which is incorporated by reference.

2. Constituent Components of Respective Layers

(Explanation of Reducing Agent)

The photothermographic material of the invention contains the reducing agent represented by the following formula (I) and the reducing agent represented by the following formula (II) in different image forming layers. Below, the reducing agent represented by the formula (I) and the reducing agent represented by the formula (II) will be described in details.

(1) Reducing Agent Represented by the Formula (I)

One of the reducing agents for use in the present invention is the compound represented by the following formula (I):

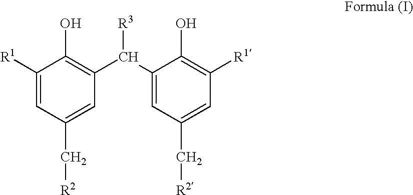

In the formula (I), R¹ and R^{1′} each independently represents a secondary or tertiary alkyl group having 3 to 20 carbon atoms; R² and R^{2′} each independently represent hydrogen atom or a group linked via a nitrogen, oxygen, phosphorus, or sulfur atom; and R¹³ represents hydrogen atom or an alkyl group having 1 to 20 carbon atoms.

The formula (I) will be described in details. R¹ and R^{1′} are preferably secondary or tertiary alkyl groups having 3 to 12 carbon atoms. Specifically, isopropyl group, tert-butyl group, tert-amyl group, 1,1,-dimethylpropyl group, 1,1-dimethylbutyl group, 1,1-dimethylhexyl group, 1,1,3,3-tetramethylbutyl group, 1,1-dimethyldecyl group, 1-methylcyclohexyl group, tert-octyl group, 1-methylcyclopropyl group, and the like are preferred. Tert-butyl group, tert-amyl group, tert-octyl group, and 1-methylcyclohexyl group are more preferred, and tert-butyl group is most preferred.

R² and R^{2′} are each more preferably hydrogen atom, a hydroxy group, an alkoxy group, an aryloxy group, an amino group, or an anilino group. They are each further preferably hydrogen atom, methoxy group, or benzyloxy group, and in particular preferably hydrogen atom.

When R² and R^{2′} are each an aryloxy group, an arylthio group, an anilino group, a heterocyclic group, or a heterocyclic thio group, these groups may each have a substituent. The substituent may be any substituent so long as it is a group substitutable on a benzene ring or a heterocyclic ring. However, mention may be made of an alkyl group, an aryl group, a heterocyclic group, a halogen atom, an alkoxy group, a hydroxy group, an aryloxy group, an alkylthio group, an arylthio group, an amino group, an acyl group, an acyloxy group, an acylamino group, an alkoxycarbonyl group, a carbamoyl group, a sulfonyl group, a sulfonamido group, a sulfonyloxy group, a sulfamoyl group, a sulfoxide group, an ureido group, an urethane group, or the like. When R² and R^{2′} are each an alkoxy group, a carbonyloxy group, an acyloxy group, an alkylthio group, an amino group, an acylamino group, an ureido group, or an urethane group, these groups may each further have a substituent. Examples of the substituent may include an alkoxy group, an alkoxycarbonyl group, an acyloxy group, a sulfonyl group, a carbonyl group, an alkylthio group, an aryloxy group, an arylthio group, a sulfonamido group, and an acylamino group.

R³ is preferably hydrogen atom, or an alkyl group having 1 to 15 carbon atoms, and more preferably an alkyl group having 1 to 8 carbon atoms. The alkyl group is preferably methyl group, ethyl group, propyl group, isopropyl group, or 2,4,4-trimethylpentyl group. R³ is in particular preferably hydrogen atom, methyl group, ethyl group, propyl group, or isopropyl group.

Below, the specific examples of the reducing agent represented by the formula (I) of the invention will be shown. However, the invention is not limited thereto.

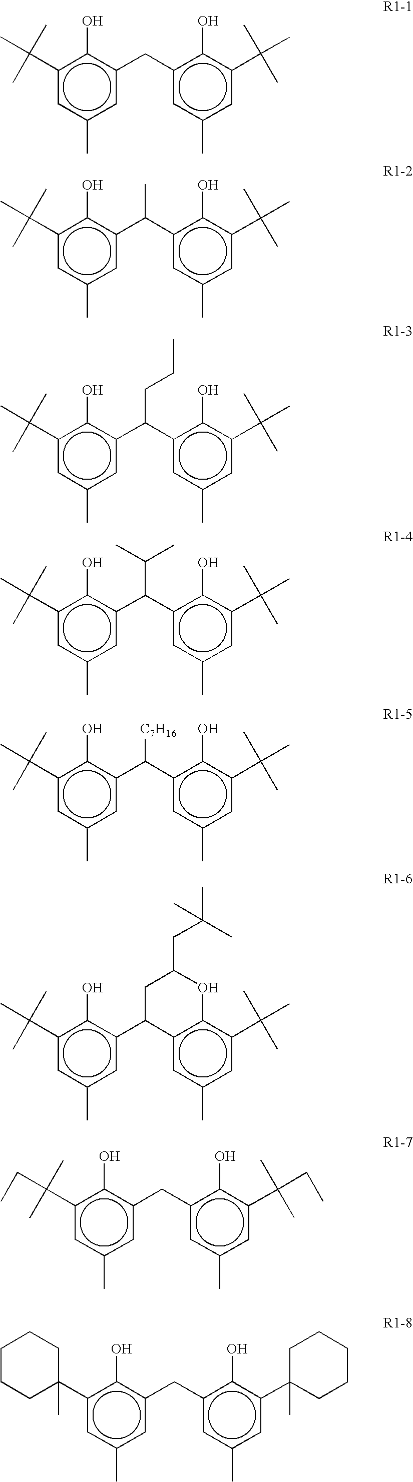

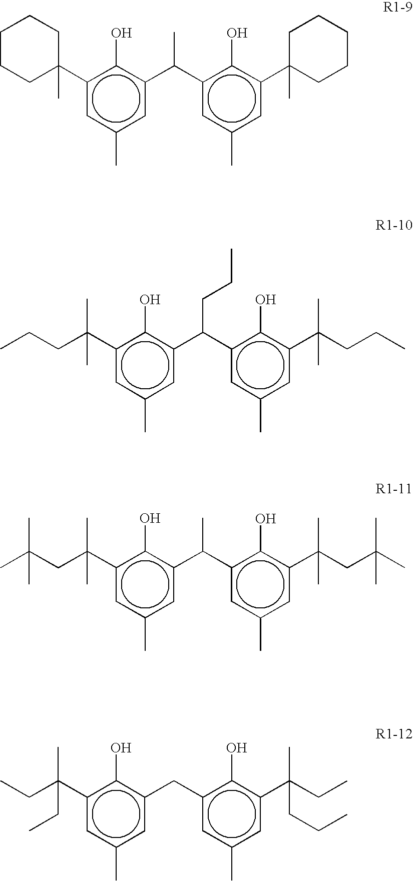

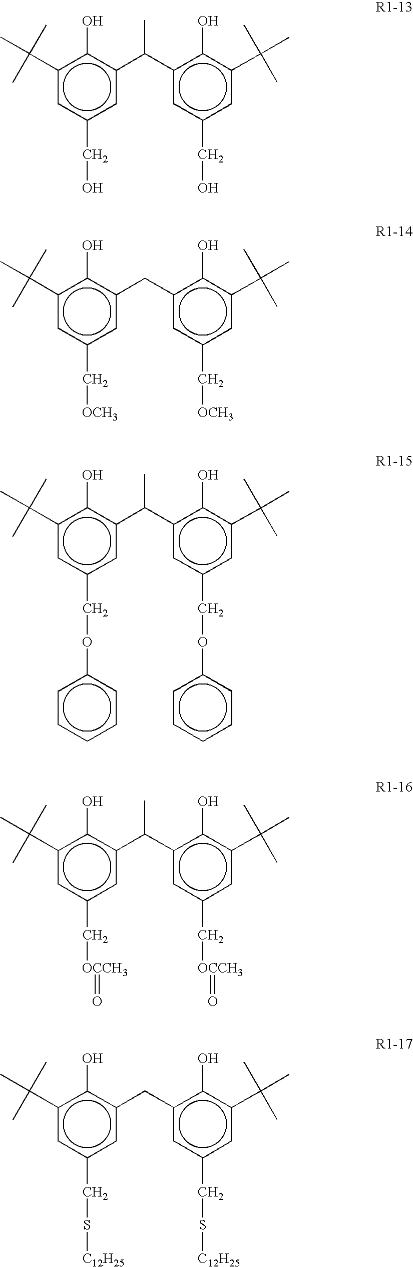

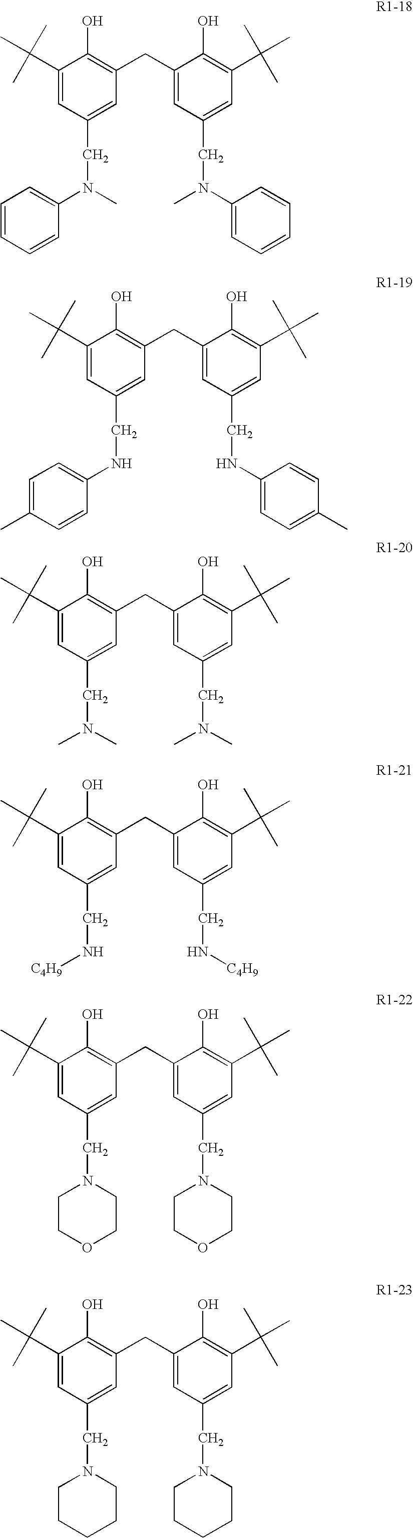

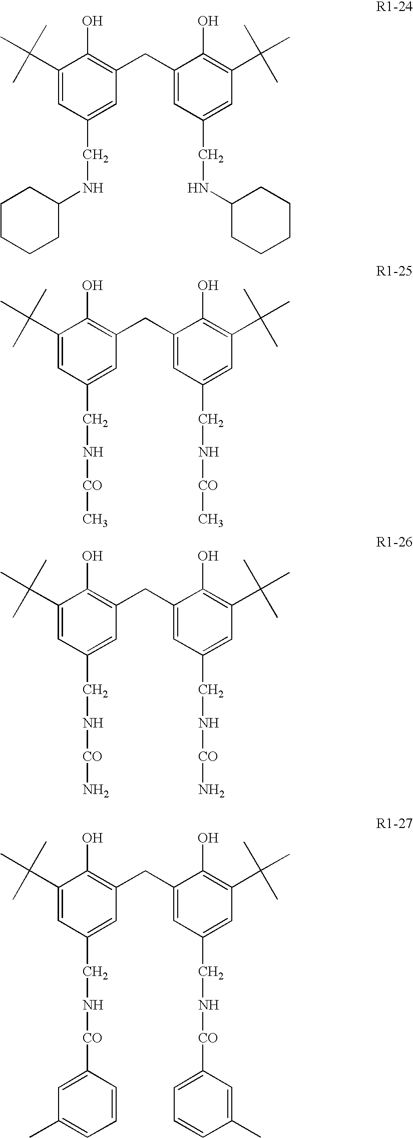

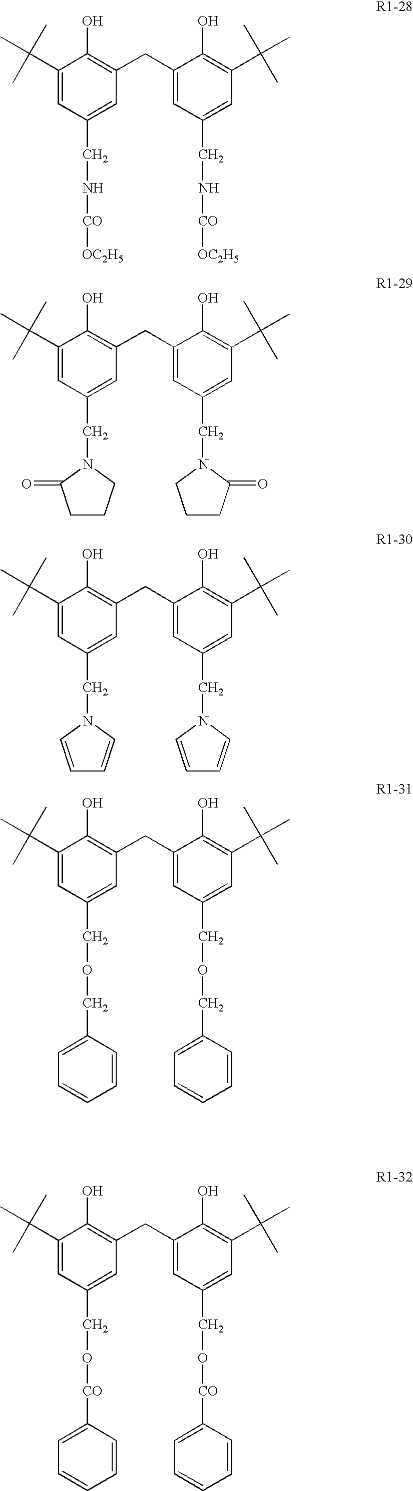

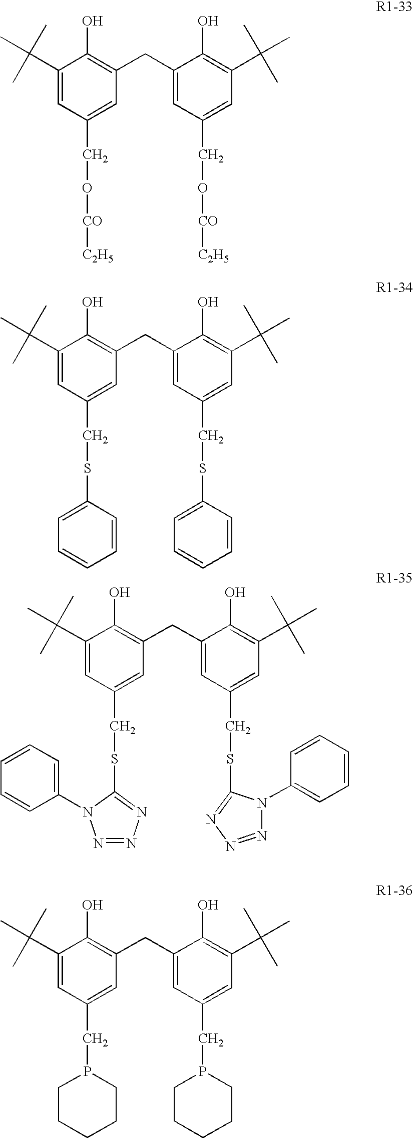

The reducing agent represented by the formula (I) is considered to be likely to undergo nucleation, and contained in at least one image forming layer. At least the other one image forming layer is allowed to contain the reducing agent represented by the formula (II) described next.

(2) Reducing Agent Represented by the Formula (II)

In the present invention, the reducing agent represented by the formula (I) is contained in at least one image forming layer, and the reducing agent represented by the formula (II) is contained in at least the other one image forming layer.

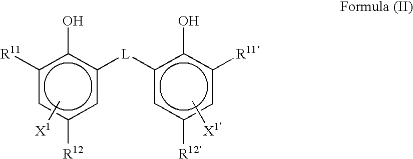

In the formula (II), R¹¹ and R^{11′} each independently represents an alkyl group having 1 to 20 carbon atoms; R¹² and R^{12′} each independently represent hydrogen atom or a substituent substitutable on a benzene ring; L represents an —S— group or a —CHR¹³-group; R¹³ represents hydrogen atom or an alkyl group having 1 to 20 carbon atoms; and X¹ and X^{1′} each independently represent hydrogen atom or a group substitutable on a benzene ring.

Herein, A few reducing agent represented by the formula (II) is also included in the compound represented by the formula (I). However, the invention exerts the effects of the invention according to the strength of the nucleating function by the reducing agent. Therefore, different reducing agents are required to be used for different image forming layers. It is also possible to add two or more types of the reducing agents represented by the formula (I) into different image forming layers, if they are different reducing agents.

The respective substituents will be described in details.

1) R¹¹ and R^{11′}

R¹¹ and R^{11′} each independently represent a substituted or unsubstituted alkyl group having 1 to 20 carbon atoms. The substituent of the alkyl group has no particular restriction, but a primary alkyl group having 1 to 20 carbon atoms is preferred. Mention may be made of an aryl group, a hydroxy group, an alkoxy group, an aryloxy group, an alkylthio group, an arylthio group, an acylamino group, a sulfonamido group, a sulfonyl group, a phosphoryl group, an acyl group, a carbamoyl group, an ester group, a halogen atom, and the like.

2) R¹² and R^{12′}, and X¹ and X^{1′}

R¹² and R^{12′} each independently represent hydrogen atom, or a substituent substitutable on a benzene ring, and X¹ and X^{1′} also each independently represent hydrogen atom, or a substituent substitutable on a benzene ring. As the respective groups substitutable on a benzene ring, preferably, mention may be made of an alkyl group, an aryl group, a halogen atom, an alkoxy group, and an acylamino group.

3) L

L represents an —S— group or a —CHR¹³-group. R¹³ represents hydrogen atom or an alkyl group having 1 to 20 carbon atoms. The alkyl group may have a substituent.

Specific examples of an unsubstituted alkyl group of R¹³ may include: methyl group, ethyl group, propyl group, butyl group, heptyl group, undecyl group, isopropyl group, 1-ethylpentyl group, and 2,4,4-trimethylpentyl group.

Examples of the substituent of an alkyl group are the same groups as those for the substituent of R¹¹, and may include: a halogen atom, an alkoxy group, an alkylthio group, an aryloxy group, an arylthio group, an acylamino group, a sulfonamido group, a sulfonyl group, a phosphoryl group, an oxycarbonyl group, a carbamoyl group, and a sulfamoyl group.

4) Preferred Substituents

R¹¹ and R^{11′} are each preferably a primary alkyl group having 1 to 15 carbon atoms. Specifically, mention may be made of methyl group, ethyl group, propyl group, butyl group, amyl group, hexyl group, or the like.

Whereas, when R¹² and R^{12′} are each an alkyl group having two or more carbon atoms, R¹¹ and R^{11′} are each preferably a secondary or tertiary alkyl group, and more preferably a tertiary alkyl group. It is most preferably tert-butyl group.

R¹² and R^{12′} are each preferably an alkyl group having 1 to 20 carbon atoms. Specific examples thereof may include: methyl group, ethyl group, propyl group, butyl group, isopropyl group, t-butyl group, t-amyl group, cyclohexyl group, 1-methylcyclohexyl group, benzyl group, methoxymethyl group, and methoxyethyl group. More preferred are methyl group, ethyl group, propyl group, isopropyl group, and t-butyl group.

Whereas, when R¹¹ and R^{11′} are each a tertiary alkyl group, R¹² and R^{12′} are each preferably an alkyl group having two or more carbon atoms, more preferably a straight-chain alkyl group having 2 to 4 carbon atoms, and in particular preferably ethyl group.

X¹ and X^{1′} are each preferably hydrogen atom, a halogen atom, or an alkyl group, and more preferably hydrogen atom.

L is preferably a —CHR¹³— group.

R¹³ is preferably hydrogen atom or an alkyl group having 1 to 15 carbon atoms. The alkyl group is preferably methyl group, ethyl group, propyl group, isopropyl group, 2,4,4-trimethylpentyl group, cyclohexyl group, or 1,3-dimethylcyclohexen-4-yl group. R¹³ is in particular preferably hydrogen atom, methyl group, propyl group, or isopropyl group.

When R¹¹ and R^{11′} are each a tertiary alkyl group, and R¹³ is hydrogen atom, R¹² and R^{12′} are each preferably an alkyl group having 2 to 5 carbon atoms. Ethyl group or propyl group is more preferred, and ethyl group is most preferred.

When R¹¹ and R^{11′} are each a primary alkyl group, and R¹³ is a primary or secondary alkyl group having 1 to 8 carbon atoms, R¹² and R^{12′} are preferably methyl groups. The primary or secondary alkyl group having 1 to 8 carbon atoms of R¹³ is more preferably methyl group, ethyl group, propyl group, isopropyl group, or cyclohexyl group, and further preferably methyl group, isopropyl group, or cyclohexyl group.

When all of R¹¹, R^{11′}, R¹², and R^{12′} are methyl groups, R¹³ is preferably a secondary alkyl group. In this case, the secondary alkyl group of R¹³ is preferably isopropyl group, isobutyl group, 1-ethylpentyl group, cyclohexyl group, or 1,3-dimethylcyclohexen-4-yl group, and more preferably isopropyl group.

Below, non-limiting specific examples of the compounds represented by the formula (R) of the invention will be shown.

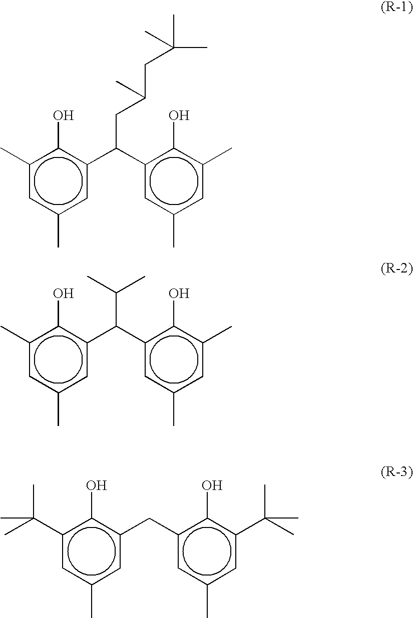

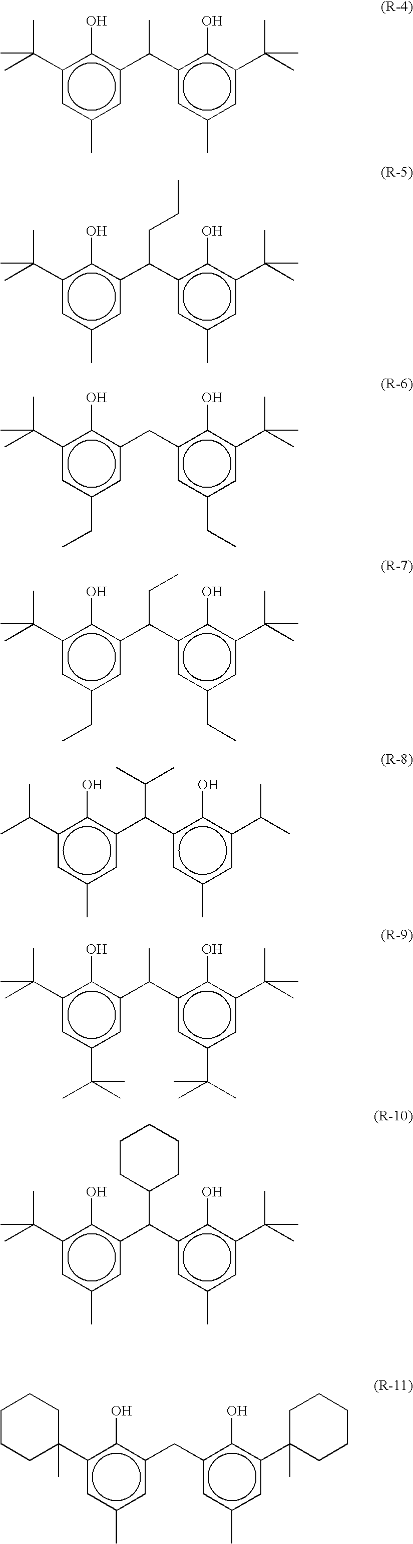

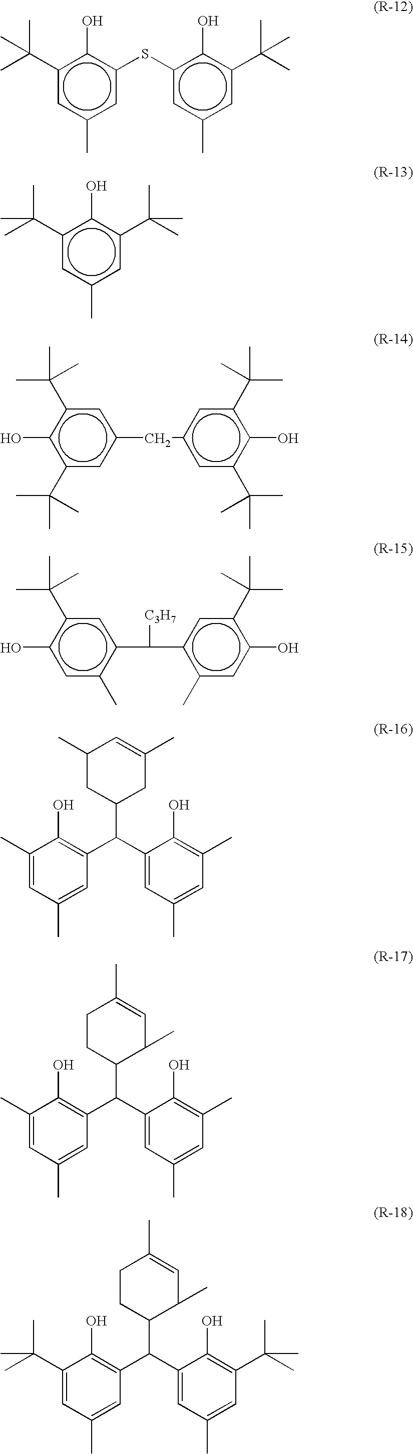

(3) Coating Amount

In the present invention, the amount of the reducing agent to be used is preferably 0.1 g/m² or more and 3.0 g/m² or less, more preferably 0.2 g/m² or more and 2.0 g/m² or less, and further preferably 0.3 g/m² or more and 1.0 g/m² or less based on the total amount of the sensitive material. The reducing agent is contained in an amount of preferably 5 mol % or more and 50 mol % or less, more preferably 8 mol % or more and 30 mol % or less, and further preferably 10 mol % or more and 20 mol % or less per mole of silver in the side having the image forming layer.

The ratio of the reducing agent represented by the formula (I) and the reducing agent represented by the formula (II) is preferably 10:90 to 90:10, and more preferably 30:70 to 70:30 in terms of the number of moles.

The reducing agent represented by the formula (I) and the reducing agent represented by the formula (II) may be used respectively alone, or in combination of two or more thereof. When these are used in combination, it is only essential that the total amount thereof falls within the foregoing preferred range.

(3) Method of Incorporation in a Coating Solution

The reducing agent of the invention may be incorporated in the coating solution with any process based on a solution form, an emulsified dispersion form, a solid fine particle dispersion form, or the like, and incorporated in the photosensitive material.

As a well-known emulsification dispersion method, mention may be made of a method in which an emulsified dispersion is mechanically prepared by dissolving the reducing agent with an oil such as dibutylphthalate, tricresyl phosphate, glyceryl triacetate or diethyl phthalate and with a co-solvent such as ethyl acetate or cyclohexanone.

Whereas, as a solid fine particle dispersion method, mention may be made of the following method. A reducing agent is dispersed in an appropriate solvent such as water by means of a ball mill, a colloid mill, a vibration ball mill, a sand mill, a jet mill, or a roller mill, or ultrasonically, thereby to form a solid dispersion. A dispersion method using a sand mill is preferred. Incidentally, at this step, a protective colloid (e.g., polyvinyl alcohol), a surface active agent (e.g., an anionic surface active agent such as sodium triisopropylnaphthalene sulfonate (a mixture of those mutually different in substitution positions of three isopropyl groups) may also be used. An antiseptic (e.g., benzisothiazolinone sodium salt) can be incorporated in a water dispersion.

The solid particle dispersion method of the reducing agent is particularly preferred. The reducing agent is preferably added in the form of fine particles with an average particle size of 0.01 μm or more to 10 μm or less, preferably 0.05 μm or more to 5 μm or less, and more preferably 0.1 μm or more to 1 μm or less. In the present invention, other solid dispersions are also preferably dispersed in the form of particles having a size within this range, and used.

(4) Other Reducing Agents Usable in Combination

The reducing agents other than the foregoing reducing agents can be used in combination. Such a reducing agent may be a given substance (preferably an organic substance) for reducing silver ions into metallic silver. Examples of the reducing agent usable in combination are described in paragraph Nos. 0043 to 0045 of JP-A No. 11-65021, and from page 7, line 34 to page 18, line 12 of EP No. 0803764A1, the disclosures of which are incorporated by reference.

In the present invention, the reducing agents are preferably so-called hindered phenol type reducing agents having substituents at the ortho positions of the phenolic hydroxyl group, or bisphenol type reducing agent. Examples of the other preferred reducing agents are the compounds described in JP-A Nos. 2001-188314, 2001-209145, 2001-350235, 2002-156727, and EP No. 1278101A2, the disclosures of which are incorporated by reference.

(Explanation of Organic Silver Salt)

1) Composition

The organic silver salt usable in the present invention is a silver salt, which is relatively stable to light, but functions as a silver ion source, and forms a silver image when heated to 80° or higher in the presence of a photosensitive silver halide exposed to light and a reducing agent. The organic silver salt may be a given organic substance capable of supplying silver ions reducible by a reducing agent. Such non-photosensitive organic silver salts are described in paragraph Nos. 0048 to 0049 of JP-A No. 10-62899, on page 18, line 24 to page 19, line 37 of EP No. 0803764A1, EP No. 0962812A1, JP-A Nos. 11-349591, 2000-7683, 2000-72711, the disclosures of which are incorporated by reference, and the like. A silver salt of an organic acid, particularly, the silver salt of a long chain aliphatic carboxylic acid (having 10 to 30, preferably 15 to 28 carbon atoms) is preferred. Preferred examples of the fatty acid silver salt include silver lignocerate, silver behenate, silver arachidinate, silver stearate, silver oleate, silver laurate, silver caproate, silver myristate, silver palmitate, and silver erucate, and mixtures thereof. In the present invention, out of these fatty acid silvers, it is preferable to use fatty acid silvers having a silver behenate content of preferably 50 mol % or more to 100 mol % or less, more preferably 85 mol % or more to 100 mol % or less, and furthermore preferably 95 mol % or more to 100 mol % or less. Further, it is preferable to use fatty acid silvers having a silver erucate content of preferably 2 mol % or less, more preferably 1 mol % or less, and furthermore preferably 0.1 mol % or less.

The silver stearate content is preferably 1 mol % or less. By setting the silver stearate content at 1 mol % or less, it is possible to obtain a silver salt of an organic acid having low Dmin and high sensitivity and excellent in image storage stability. The silver stearate content is preferably 0.5 mol % or less, and in particular preferably, the silver stearate is substantially not contained.

Further, when the silver arachidinate is contained as the silver salt of an organic acid, the silver arachidinate content is preferably 6 mol % or less, and further preferably 3 mol % or less in obtaining low Dmin and obtaining a silver salt of an organic acid excellent in image storage stability.

2) Shape

The organic silver salt usable in the present invention has no particular restriction on its shape, and it may have any of needle-shaped, rod-shaped, tabular and flaky-shaped forms.

In the present invention, a flaky-shaped organic silver salt is preferred. Whereas, short needle-shaped, rectangular prismatic, cubic, or potato-shaped indefinite-form particles each having a ratio of length between the major axis and the minor axis of 5 or less are also preferably used. These organic silver particles have a feature of causing less fog upon heat development than with the long needle-shaped particles having a ratio of length between the major axis and the minor axis of 5 or more. In particular, the particles with a ratio between the major axis and the minor axis of 3 or less improve the mechanical stability of the resulting coating film, and hence they are preferred. In this specification, the flaky-shaped organic silver salt is defined as follows. The organic acid silver salt is observed by means of an electronic microscope, and the shape of the organic acid silver salt particle is approximated to a rectangular parallelepiped. When the sides of the rectangular parallelepiped are taken as a, b, and c in the order from the shortest (c may be equal to b), x is calculated from the shorter numerical values, a and b, and determined as follows.
x=b/a

Thus, x is determined for each of about 200 particles in this manner, and when the average value is taken as x (average), those satisfying the relationship: x (average)≧1.5, are regarded as flaky-shaped particles. Preferably, 30≧x (average)≧1.5, and more preferably, 15≧x (average)≧1.5. In this connection, needle-shaped particles satisfy the relation: 1≦x (average)<1.5.

In a flaky-shaped particle, a can be regarded as the thickness of a tabular particle having a plane with sides of b and c as the main plane. The average of a is preferably 0.01 μm or more to 0.3 μm or less, and more preferably 0.1 μm or more to 0.23 μm or less. The average of c/b is preferably 1 or more to 9 or less, more preferably 1 or more to 6 or less, furthermore preferably 1 or more to 4 or less, and most preferably 1 or more to 3 or less.

By setting the sphere equivalent diameter at 0.05 μm or more and 1 μm or less, aggregation becomes less likely to occur in the photosensitive material, resulting in favorable image storage stability. The sphere equivalent diameter is preferably 0.1 μm or more to 1 μm or less. In the present invention, the sphere equivalent diameter is measured in the following manner. A sample is directly photographed by means of an electron microscope. Then, the negative is subjected to image processing.

In the flaky-shaped particle, the sphere equivalent diameter/a of the particle is defined as an aspect ratio. The aspect ratio of the flaky-shaped particle is preferably 1.1 or more and 30 or less, and more preferably 1.1 or more and 15 or less from the viewpoints of allowing aggregation to become less likely to occur in the photosensitive material, and making the image storage stability favorable.

It is preferable that the particle size distribution of the organic silver salt is mono-dispersed. Being “mono-dispersed” corresponds to the case where the percentage of a value obtained by dividing the standard deviations of their respective lengths of a minor axis and a major axis by the lengths of the minor axis and the major axis, respectively, is preferably 100% or less, more preferably 80% or less, and furthermore preferably 50% or less. The shape of an organic silver salt can be determined from a transmission electron microscope image of the organic silver salt dispersion. As another method for determining the mono-dispesibility, there is a method of determining the standard deviation of the volume weighted average diameter of an organic silver salt. The percentage of the value obtained by dividing the standard deviation by the volume weighted average diameter (coefficient of variation) is preferably 100% or less, more preferably 80% or less, and furthermore preferably 50% or less. For example, the mono-dispersibility can be determined from the particle size (volume weighted average diameter) obtained by irradiating an organic silver salt dispersed in a solution with a laser light, and determining the autocorrelation function of fluctuation of scattered light on the basis of the change in time.

3) Preparation

To the manufacturing and dispersion methods of the organic acid silver for use in the present invention, known methods and the like can be applied. For example, the following references can serve as a reference: JP-A No. 10-62899 described above, EP No. 0803763A1, EP No. 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870, and 2002-107868, the disclosures of which are incorporated by reference.

When a photosensitive silver salt coexists during dispersing the organic silver salt, fog increases, and the sensitivity is substantially lowered. As a result, it is more preferable that a photosensitive silver salt is substantially not included during dispersing. In the present invention, the amount of a photosensitive silver salt to be dispersed in an aqueous dispersion is preferably 1 mol % or less, and more preferably 0.1 mol % or less per mole of the organic acid silver salt in the dispersion. Furthermore preferably, the photosensitive silver salt is not positively added.

In the present invention, it is possible to manufacture the photosensitive material by mixing an aqueous dispersion of the organic silver salt and an aqueous dispersion of the photosensitive silver salt. The mixing ratio of the photosensitive silver salt to the organic silver salt can be selected according to the intended purpose. The ratio of the photosensitive silver salt to the organic silver salt is preferably in the range of 1 mol % or more to 30 mol % or less, more preferably 2 mol % or more to 20 mol % or less, and in particular preferably 3 mol % or more to 15 mol % or less. For mixing, it is a method preferably used for adjusting the photographic properties that two or more kinds of aqueous dispersions of organic silver salts and two or more kinds of aqueous dispersions of photosensitive silver salts are mixed.

4) Amount Added

The amount of the organic silver salt to be used in the present invention is preferably 0.1 g/m² or more to 3.0 g/m² or less, more preferably 0.3 g/m² or more to 2.0 g/m² or less, and furthermore preferably 0.5 g/m² or more to 1.8 g/m² or less, in terms of the total coating amount of silver also containing silver halide. In particular, the total coating amount of silver is preferably 1.6 g/m² or less, and more preferably 1.4 g/m² or less in order to improve the image storage stability. When the preferred reducing agents of the invention are used, it is possible to obtain a sufficient image density even with such a low silver amount.

Whereas, in the present invention, a photothermographic material including two or more image forming layers provided therein is used, wherein the coating amount of the organic silver salt contained in the respective image forming layers has no particular restriction.

(Description of Anti-Foggant)

The anti-foggant, the stabilizer and the stabilizer precursor usable in the present invention can include those described in JP-A No. 10-62899, in column No. 0070, EP-A No. 0803764A1, in page 20, line 57—page 21, line 7, compounds described in JP-A Nos. 9-281637 and 9-329864, compounds described in U.S. Pat. No. 6,083,681, and EP No. 1048975.

1) Polyhalogen Compound

Preferred organic polyhalogen compound in the present invention is to be described specifically. The preferred polyhalogen compound in the present invention is a compound represented by the following formula (H).
Q—(Y)ₙ—C(Z₁)(Z₂)X Formula (H);

In formula (H), Q represents an alkyl group, aryl group or heterocyclic group, Y represents a bivalent connection group, n represents 0 to 1, Z₁ and Z₂ each independently represent a halogen atom, and X represents hydrogen atom or an electron accepting group.

In formula [H], Q is, preferably, an alkyl group of 1 to 6 carbon atoms, an aryl group of 6 to 12 carbon atoms or heterocyclic group containing at least one nitrogen atom (for example, pyridine and quinoline).

In a case where Q is an aryl group in formula [H], Q preferably represents a phenyl group substituted with an electron accepting group in which the Hammett's substituent group constant σp takes a positive value. For the Hammett's substituent constant, Journal of Medicinal Chemistry, 1973, vol. 16, No. 11, pages 1207-1216, etc. can be referred to. Examples of the electron accepting group described above include a halogen atom, alkyl group substituted by electron accepting group, aryl group substituted by electron accepting group, heterocyclic group, arkyl or arylsulfonyl group, acyl group, alkoxycarbonyl group, carbamoyl group, or sulfamoyl group. Particularly preferred electron accepting group is a halogen atom, carbamoyl group, or arylsulfonyl group, with the carbamoyl group being most preferred. X is preferably an electron accepting group. Preferable examples of the electron accepting group include a halogen atom; an aliphatic, aryl or heterocyclic sulfonyl group; an aliphatic, aryl or heterocyclic acyl group; an aliphatic, aryl or heterocyclic oxycarbonyl group; a carbamoyl group; and a sulfamoyl group. A halogen atom and a carbamoyl group are more preferable, and a bromine atom is particularly preferable among them.

Z₁ and Z₂ each independently preferably represent a bromine atom or an iodine atom and, more preferably, represent a bromine atom.

Y represents, preferably, —C(═O)—, —SO—, —SO₂—, —C(═O)N(R)—, or —SO₂N(R)— and, more preferably, —C(═O)—, —SO₂—, and —C(═O)N(R)— and, particularly preferably, —SO₂—, —C(═O)N(R)—, in which R represents hydrogen atom, aryl group or alkyl group, more preferably, hydrogen atom or an alkyl group and, particularly preferably, hydrogen atom.

n represents 0 or 1 and, preferably, 1.

In formula (H) in a case where the Q represents an alkyl group, Y is preferably —C(═O)N(R)— and in a case where Q represents an aryl group or the heterocyclic group, Y preferably represents —SO₂—.

A form where the residues formed by removing the hydrogen atom from the compound in formula (H) are combined to each other (generally referred to as bis-form, tris-form and tetrakis-form) can also be used preferably. A form having a dissociating group (for example, COOH group or a salt thereof, SO₃H group or a salt thereof, PO₃H group or a salt thereof, etc.), a group containing a quaternary nitrogen cation (for example, ammonium group, pyridinium group, etc.), polyethyleneoxy group or hydroxyl group as a substituent in formula (H) is also preferred.

Specific examples of the compound of formula (H) in the present invention are shown below.

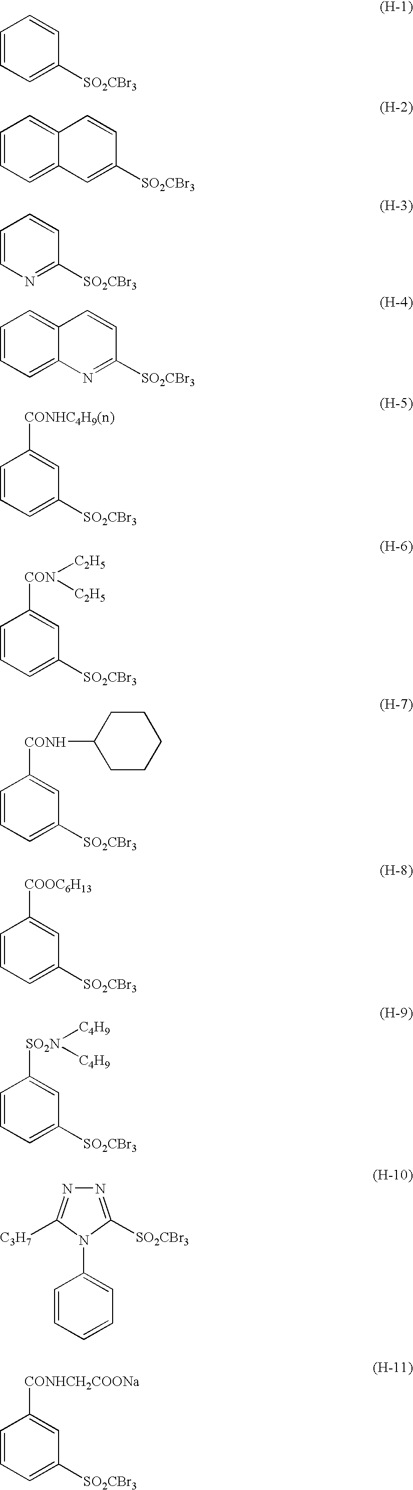

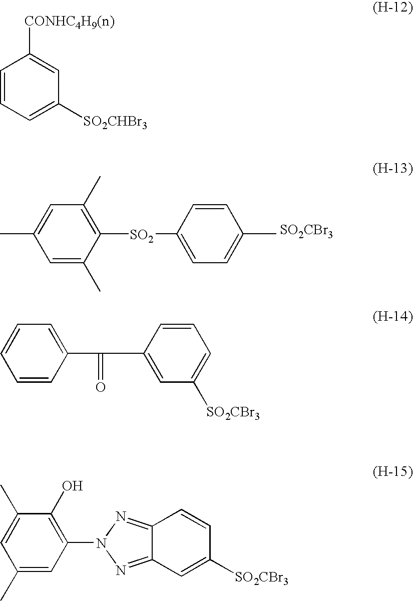

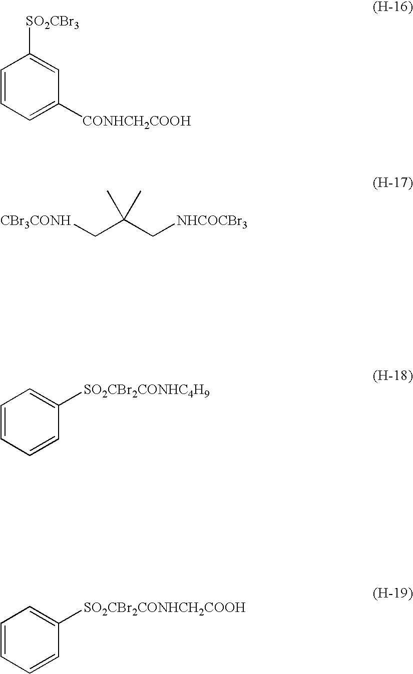

As other polyhalogen compounds than those described above usable in the present invention, those compounds described in the specifications of U.S. Pat. Nos. 3,874,946, 4,756,999, 5,340,712, 5,369,000, 5,464,737, 6,506,548, JP-A Nos. 50-137126, 50-89020, 50-119624, 59-57234, 7-2781, 7-5621, 9-160164, 9-244177, 9-244178, 9-160167, 9-319022, 9-258367, 9-265150, 9-319022, 10-197988, 10-197989, 11-242304, 2000-2963, 2000-112070, 2000-284410, 2000-284412, 2001-33911, 2001-31644, 2001-312027, and 2003-50441 as the exemplified compounds for the inventions can be used preferably. Particularly those compounds exemplified specifically in JP-A Nos. 7-2781, 2001-33911, and 2001-312027 are preferred.

The compound represented by formula (H) in the present invention is used, preferably, within a range of 10⁻⁴ mol or more and 1 mol or less, more preferably, within a range of 10⁻³ mol or more and 0.5 mol or less and, further preferably, within a range of 1×10⁻² mol or more and 0.2 mol or less based on one mol of the non-photosensitive silver salt in the image-forming layer.

In the present invention, the method of incorporating the anti-foggant in the photosensitive material can include the method described for the method of incorporating the reducing agent, and also the organic polyhalogen compound is added preferably as the fine solid particle dispersion.

2) Other Anti-Foggant

Other anti-foggants can include mercury (II) salt in JP-A No. 11-65021, in column No. 0113, benzoic acids, in column No. 0114, salicylic acid derivatives in JP-A No. 2000-206642, formalin scavenger compound represented by formula (S) in JP-A No. 2000-221634, triazine compound according to claim 9 in JP-A No. 11-352624, the compound represented by formula (III) in JP-A No. 6-11791, and 4-hydroxy-6-methyl-1,3,3a,7-tetrazaindene.

The photothermographic material in the present invention may contain an azolium salt for preventive fogging. The azolium salt can include the compound represented by formula (XI) described in JP-A No. 59-193447, the compound described in JP-B No. 55-12581, and the compound represented by formula (II) described in JP-A No. 60-153039. The azolium salt may be added to any portion of the photosensitive material and it is preferably added to the layer on the surface having the image-forming layer and it is added further preferably to the image-forming layer. Referring to the addition time of the azolium salt, it may be added at any step for the preparation of coating solution and, in a case of adding to the image-forming layer, it may be added at any step from preparation of the organic silver salt to preparation of the coating solution and it is preferably added after the preparation of organic silver salt to just before the coating thereof. The azolium salt may be added by any method such as in the form of powder, solution and fine particle dispersion. Further, it may be added as a solution mixed with other additives such as a sensitizing dye, a reducing agent, or a color-tone-adjusting agent. The addition amount of the azolium salt in the present invention may be any amount and it is, preferably, 1×10⁻⁶ mol or more and 2 mol or less and, further preferably, 1×10⁻³ mol or more and 0.5 mol or less based on one mol of silver.

(Explanation of Development Accelerator)

For the photothermographic material of the invention, there are preferably used, as development accelerators, the sulfonamidephenol type compounds represented by the formula (A) described in JP-A Nos. 2000-267222, 2000-330234, and the like, the hindered phenol type compounds represented by the formula (II) described in JP-A No. 2001-92075, the hydrazine type compounds represented by the formula (I) described in JP-A Nos. 10-62895, 11-15116, and the like, the formula (D) of JP-A No. 2002-156727, and the formula (1) described in JP-A No. 2002-278017, and the phenol type or naphthol type compounds represented by the formula (2) described in JP-A No. 2001-264929; the phenol type compounds described in JP-A Nos. 2002-311533 and 2002-341484 are also preferred and in particular, the naphthol type compounds described in JP-A No. 2003-66558 are preferred (the disclosures of all of the above are incorporated herein by reference).

In the present invention, the development accelerator is used in an amount in the range of 0.1 mol % or more to 20 mol % or less, preferably in the range of 0.5 mol % or more to 10 mol % or less, and more preferably in the range of 1 mol % or more to 5 mol % or less based on the amount of the reducing agent.

As a process for introducing it into a sensitive material, mention may be made of the same process for the reducing agent. In particular, the development accelerator is preferably added in the form of a solid dispersion or an emulsified dispersion. When it is added in the form of an emulsified dispersion, it is preferably added in the form of an emulsified dispersion obtained by dispersing the compound using a high boiling solvent which is a solid at ordinary temperatures, and a low boiling co-solvent, or added in the form of a so-called oil-less emulsified dispersion not using a high boiling solvent.

In the present invention, out of the foregoing development accelerators, the hydrazine type compounds described in JP-A Nos. 2002-156727 and 2002-278017, and the naphthol type compounds described in JP-A No. 2003-66558 are more preferred.

Particularly preferred development accelerators in the present invention are compounds represented by the following formulae (A-1) and (A-2).
Q₁—NHNH—Q₂ Formula (A-1);
in which Q₁ represents an aromatic group or heterocyclic group bonded at a carbon atom to —NHNH—Q₂, and Q₂ represents a carbamoyl group, acyl group, alkoxycarbonyl group, aryloxycarbonyl group, sulfonyl group, or sulfamoyl group.

In formula (A-1), the aromatic group or heterocyclic group represented by Q₁ is, preferably, a 5 to 7 membered unsaturated ring. Preferred examples are benzene ring, pyridine ring, pyrazine ring, pyrimidine ring, pyridazine ring, 1,2,4-triazine ring, 1,3,5-trazine ring, pyrrole ring, imidazole ring, pyrazole ring, 1,2,3-triazole ring, 1,2,4-triazole ring, tetrazole ring, 1,3,4-thiadiazole ring, 1,2,4-thiadiazole ring, 1,2,5-thiadiazole ring, 1,3,4-oxadiazole ring, 1,2,4-oxadiazole ring, 1,2,5-oxadiazole ring, thiazole ring, oxazole ring, isothiazole ring, isooxazole ring, or thiophene ring, and a condensed ring in which the rings described above are condensed to each other is also preferred.

The rings described above may have substituents and in a case where they have two or more substituents, the substituents may be identical or different with each other. Examples of the substituent can include a halogen atom, alkyl group, aryl group, carbonamide group, alkylsulfonamide group, arylsulfonamide group, alkoxy group, aryloxy group, alkylthio group, arylthio group, carbamoyl group, sulfamoyl group, cyano group, alkylsulfonyl group, arylsulfonyl group, alkoxycarbonyl group, aryloxycarbonyl group or acyl group. In a case where the substituents are groups capable of substitution, they may have further substituents and examples of preferred substituents can include a halogen atom, alkyl group, aryl group, carbonamide group, alkylsulfonamide group, arylsulfonamide group, alkoxy group, aryloxy group, alkylthio group, arylthio group, acyl group, alkoxycarbonyl group, aryloxycarbonyl group, carbamoyl group, cyano group, sulfamoyl group, alkylsulfonyl group, arylsulfonyl group, and acyloxy group.

The carbamoyl group represented by Q₂ is a carbamoyl group of, preferably, 1 to 50 carbon atoms and, more preferably, 6 to 40 carbon atoms and can include, for example, not-substituted carbamoyl, methyl carbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl} carbamoyl, N-2-hexyldecyl)carbamoyl, N-phenylcarbamoyl, N-(4-dodecyloxyphenyl)carbamoyl, N-2-chloro-5-dodecyloxycarbonylphenyl)carbamoyl, N-naphthylcarbamoyl, N-3-pyridylcarbamoyl or N-benzylcarbamoyl.

The acyl group represented by Q₂ is an acyl group of, preferably, 1 to 50 carbon atoms and, more preferably, 6 to 40 carbon atoms and can include, for example, a formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, or 2-hydroxymethylbenzoyl. The alkoxycarbonyl group represented by Q₂ is an alkoxycarbonyl group of, preferably, 2 to 50 carbon atom and, more preferably, 6 to 40 carbon atoms and can include, for example, methoxycarbonyl, ethoxycarbonyl, isobutyloxycarbonyl, cyclehexyloxycarbonyl, dodecyloxycarbonyl or benzyloxycarbonyl.

The aryloxy carbonyl group represented by Q₂ is an aryloxycarbonyl group of, preferably, 7 to 50 carbon atoms and, more preferably, 7 to 40 carbon atoms and can include, for example, a phenoxycarbonyl, 4-octyloxyphenoxycarbonyl, 2-hydroxymethylphenoxycarbonyl, or 4-dodecyloxyphenoxycarbonyl. The sulfonyl group represented by Q₂ is a sulfonyl group of, preferably, 1 to 50 carbon atoms and, more preferably, 6 to 40 carbon atoms and can include, for example, methylsulfonyl, butylsulfonyl, octylsulfonyl, 2-hexadecylsulfonyl, 3-dodecyloxypropylsulfonyl, 2-octyloxy-5-tert-octylphenyl sulfonyl, or 4-dodecyloxyphenyl sulfonyl.

The sulfamoyl group represented by Q₂ is a sulfamoyl group of, preferably, 0 to 50 carbon atoms, more preferably, 6 to 40 carbon atoms and can include, for example, a not-substituted sulfamoyl, N-ethylsulfamoyl, N-2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, or N-2-tetradecyloxyphenyl)sulfamoyl. The group represented by Q₂ may further have a group mentioned as the example of the substituent for the 5 to 7-membered unsaturated ring represented by Q₁ at the position capable of substitution. In a case where the group has two or more substituents, such substituents may be identical or different with each other.

Then, a preferred range for the compound represented by formula (A-1) is to be described. A 5 to 6-membered unsaturated ring is preferred for Q₁, and a benzene ring, pyrimidine ring, 1,2,3-triazole ring, 1,2,4-triazole ring, tetrazole ring, 1,3,4-thiadiazole ring, 1,2,4-thiadiazole ring, 1,3,4-oxadiazole ring, 1,2,4-oxadiazole ring, thioazole ring, oxazole ring, isothiazole ring, isooxazole ring, and a ring in which the rings described above are condensed each with a benzene ring or unsaturated hetero-ring is further preferred. Further, Q₂ preferably represents a carbamoyl group and a carbamoyl group having hydrogen atom on the nitrogen atom is particularly preferred.

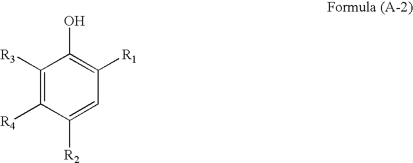

In formula (A-2), R₁ represents an alkyl group, acyl group, acylamino group, sulfonamide group, alkoxycarbonyl group, or carbamoyl group. R₂ represents hydrogen atom, halogen atom, alkyl group, alkoxy group, aryloxy group, alkylthio group, arylthio group, acyloxy group, or carbonate ester group. R₃ and R₄ each independently represent a group capable of substitution on the benzene ring which has been mentioned as the example of the substituent for formula (A-1). R₃ and R₄ may join to each other to form a condensed ring.

R₁ represents, preferably, an alkyl group of 1 to 20 carbon atoms (for example, methyl group, ethyl group, isopropyl group, butyl group, tert-octyl group, or cyclohexyl group), acylamino group (for example, acetylamino group, benzoylamino group, methylureido group, or 4-cyanophenylureido group), carbamoyl group (for example, n-butylcarbamoyl group, N,N-diethylcarbamoyl group, phenylcarbamoyl group, 2-chlorophenylcarbamoyl group, or 2,4-dichlorophenylcarbamoyl group), with acylamino group (including ureido group or urethane group) being more preferred.

R₂ represents, preferably, a halogen atom (more preferably, chlorine atom, or bromine atom), alkoxy group (for example, methoxy group, butoxy group, n-hexyloxy group, n-decyloxy group, cyclohexyloxy group, or benzyloxy group), and aryloxy group (phenoxy group or naphthoxy group).

R₃ represents, preferably, hydrogen atom, halogen atom or an alkyl group of 1 to 20 carbon atoms, the halogen atom being most preferred. R₄ represents, preferably, hydrogen atom, alkyl group or an acylamino group, with the alkyl group or the acylamino group being more preferred. Examples of the preferred substituent thereof are identical with those for R₁. In a case where R₄ is an acylamino group, R₄ may preferably be joined with R₃ to form a carbostyryl ring.

In a case where R₃ and R₄ in formula (A-2) join to each other to form a condensed ring, a naphthalene ring is particularly preferred as the condensed ring. The same substituent as the example of the substituent referred to for formula (A-1) may join to the naphthalene ring. In a case where formula (A-2) is a naphtholic compound, R₁ represents, preferably, a carbamoyl group. Among them, benzoyl group is particularly preferred. R₂ represents, preferably, an alkoxy group or aryloxy group and, particularly preferably, an alkoxy group.

Preferred specific examples for the development accelerator of the invention are to be described below. The invention is not restricted to them.

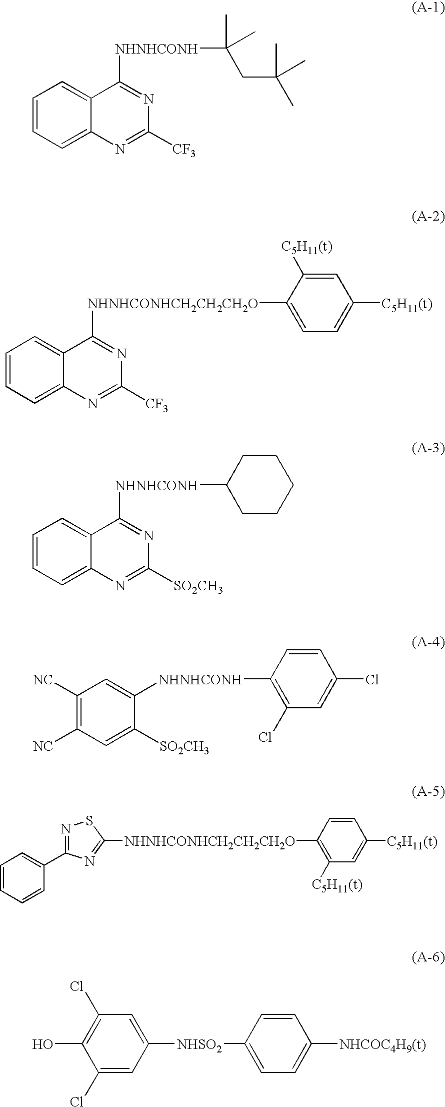

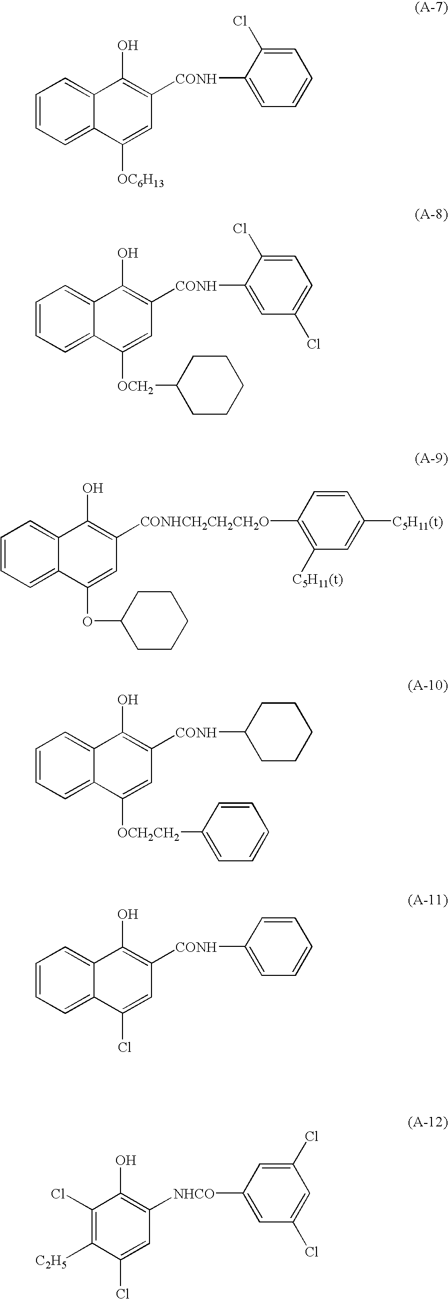

(Explanation of Hydrogen Bonding Compound)

When the reducing agent in the present invention has an aromatic hydroxyl group (—OH) or an amino group (—NHR, where R is hydrogen atom or an alkyl group), particularly in the case of the foregoing bisphenols, a non-reducible compound having a group capable of forming a hydrogen bond with each of these groups is preferably used in combination.

As the groups forming a hydrogen bond with a hydroxyl group or an amino group, mention may be made of a phosphoryl group, a sulfoxide group, a sulfonyl group, a carbonyl group, an amido group, an ester group, an urethane group, an ureido group, a tertiary amino group, a nitrogen-containing aromatic group, and the like. Out of these, preferred are a phosphoryl group, a sulfoxide group, an amido group (provided that it does not have an >N—H group, but is blocked like an >N—Ra (Ra is a substituent other than H)), an urethane group (provided that it does not have an >N—H group, but is blocked like an >N—Ra (Ra is a substituent other than H)), and an ureido group (provided that it does not have an >N—H group, but is blocked like an >N—Ra (Ra is a substituent other than H)).

Particularly preferred hydrogen bonding compounds in the present invention are the compounds represented by the following formula (D):

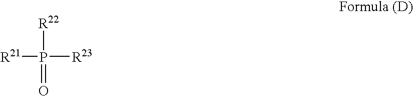

In formula (D), R²¹ to R²³ each independently represent an alkyl group, aryl group, alkoxy group, aryloxy group, amino group or heterocyclic group, which may be not substituted or have a substituent.

The substituent in a case where R²¹ to R²³ has a substituent can include, for example, a halogen atom, alkyl group, aryl group, alkoxy group, amino group, acyl group, acylamino group, alkylthio group, arylthio group, sulfoneamide group, acyloxy group, oxycarbonyl group, carbamoyl group, sulfamoyl group, sulfonyl group, or phosphoryl group, and preferred substituent can include an alkyl group or aryl group, for example, methyl group, ethyl group, isopropyl group, t-butyl group, t-octyl group, phenyl group, 4-alkoxyphenyl group, or 4-acyloxyphenyl group.

The alkyl group for R²¹ to R²³ can include, specifically, methyl group, ethyl group, butyl group, octyl group, dodecyl group, isopropyl group, t-butyl group, t-amyl group, t-octyl group, cyclohexyl group, 1-methylcyclohexyl group, benzyl group, phenethyl group, or 2-phenoxypropyl group.

The aryl group for R²¹ to R²³ can include, for example, phenyl group, cresyl group, xylyl group, naphthyl group, 4-t-butylphenyl group, 4-t-octylphenyl group, 4-anisidyl group, or 3,5-dichlorophenyl group.

The alkoxy group for R²¹ to R²³ can include, for example, methoxy group, ethoxy group, butoxy group, octyloxy group, 2-ethylhexyloxy group, 3,5,5-trimethylhexyloxy group, dodecyloxy group, cyclohexyloxy group, 4-methylcyclohexyloxy group, or benzyloxy group.

The aryloxy group for R²¹ to R²³ can include, for example, a phenoxy group, cresyloxy group, isopropylphenoxy group, 4-t-butylphenoxy group, naphthoxy group, or biphenyloxy group.

The amino group for R²¹ to R²³ can include, for example, a dimethylamino group, diethylamino group, dibutylamino group, dioctylamino group, N-methyl-N-hexylamino group, dicyclohexylamino group, diphenylamino group, or N-methyl-N-phenylamino group.

For R²¹ to R²³, an alkyl group, aryl group, alkoxy group, or aryloxy group are preferred. With a view point of the effect of the invention, it is preferable that at least one of R²¹ to R²³ is alkyl group or aryl group and it is more preferable that two or more of them are alkyl group or aryl group. Further, with a view point of availability at a reduced cost, it is preferable that R²¹ to R²³ are identical groups.

Specific examples of the hydrogen bonding compound including the compound of formula (D) in the present invention are shown below but the invention is not restricted to them.

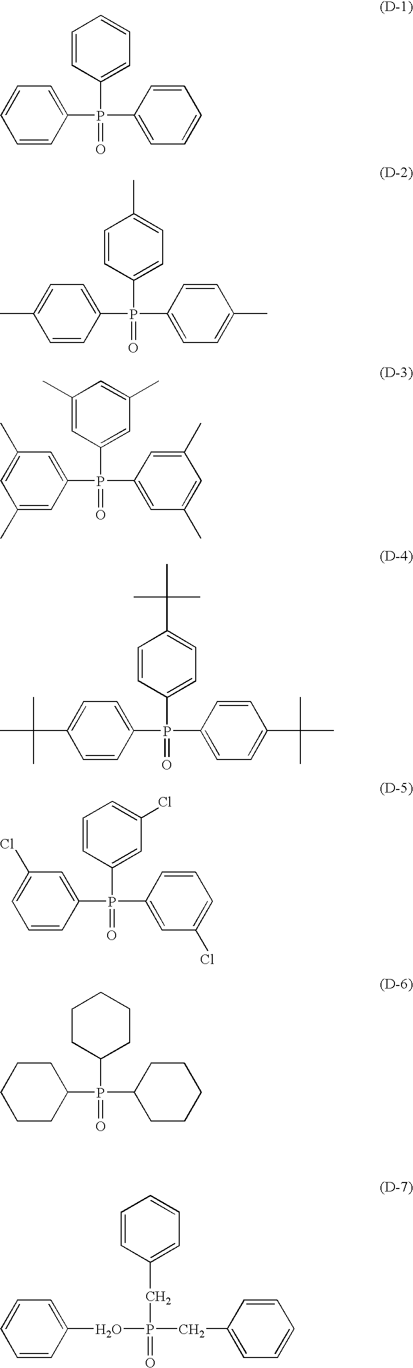

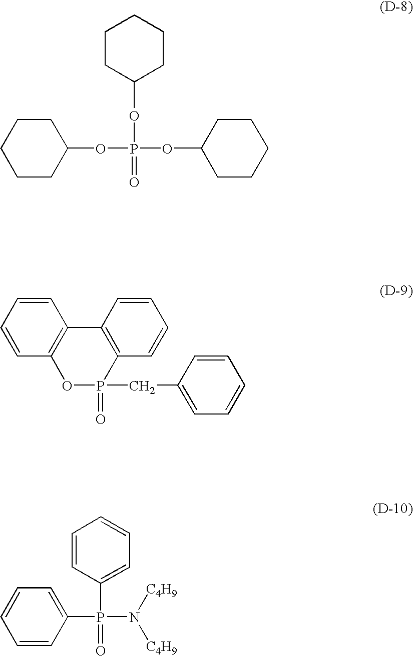

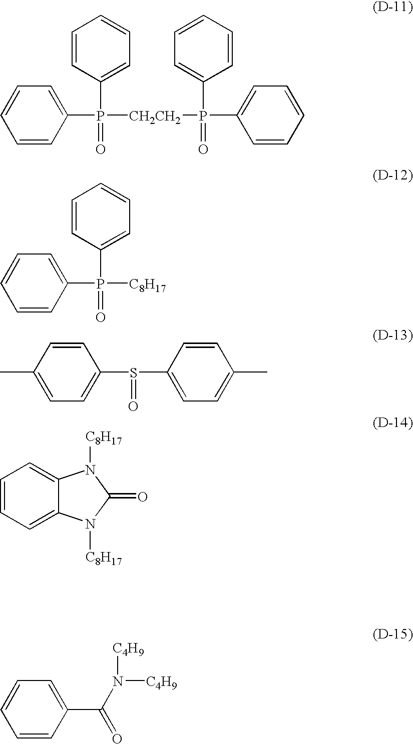

As the specific examples of the hydrogen bonding compound, other than the foregoing ones, mention may be made of those described in EP-A No. 1096310, JP-A Nos. 2002-156727, and 2002-318431.

The compound of the formula (D) in the present invention can be used in the photosensitive material by being incorporated into the coating solution in solution form, in emulsified dispersion form, or in solid dispersed fine particle dispersion form in the same manner as with the reducing agent. However, it is preferably used in solid dispersion form. These compounds each form a hydrogen bonding complex with a compound having a phenolic hydroxyl group or an amino group in a solution state, so that it can be separated as a complex in a crystalline state, depending on the combination between the reducing agent and the compound of the formula (D) of the invention.

It is particularly preferable for obtaining stable performances to use the crystal powder thus separated in the form of a solid dispersed fine particle dispersion. Further, methods of mixing the reducing agent with the compound of the formula (D) of the invention in a powder state, and then causing the formation of a complex during dispersing by means of a sand grinder mill, or the like with an appropriate dispersing agent can also preferably be used.

It is preferable that the compound of the formula (D) of the invention is used in an amount of preferably in the range of 1 mol % or more to 200 mol % or less, more preferably in the range of 10 mol % or more to 150 mol % or less, and further preferably in the range of 20 mol % or more to 100 mol % or less based on the amount of the reducing agent.

(Explanation of Silver Halide)

1) Halogen Composition

The photosensitive silver halides usable in the present invention have no particular restriction on the halogen composition. Silver chloride, silver chlorobromide, silver bromide, silver iodobromide, silver chloroiodobromide, and silver iodide can be used. Out of these, silver bromide, silver iodobromide, and silver iodide are preferred. The distribution of halogen composition in a grain may be uniform, or it may be such that the halogen composition is stepwise changed or continuously changed. Further, silver halide grains having a core/shell structure can preferably be used. For the structure, a twofold to fivefold structure is preferable. Core/shell grains having a twofold to fourfold structure are more preferably used. Techniques of localizing silver bromide or silver iodide on the surface of silver chloride, silver bromide, or silver chlorobromide grain can also preferably be used.

In a photothermographic material having image forming layers on both sides, silver halide with a high silver iodide content is preferred. It is very preferable from the viewpoint of the image storage stability to light irradiation after the treatment that the silver iodide content in the silver halide is preferably 40 mol % or more to 100 mol % or less, and that the silver iodide content is more preferably 70 mol % or more to 100 mol % or less, further preferably 80 mol % or more to 100 mol % or less, and in particular preferably 90 mol % or more to 100 mol % or less.

2) Grain Formation Method

The methods for forming the photosensitive silver halide are well known in the art. For example, methods described in Research Disclosure No. 17029, June, 1978, and U.S. Pat. No. 3,700,458 can be used. Specifically, the following method is used. Namely, a silver-supplying compound and a halogen-supplying compound are added into a solution of gelatin or other polymers, thereby to prepare a photosensitive silver halide. Then, the resulting photosensitive silver halide is mixed with an organic silver salt. Further, the methods described in paragraph Nos. 0217 to 0224 of JP-A No. 11-119374, and the methods described in JP-A Nos. 11-352627 and 2000-347335 are also preferred.

3) Grain Size

The grain size of the photosensitive silver halide is preferably smaller for the purpose of minimizing the white turbidity after image formation. Specifically, 70% or more of the total grains have a grain size of 0.10 μm or less, preferably 0.01 μm or more to 0.06 μm or less, and further preferably 0.02 μm or more and 0.04 μm or less. The grain size herein mentioned denotes the diameter of the converted circular image having an area equivalent to the projection area of a silver halide grain (the projection area of the main plane for a tabular grain).

Whereas, in the photothermographic material having image forming layers on the both sides, it is possible to select a sufficiently large grain size necessary for achieving high sensitivity. In this case, the average sphere equivalent diameter of the silver halide is preferably 0.3 μm or more to 5.0 μm or less, and further preferably 0.35 μm or more to 3.0 μm or less.

In the case of the same kind of silver halides, the larger the grain size is, the higher the sensitivity is.

4) Grain Shape

The silver halide grain may be in the shape of a cuboid, an octahedron, a tablet, a sphere, a rod, a potato, or the like. In the present invention, cuboidal grains are particularly preferred. Silver halide grains with rounded corners can also preferably be used. The plane indices (Miller indices) of outer surface planes of photosensitive silver halide grains have no particular restriction. However, {100} plane showing a high spectral sensitization efficiency upon adsorption of spectral sensitizing dyes thereon preferably occupies a large proportion. The proportion is preferably 50% or more, more preferably 65% or more, and furthermore preferably 80% or more. The proportion of Miller index {100} plane can be determined by the method described in T. Tani; J. Imaging Sci., 29, 165, (1985), which utilizes the adsorption dependency between {111} plane and {100} plane in the sensitizing dye adsorption.

The silver halide having a high silver iodide content to be preferably used for the photothermographic material including image forming layers on the both sides can assume complex forms. As the preferred form, for example, mention may be made of the form of joined grains as shown in p. 164, FIG. 1 of R. L. JENKINS etal., J. of Phot. Sci. Vol. 28 (1980). The tabular grains as shown in FIG. 1 of the same journal may also be preferably used. Particularly, 50% or more of the photosensitive silver halide in a projected area includes tabular grains with an aspect ratio of 2 or more. More preferably, the photosensitive silver halide includes tabular grains with an aspect ratio of 3 or more to 20 or less in an amount of 50% or more.

5) Heavy Metal

The photosensitive silver halide grains of the invention can contain a metal of the Groups 3 to 13 in the Periodic Table (showing the Groups 1 to 18), or a metal complex thereof. The metals of the Groups 3 to 13 in the Periodic Table or the central metals of the metal complexes are preferably rhodium, ruthenium, and iridium. These metal complexes may be used alone, or in combination of two or more complexes of the same kind of metals and different kinds of metals. The preferred content is preferably in the range of 1×10⁻⁹ mol or more to 1×10⁻³ or less mol per mole of silver. These heavy metals, metal complexes, and addition processes thereof are described in JP-A Nos. 7-225449, 11-65021, paragraph Nos. 0018 to 0024, and JP-A No. 11-119374, paragraph Nos. 0227 to 0240.

In the present invention, a silver halide grain having a hexacyano metal complex in the grain outermost surface is preferred. As the hexacyano metal complexes, mention may be made of [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, [Re(CN)₆]³⁻, and the like. In the present invention, a hexacyano Fe complex is preferred.

The hexacyano metal complex exists in the form of an ion in an aqueous solution, and hence its counter cation is not important. However, the counter cations to be preferably used are alkali metal ions such as sodium ion, potassium ion, rubidium ion, cesium ion, and lithium ion, ammonium ion, and alkylammonium ion (e.g., tetramethylammonium ion, tetraethylammonium ion, tetrapropylammonium ion, or tetra(n-butyl)ammonium ion), which are readily miscible with water, and are suitable for the operation of precipitating silver halide emulsions.

The hexacyano metal complex may be added by being incorporated in a mixed solvent of water, and in addition, an organic solvent miscible with water (e.g., alcohols, ethers, glycols, ketones, esters, or amides), or gelatin.

The amount of hexacyano metal complex to be added is preferably 1×10⁻⁵ mol or more to 1×10⁻² mol or less, and more preferably 1×10⁻⁴ mol or more to 1×10⁻³ mol or less per mole of silver.

In order for the hexacyano metal complex to exist in the outermost surfaces of silver halide grains, the hexacyano metal complex is directly added after the completion of addition of an aqueous silver nitrate solution for use in grain formation, and before the completion of the charging step until prior to the chemical sensitization step of performing chalcogen sensitization such as sulfur sensitization, selenium sensitization or tellurium sensitization, or noble metal sensitization such as gold sensitization, during the water washing step, during the dispersing step, or before the chemical sensitization step. In order to prevent the growth of silver halide grains, the hexacyano metal complex is preferably added immediately after grain formation, and preferably added before the completion of the charging step.

Incidentally, the addition of the hexacyano metal complex may be started after adding 96 mass % of the total amount of silver nitrate to be added for grain formation. It is more preferably started after adding 98 mass % thereof, and in particular preferably after adding 99 mass % thereof.

When the hexacyano metal complex is added just before the completion of the grain formation, and after the addition of an aqueous solution of silver nitrate, it can adsorb onto the outermost surfaces of the silver halide grains. Most of them each form a slightly-soluble salt with the silver ions in the grain surfaces. The silver salt of hexacyano iron (II) is more slightly soluble than AgI, which can prevent redissolving in the form of fine grains. This enables manufacturing of silver halide fine grains with a small grain size.

Further, the metal atoms (e.g., [Fe(CN)₆]⁴⁻) which can be incorporated in the silver halide grains usable in the present invention, and a desalting processes or a chemical sensitizing process of a silver halide emulsion are described in JP-A No. 11-84574, paragraph Nos. 0046 to 0050, JP-A No. 11-65021, paragraph Nos. 0025 to 0031, and JP-A No. 11-119374, paragraph Nos. 0242 to 0250.

6) Gelatin

As the gelatins to be incorporated in the photosensitive silver halide emulsion for use in the present invention, various gelatins may be used. The dispersion state in an organic silver salt-containing coating solution of the photosensitive silver halide emulsion is required to be kept favorable, so that gelatin having a molecular weight of 10,000 to 1,000,000 is preferably used. Whereas, it is also preferable to subject the substituent of gelatin to phthalation treatment. The gelatin may be used for grain formation or for dispersing after desalting treatment, but it is preferably used for grain formation.

7) Sensitizing Dye

As sensitizing dyes applicable to the invention, the sensitizing dyes can be advantageously selected which are capable of spectrally sensitizing silver halide grains in a desirable wavelength region upon adsorbing on the silver halide grains, and have the spectral sensitivities suitable for the spectral characteristics of an exposure light source. The sensitizing dyes and the addition processes thereof are described in the following references, or as the following substances: paragraph Nos. 0103 to 0109 of JP-A No. 11-65021, the compounds represented by the formula (II) in JP-A No. 10-186572, the dyes represented by the formula (I) and the paragraph No. 0106 of JP-A No. 11-119374, U.S. Pat. No. 5,510,236, the dyes described in Example 5 of U.S. Pat. No. 3,871,887, JP-A No. 2-96131, the dyes disclosed in JP-A No. 59-48753, on page 19, line 38 to page 20, line 35 of EP No. 0803764A1, JP-A Nos. 2001-272747, 2001-290238, and 2002-23306, the disclosures of which are incorporated by reference and the like. These sensitizing dyes may be used alone, or may also be used in combination of two or more thereof. In the present invention, the timing of adding a sensitizing dye to a silver halide emulsion is preferably during the period after the desalting step until coating, and more preferably during the period after desalting until prior to the completion of chemical ripening.

The amount of the sensitizing dye to be added in the present invention can be set at a desirable amount according to the sensitivity and the fog performance. It is preferably 10⁻⁶ mol or more to 1 mol or less, and more preferably 10⁻⁴ mol or more to 10⁻¹ mol or less per mole of silver halide of the image forming layer.

In the present invention, it is possible to use a supersensitizer in order to improve the spectral sensitization efficiency. As the supersensitizers for use in the present invention, mention may be made of the compounds described in EP No. 587,338, U.S. Pat. Nos. 3,877,943 and 4,873,184, JP-A Nos. 5-341432, 11-109547, and 10-111543, and the like.

8) Chemical Sensitization

The photosensitive silver halide grains in the present invention are preferably subjected to chemical sensitization with a sulfur sensitization process, a selenium sensitization process, or a tellurium sensitization process. The compounds preferably usable for a sulfur sensitization process, a selenium sensitization process, or a tellurium sensitization process are known compounds. For example, the compounds described in JP-A No. 7-128768 and the like may be used. In particular, tellurium sensitization is preferred in the present invention. The compounds described in the reference described in paragraph No. 0030 of JP-A No. 11-65021, and the compounds represented by the formulae (II), (III), and (IV) in JP-A No. 5-313284 are more preferred.

The photosensitive silver halide grains in the present invention have been preferably chemically sensitized by a gold sensitization process, in combination with the chalcogen sensitization, or alone. The gold sensitizer preferably has a valence of gold of +1 or +3. Preferred gold sensitizers are normally used gold compounds. Typical preferred examples thereof include: chloroauric acid, bromoauric acid, potassium chloroaurate, potassium bromoaurate, auric trichloride, potassium auric thiocyanate, potassium iodoaurate, tetracyanoauric acid, ammonium aurothiocyanate, and pyridyltrichlorogold. Further, the gold sensitizers described in U.S. Pat. No. 5,858,637 and JP-A No. 2002-278016 are also preferably used.

In the present invention, any timing is acceptable for the chemical sensitization so long as the timing is after grain formation and before coating. The timing may be after desalting, and (1) before spectral sensitization, (2) simultaneously with spectral sensitization, (3) after spectral sensitization, (4) immediately before coating, or the like.

Each amount of the sulfur, selenium, and tellurium sensitizers for use in the present invention varies according to the silver halide grains to be used, the chemical ripening conditions, and the like. Each sensitizer is used in an amount of about 10⁻⁸ mol or more to 10⁻² mol or less, and preferably 10⁻⁷ mol or more to 10⁻³ mol or less per mole of silver halide.

The amount of gold sensitizer to be added varies according to various conditions. It is, as a guideline, 10⁻⁷ mol or more to 10⁻³ mol or less, and more preferably 10⁻⁶ mol or more to 5×10⁻⁴ mol or less per mole of silver halide

The conditions for the chemical sensitization in the present invention have no particular restriction. The pH is 5 to 8, the pAg is 6 to 11, and the temperature is about 40 to 95° C.

To the silver halide emulsion for use in the present invention, a thiosulfonic acid compound may also be added with the method described in EP No. 293,917.

For the photosensitive silver halide grains in the present invention, a reducing agent is preferably used. As the specific compounds for a reduction sensitization process, ascorbic acid and aminoiminomethane sulfinic acid are preferred. In addition, stannous chloride, hydrazine derivatives, borane compounds, silane compounds, polyamine compounds, and the like are preferably used. The reduction sensitizer may be added in the any process of the photosensitive emulsion manufacturing steps of from the crystal growth until the preparation step immediately before coating. Whereas, the emulsion is preferably ripened with the pH held at 7 or more, or with the pAg held at 8.3 or less, so that reduction sensitization is performed. The reduction sensitization is also preferably performed by introducing the single addition part of silver ion during grain formation.

9) Compound in which a one-electron oxidant formed by one-electron oxidation can release one electron or more electrons

The photothermographic material in the present invention preferably contains a compound in which a one-electron oxidant formed by one-electron oxidation can release one electron or more electrons. The compound is used alone or together with the various chemical sensitizers described above and can increase the sensitivity of the silver halide.

The compound in which a one-electron oxidant formed by one-electron oxidation can release one electron or more electrons contained in the photosensitive material of the invention is a compound selected from the following types 1 and 2.

Type 1 and Type 2 compounds contained in the photothermographic material of the invention are to be described.

Type 1

A compound in which a one-electron oxidant formed by one-electron oxidation can further release one or more electrons accompanying successive bonding cleavage reaction.

Type 2

A compound in which a one-electron oxidant formed by one-electron oxidation can further release one or more electrons after successive bonding forming reaction.

At first the type 1 compound is described.

The type 1 compound in which a one-electron oxidant formed by one-electron oxidation can further release one electron accompanying successive bonding cleavage reaction can include those compounds which are referred to as “1-photon 2-electron sensitizing agent” or “deprotonating electron donating sensitizing agent” described in patent literatures such as JP-A No. 9-211769 (specific examples: compounds PMT-1 to S-37 described in Table E and Table F in pages 28-32), JP-A Nos. 9-211774, and 11-95355 (specific examples: compounds INV 1 to 36), JP-W No. 2001-500996 (specific examples; compounds 1 to 74, 80 to 87, and 92 to 122), U.S. Pat. Nos. 5,747,235 and 5,747,236, EP No. 786692 A1 (specific examples: compounds INV 1 to 35), EP-A No. 893732 A1, U.S. Pat. Nos. 6,054,260 and 5,994,051. Further, preferred ranges for the compounds are identical with the preferred ranges described in the cited patent specifications.

The type 1 compound in which a one-electron oxidant formed by one-electron oxidation can further release one electron or more electrons accompanying successive bonding cleavage reaction can include those compounds represented by formula (1) (identical with formula (1) described in JP-A No. 2003-114487), formula (2) (identical with formula (2) described in JP-A No. 2003-114487), formula (3) (identical with formula (1) described in JP-A No. 2003-114488), formula (4) (identical with formula (2) described in JP-A No. 2003-114488), formula (5) (identical with formula (3) described in JP-A No. 2003-114488), formula (6) (identical with formula (I) described in JP-A No. 2003-75950), formula (7) (identical with formula (2) described in JP-A No. 2003-75950), formula (8) (identical with formula (1) described in JP-A No. 2004-239943, which has not been published at the time of the present application), and formula (9) (identical with formula (3) described in JP-A No. 2004-245929, which has not been published at the time of the present application) among the compounds capable of causing reaction represented by the chemical reaction formula (1) (identical with chemical reaction formula (1) described in JP-A No. 2004-245929, which has not been published at the time of the present application). Further, preferred ranges for the compounds are identical with the preferred ranges described in the cited patent specifications. The disclosure of the above-described patent documents are incorporated by reference herein.

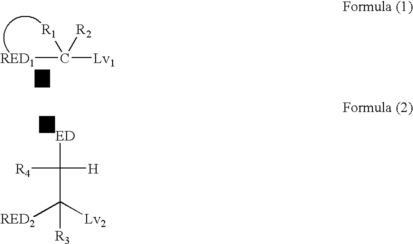

In formulae (1) and (2), RED₁ and RED₂ each independently represent a reducing group. R₁ represents a group of non-metal atoms capable of forming, together with the carbon atom (C) and RED₁, a cyclic structure corresponding to a tetrahydro form or a hexahydro form of a 5-membered or 6-membered aromatic ring (including aromatic heterocyclic ring), R₂, R₃ and R₄ each independently represent hydrogen atom or a substituent, Lv₁ and Lv₂ each independently represent a leaving group, and ED represents an electron donating group.

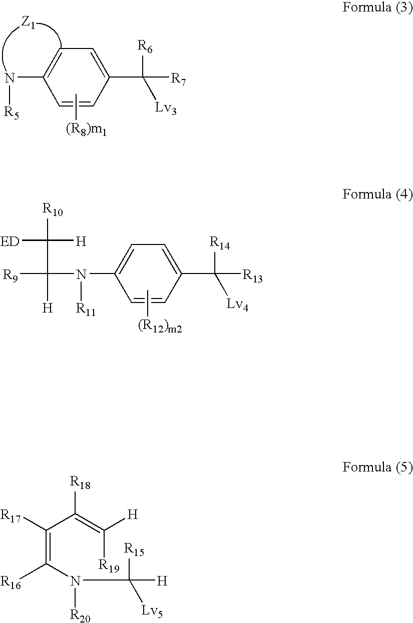

In formulae (3), (4) and (5), Z₁ represents a group of atoms capable of forming a 6-membered ring together with a nitrogen atom and two carbon atoms of the benzene ring, R₅, R₆, R₇, R₉, R₁₀, R₁₁, R₁₃, R₁₄, R₁₅, R₁₆, R₁₇, R₁₈ and R₁₉ each independently represent hydrogen atom or a substituent, R₂₀ represents hydrogen atom or a substituent, in which R₁₆ and R₁₇ are joined to each other to form an aromatic ring or aromatic heterocyclic ring in a case where R₂₀ represents a group other than the aryl group, R₈ and R₁₂ each independently represent a substituent capable of substituting the benzene ring, m1 represents an integer of 0 to 3, m2 represents an integer of 0 to 4 and Lv₃, Lv₄ and Lv₅ each independently represent a leaving group.

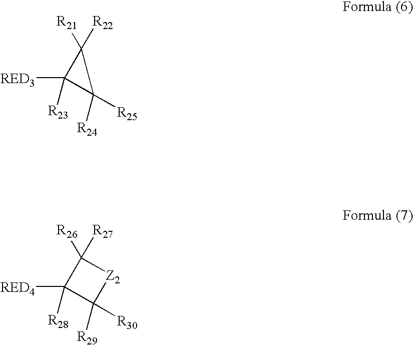

In formulae (6) and (7), RED₃ and RED₄ each independently represent a reducing group, R₂₁ to R₃₀ each independently represent hydrogen atom or a substituent, Z₂ represents —CR₁₁₁R₁₁₂—, —NR₁₁₃—, or O—, R₁₁₁ and R₁₁₂ each independently represent hydrogen atom or a substituent, and R₁₁₃ represents hydrogen atom, alkyl group, aryl group or heterocyclic group.

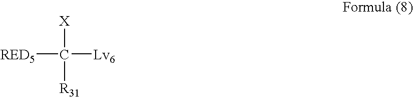

In formula (8), RED₅ is a reducing group, which represents an aryl amino group or heterocyclic amino group, R₃₁ represents hydrogen atom or a substituent, X represents an alkoxy group and aryloxy group, heterocyclicoxy group, alkylthio group, arylthio group, heterocyclicthio group, alkylamino group, arylamino group, or heterocyclic amino group. Lv₆ is a leaving group which represents a carboxyl group or a salt thereof, or hydrogen atom.

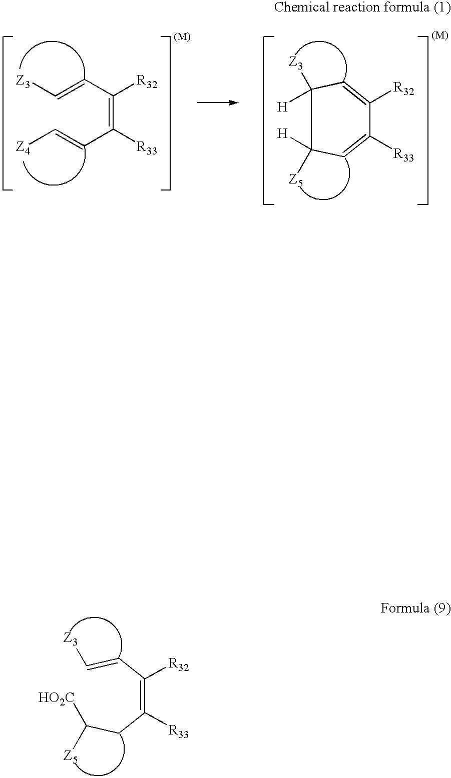

The compound represented by formula (9) is a compound causing bonding forming reaction represented by the chemical reaction formula (1) by further oxidation after 2-electron oxidation accompanying decarbonation. In the chemical reaction formula (1), R₃₂ and R₃₃ each independently represent hydrogen atom or a substituent, Z₃ represents a group forming a 5-nembered or 6-nembered heterocyclic ring together with C═C, Z₄ represents a group forming a 5-membered or 6-nembered aryl group or heterocyclic group together with C═C, M represents a radial, radical cation or cation. In formula (9), R₃₂ and R₃₃, Z₃ have the same meanings as those for the chemical reaction formula (1), Z₅ represents a group forming a 5-membered or 6-membered cycloaliphatic hydrocarbon group or heterocyclic group together with C—C.

Then the type 2 compound is to be described.

The type 2 compound in which one-electron oxidant formed by one-electron oxidation can further release one electron or more electrons accompanying successive bonding forming reaction can include those compounds represented by formula (10) (identical with formula (1) described in JP-A No. 2003-140287), and those compounds capable of causing reaction represented by the chemical reaction formula (1) (identical with chemical reaction formula (1) described in JP-A No. 2004-245929, which has not been published at the time of the present application) represented by formula (11) (identical with formula (2) described in JP-A No. 2004-245929, which has not been published at the time of the present application). Preferred ranges for the compounds are identical with preferred ranges described in the cited patent specifications.
RED₆—Q—Y Formula (10);

In formula (10), RED₆ represents a reducing group subjected to one-electron oxidation, Y represents a reaction group including a carbon-carbon double bond site, carbon-carbon triple bond site, aromatic group site, or a non-aromatic heterocyclic site formed by condensation of benzo ring capable of reacting with one-electron oxidant formed by one-electron oxidation of RED₆ and forming a new bond, and Q represents a connection group connecting RED₆ and Y.

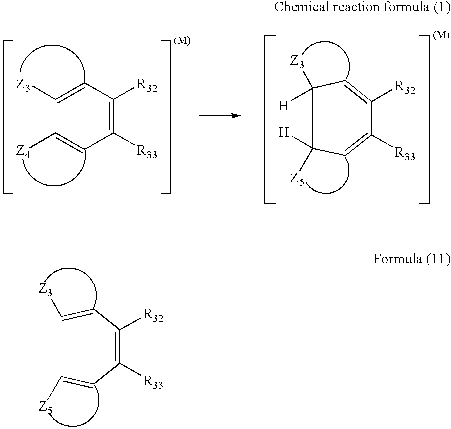

The compound represented by formula (11) is a compound causing the bonding forming reaction represented by the chemical reaction formula (1) upon oxidation. In the chemical reaction formula (1), R₃₂ and R₃₃ each independently represent hydrogen atom or a substituent, Z₃ represents a group forming, together with C═C, a 5-nembered or 6-membered heterocyclic group, Z₄ represents a group forming a 5-membered or 6-membered aryl group or hetercyclic group together with C═C, Z₅ represents a group forming a 5-membered or 6-nembered cycloaliphatic hydrocarbon group or heterocyclic group together with C—C, and M represents a radical, radical cation or cation. In formula (11), R₃₂, R₃₃, Z₃, Z₄ have the same meanings as those in the chemical reaction (1).

Among the type 1 and type 2 compounds, preferred are “compound having an adsorptive group to silver halide in the molecule” or “compound having a partial structure of a spectral sensitizing dye in the molecule”. A typical absorptive group to the silver halide is a group described in the specification of JP-A No. 2003-156823, page 16, right column, line 1 to page 17, right column, line 12. The partial structure for the spectral sensitizing dye is a structure described in the above-mentioned specification, page 17, right column, line 34 to page 18, left column, line 6.

Among the type 1 and type 2 compounds, more preferred are “compound having at least one adsorptive group to silver halide in the molecule” and, further preferably, “compound having two or more absorptive groups to silver halide in the identical group”. In a case where two or more absorptive groups are present in a single molecule, the absorptive groups may be identical or different with each other.

Preferred adsorptive groups can include a mercapto-substituted nitrogen-containing heterocyclic group (for example, 2-mercaptothiadiazole group, 3-mercapto-1,2,4-triazole group, 5-mercaptotetrazole group, 2-mercapto-1,3,4-oxathiazole group, 2-mercaptobenzoxazole group, 2-mercaptobenzthiazole group, 1,5-dimethyl-1,2,4-triazolium-3-thiorate group, etc.), or a nitrogen-containing hetero-ring group having —NH— group capable of forming imino silver (>NAg) as a partial structure of the heterocyclic (for example, benzotriazole group, benzimadazole group, indazole group, etc.). Particularly preferred are 5-mercaptotetrazole group, 3-mercapto-1,2,4-triazole group, and benzotriazole group and, most preferred are 3-mercapto-1,2,4-triazole group and 5-mercaptotetrazole group.

Absporptive group having two or more mercapto groups in the molecule as the partial structure are also particularly preferred. The mercapto group (—SH), in a case where it is tautomerically isomerizable, may form a thion group. Preferred examples of adsorptive groups having two or more mercapto groups as the partial structure (for example, dimercapto substituted nitrogen-containing heterocyclic group) can include a 2,4-dimercaptopyrimidine group, 2,4-dimercaptotriazine group, and 3,5-dimercapto-1,2,4-triazole group.

A quaternary salt structure of nitrogen or phosphorus can also be used preferably as the absorptive group. The quaternary salt structure of nitrogen can include, specifically, an ammonio group (trialkyl ammonio group, dialkylaryl (or heteroaryl) ammonio group, alkyldiaryl (or heteroaryl) ammonio group) or a group containing a nitrogen-containing heterocyclic group containing a quatenarized nitrogen atom. The quaternary salt structure of phosphorus can include a phosphonio group (trialkyl phosphonio group, dialkylaryl or heteroaryl) phosphonio group, alkyldiaryl (or heteroaryl) phosphonio group, triaryl (or heteroaryl) phosphonio group. More preferably, a quaternary salt structure of nitrogen is used and, further preferably, a 5-nembered or 6-membered nitrogen containing aromatic heterocyclic group containing quaternarized nitrogen atom is used. Particularly preferably, a pyridinio group, quinolinio group or isoquinolinio group is used. The nitrogen-containing heterocyclic group containing the quaternarized nitrogen atom may have an optional substituent.

Examples for the counter anion of the quaternary salt can include, for example, halogen ion, carboxylate ion, sulfonate ion, sulfate ion, perchlorate ion, carbonate ion, nitrate ion, BF₄⁻PF₆⁻ and Ph₄B. In a case where there exists a group having negative charges such as on a carboxylate group in the molecule, it may form an intramolecular salt therewith. As the counter anion not present in the molecule, chlorine ion, bromine ion or methane sulfonate ion is particularly preferred.

The preferred structure of the compound represented by the types 1 and 2 having the quaternary salt structure of nitrogen or phosphorus as the adsorptive group is represented by formula (X).
(P—Q₁—)ᵢ—R(—Q₂—S)ⱼ

In formula (X), P and R each independently represent a quaternary salt structure of nitrogen or phosphorus which is not a partial structure of the sensitizing dye, Q₁ and Q₂ each independently represent a connection group, specifically, a single bond, alkylene group, arylene group heterocyclic group, —O—, —S—, NR_{N}—, —C(═O)—, —SO₂—, —SO—, —P(═O)— each alone or in combination of such groups in which R_{N} represents hydrogen atom, alkyl group, aryl group, or heterocyclic group, S represents a residue formed by removing one atom from the compound represented by type (1) or (2), i and j each independently represent an integer of 1 or greater and are selected within a range of i+j of from 2 to 6. Preferably, i is 1 to 3 and j is 1 to 2 and, more preferably, i is 1 or 2 and j is 1 and, most preferably, i is 1 and j is 1. In the compound represented by formula (X), the total number of carbon atoms thereof is preferably within a range from 10 to 100 and, more preferably, 10 to 70 and, further preferably, 11 to 60 and, particularly preferably, 12 to 50.

Specific examples for the compounds represented by type 1 and type 2 are set forth below but the invention is not restricted to them.

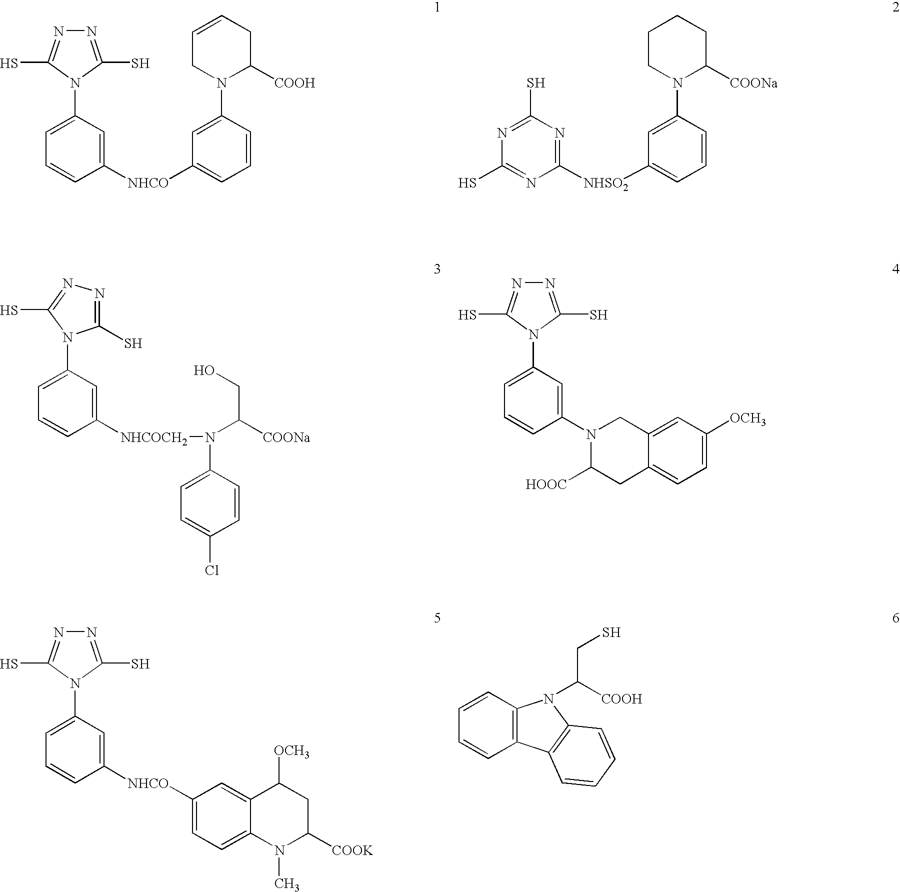

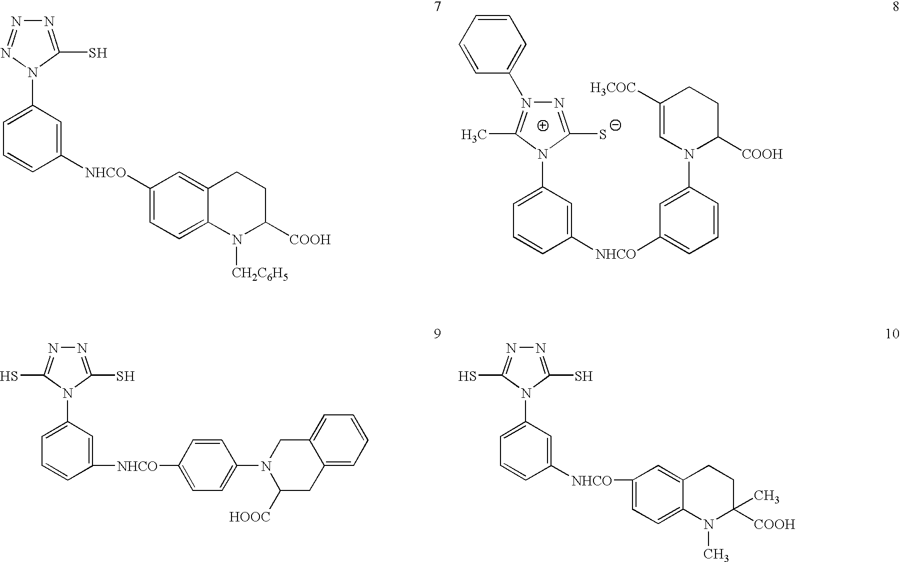

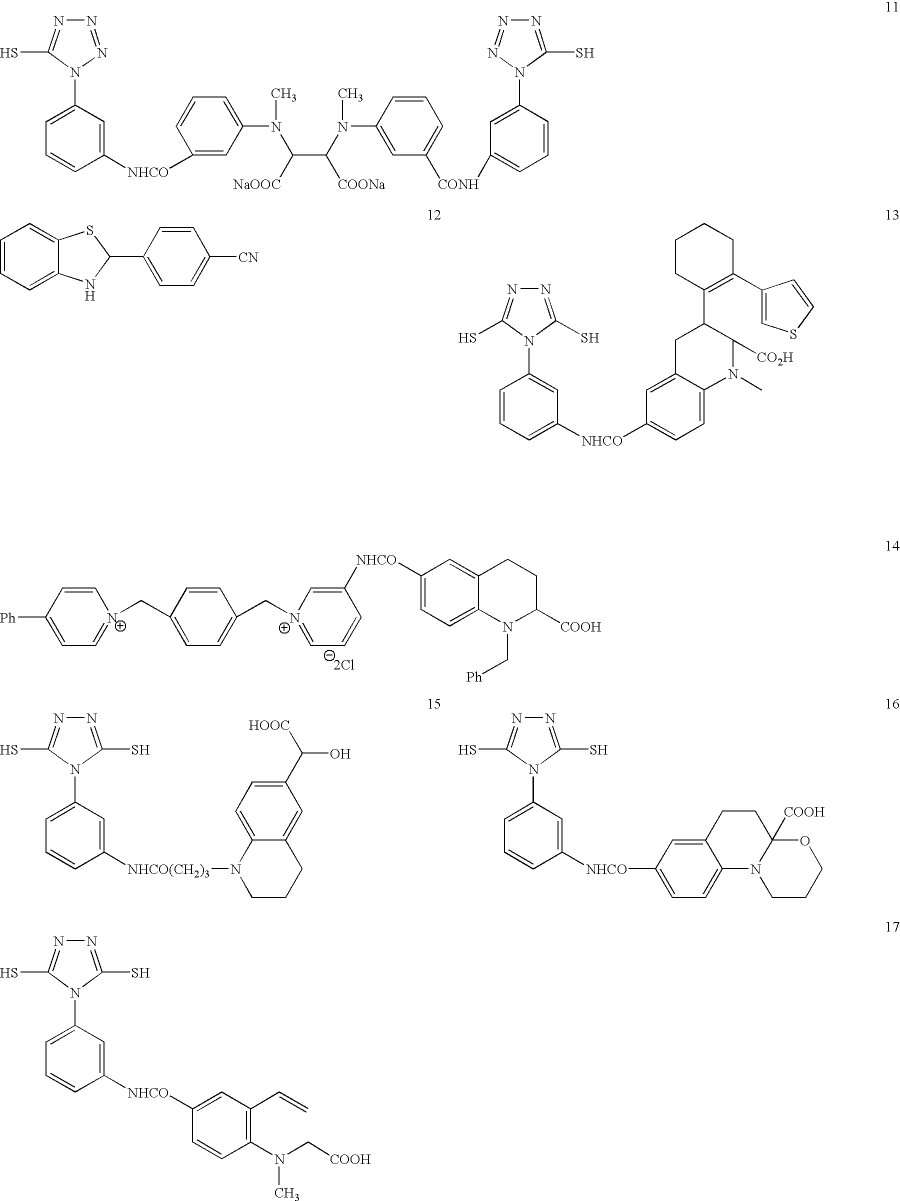

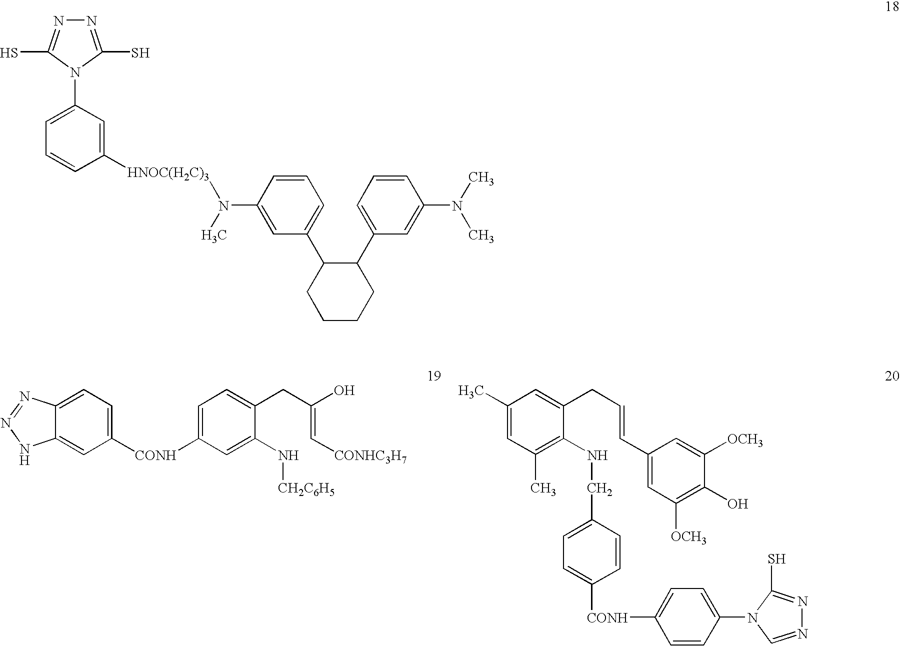

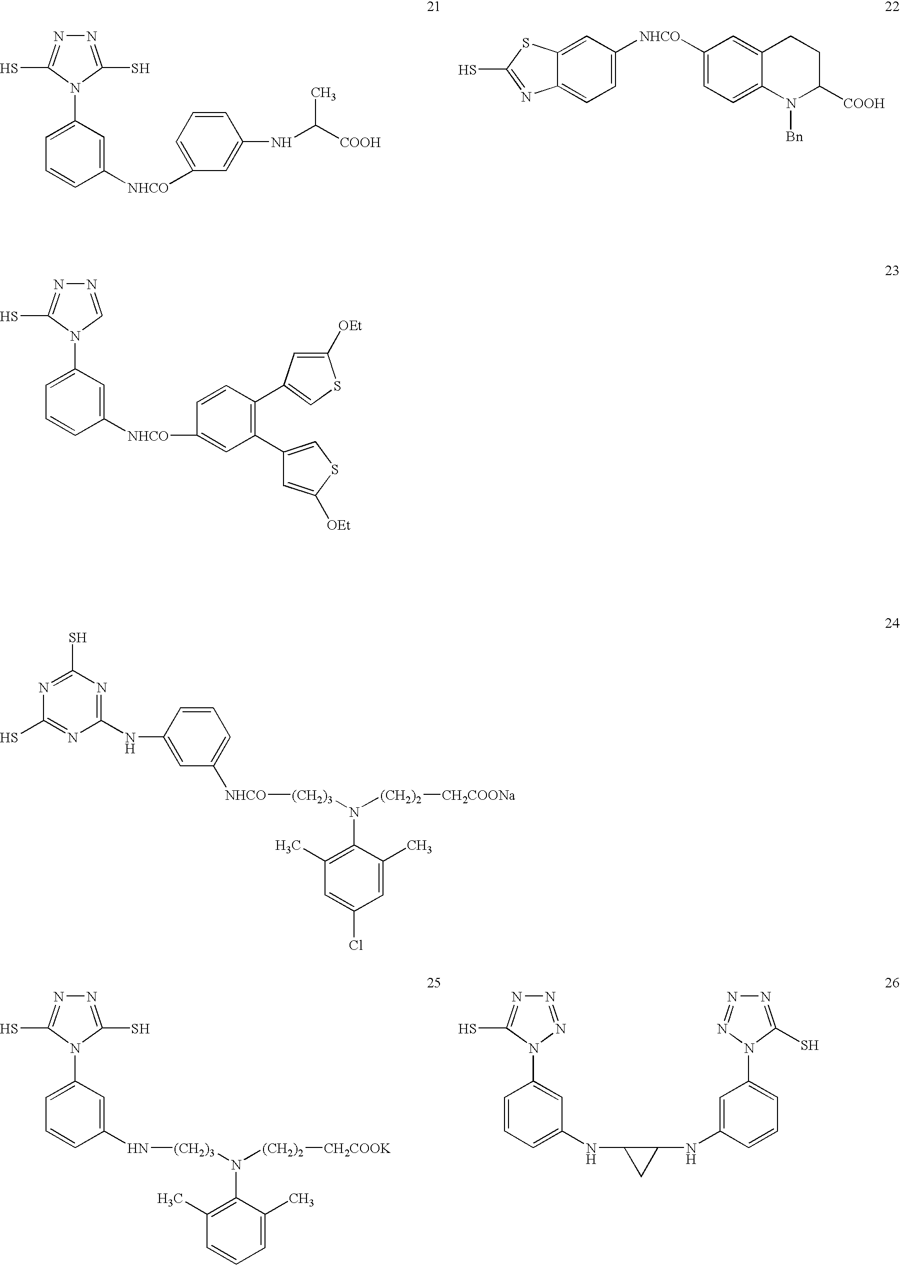

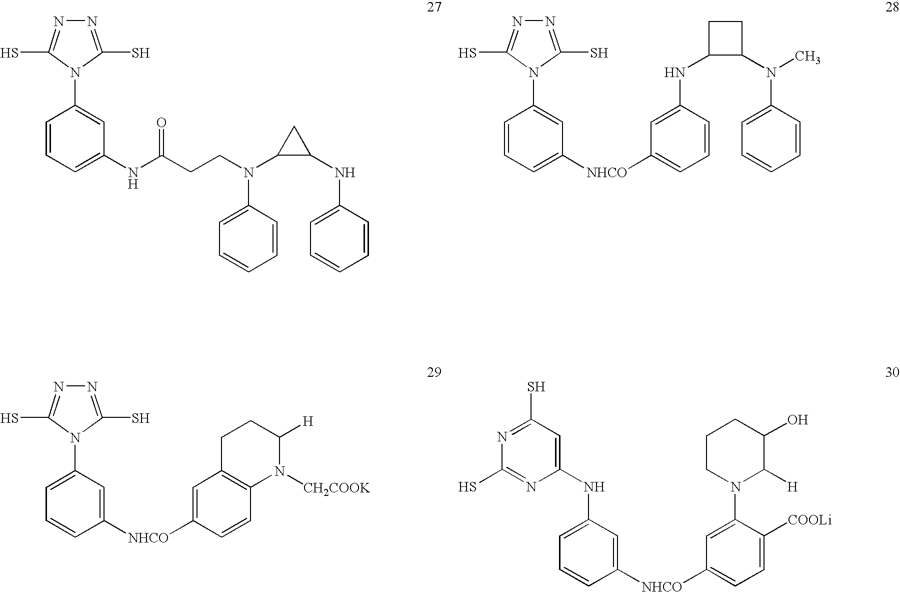

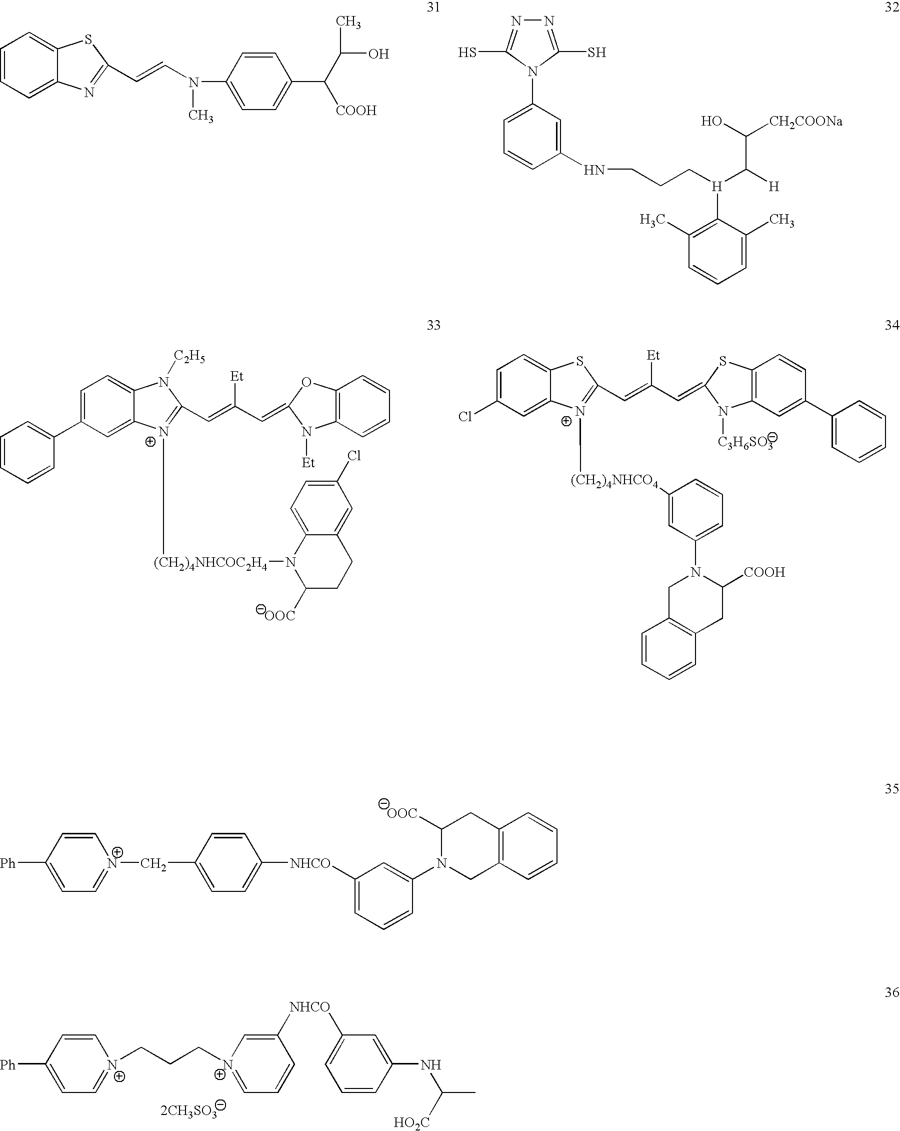

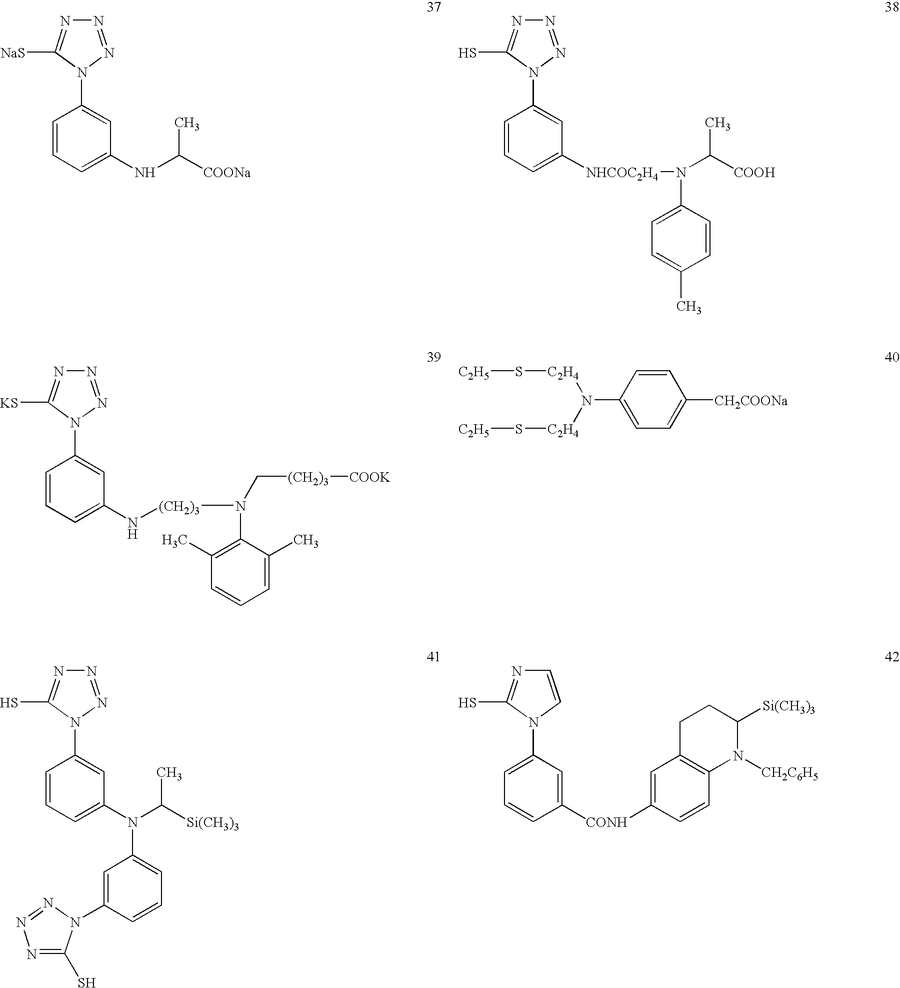

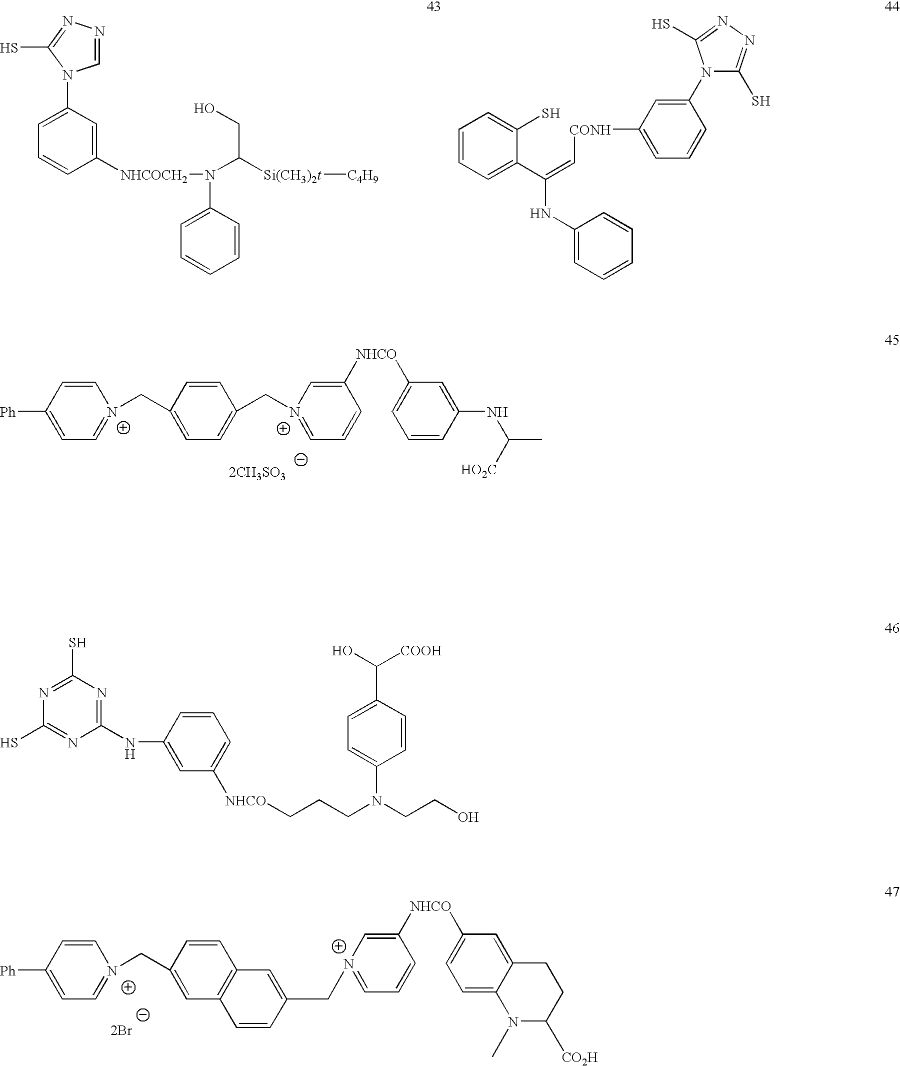

The compound of type 1 or type 2 in the present invention may be used at any step during preparation of the emulsion or in the production steps for the photothermographic material. For example, the compound may be used upon formation of particles, during desalting step, during chemical sensitization and before coating. Further, the compound can be added divisionally for plural times during the steps and added, preferably, from the completion of formation of the particles before the desalting step, during chemical sensitization Oust before starting to just after completion of chemical sensitization), and before coating and, more preferably, during the chemical sensitization and before coating.

The compounds of type 1 and type 2 in the present invention are preferably added being dissolved in a water or a water soluble solvent such as methanol or ethanol or a mixed solvent of them. In a case of dissolving in water, a compound the solubility of which is improved by controlling the pH higher or lower may be added by dissolution while controlling the pH to a higher or lower level.

The compound of type 1 or type 2 in the present invention is preferably used in an emulsion layer (imege forming layer) but it may be added to a protective layer or an intermediate layer as well as to the emulsion layer, and then diffused upon coating. The addition timing of the compound may be either before or after the applying of the sensitizing dye and is incorporated respectively in a silver halide emulsion layer, preferably, at a ratio of 1×10⁻⁹ mol or more and 5×10⁻² mol or less and, more preferably, 1×10⁻⁸ mol or more and to 2×10⁻³ mol per one mol of the silver halide.

10) Adsorptive Redox Compound Having Adsorptive Group and Reducing Group

In the present invention, an adsorptive redox compound having the adsorptive group to the silver halide and the reducing group in the molecule is preferably contained. The adsorptive redox compound is preferably a compound represented by the following formula (i).
A—(W)ₙ—B Formula (I);

In formula (I), A represents a group that can be adsorbed to a silver halide (hereinafter referred as an adsorptive group), W represents a bivalent connection group, n represents 0 or 1 and B represents a reducing group.

The adsorptive group represented by A in formula (I) is a group directly adsorbing to the silver halide or a group promoting adsorption to the silver halide and it can include, specifically, a mercapto group (or a salt thereof), thion group (—C(═S)—), a heterocyclic group containing at least one atom selected from nitrogen atom, sulfur atom, selenium atom and tellurium atom, sulfide group, disulfide group, cationic group or ethynyl group.

The mercapto group (or a salt thereof) as the adsorptive group means the mercapto group (or a salt thereof) itself, as well as represents, more preferably, a heterocyclic group, aryl group or alkyl group substituted with at least one mercapto group (or the salt thereof). The heterocyclic group is at least a 5-nembered to 7-membered single or condensed aromatic or non-aromatic heterocyclic group including, for example, imidazole ring group, thiazole ring group, oxazole ring group, benzimidazole ring group, benzothiazole ring group, benzoxazole ring group, triazole ring group, thiadiazole ring group, oxadiazole ring group, tetrazole ring group, purine ring group, pyridine ring group, quinoline ring group, isoquinoline ring group, pyrimidine ring group, and triazine ring group. Further, it may also be a heterocyclic group containing a quaternarized nitrogen atom, in which the substituting mercapto group may be dissociated to form a meso ion. When the mercapto group forms a salt, the counter ion can include, for example, a cation of an alkali metal, alkaline earth metal or heavy metal (Li⁺, Na⁺, K⁺, Mg²⁺, Ag⁺, Zn²⁺), ammonium ion, heterocyclic group containing quaternarized nitrogen atom, or phosphonium ion.

The mercapto group as the adsorptive group may also be tautomerically isomerized into a thion group.

The thione group as the adsorptive group can also include a linear or cyclic thioamide group, thioureido group, thiourethane group or dithiocarbamate ester group.

The heterocyclic group containing at least one atom selected from the nitrogen atom, sulfur atom, selenium atom and tellurium atom as the adsorptive group is a nitrogen-containing heterocyclic group having —NH— group capable of forming imino silver (>NAg) as a partial structure of the heterocyclic ring, or a heterocyclic group having an —S— group, —Se— group, —Te— group or ═N— group capable of coordination bond to a silver ion by way of coordination bonding as a partial structure of the heterocyclic ring. Examples of the former can include, for example, benzotriazole group, triazole group, indazole group, pyrazole group, tetrazole group, benzoimidazole group, imidazole group, and purine group, and examples of the latter can include, for example, thiophene group, thiazole group, oxazole group, benzothiophene group, benzothiazole group, benzoxazole group, thiadiazole group, oxadiazole group, triazine group, selenoazole group, benzoselenoazole group, tellurazole group, and benzotellurazole group.

The sulfide group or disulfide group as the adsorptive group can include all of the groups having the —S— or —S—S— partial structure.

The cationic group as the adsorptive group means a group containing a quaternarized nitrogen atom, specifically, a group containing a nitrogen-containing heterocyclic group containing an ammonio group or quaternarized nitrogen atom. The nitrogen-containing heterocyclic group containing the quaternarized nitrogen atom can include, for example, pyridinio group, quinolinio group, isoquinolinio group, and imidazolio group.

The ethynyl group as the adsorptive group means —C≡CH group in which the hydrogen atom may be substituted.

The adsorptive group may have an optional substituent.

Further, specific examples of the adsorptive group can include those described in the specification of JP-A No. 11-95355, in pages 4 to 7.

Preferred adsorptive group represented by A in formula (I) can include mercapto-substituted heterocyclic group (for example, 2-mercaptothiadiazole group, 2-mercapto-5-aminothiadiazole group, 3-mercapto-1,2,4-triazole group, 5-mercaptotetrazole group, 2-mercapto-1,3,4-oxadiazole group, 2-mercaptobenzimidazole group, 1,5-dimethyl-1,2,4-triazolium-3-thiorate group, 2,4-dimercapto pyrimidine group, 2,4-dimercapto triazine group, 3,5-dimercapto-1,2,4-triazole group, and 2,5-dimercapto-1,3-thiazole), or a nitrogen-containing heterocyclic group having —NH— group capable of forming imino silver (>NAg) as a partial structure of the heterocyclic ring (for example, benzotriazole group, benzimidazole group, and indazole group). More preferred adsorptive groups are 2-mercaptobenzimidazole group and 3,5-dimercapto-1,2,4-triazole group.

In formula (I), W represents a bivalent connection group. Any connection group may be used so long as it does not give undesired effects on photographic properties. For example, bivalent connection groups constituted with carbon atom, hydrogen atom, oxygen atom, nitrogen atom or sulfur atom can be utilized. They can include, specifically, alkylene group of 1 to 20 carbon atoms (for example, methylene group, ethylene group, trimethylene group, tetramethylene group, and hexamethylene group), alkenylene group of 2 to 20 carbon atoms, alkinylene group of 2 to 20 carbon atoms, arylene group of 6 to 20 carbon atoms (for example, phenylene group and naphthylene group), —CO—, —SO₂—, —O—, and —NR₁— and combination of such connection groups, in which R₁ represents hydrogen atom, alkyl group, heterocyclic group, or aryl group.

The connection group represented by W may further have other optional substituent.

In formula (I), the reducing group represented by B represents a group capable of reducing silver ion and can include, for example, residues derived by removing one hydrogen atom, from formyl group, amino group, triple bond group such as an acetylene group or propargyl group, mercapto group, hydroxyl amines, hydroxamic acids, hydroxy ureas, hydroxy urethanes, hydroxy semicarbazides, reductones (including reductone derivatives), anilines, phenols (including chroman-6-ols, 2,3-dihydrobenzofuran-5-ols, aminophenols, sulfoneamide phenols, and polyphenols such as hydroquinones, catechols, resorcinols, benzene triols and bisphenols), acyl hydrazines, carbamoyl hydrazides, and 3-pyrazolidone. They may have an optional substituent.

In formula (I), the oxidation potential for the reducing agent represented by B can be measured by a measuring method described in “Electrochemical Measuring Method” written by Akira Fujishima (published from Gihodo, pp 150-208) or “Experimental Chemical Course” edited by Chemical Society of Japan, 4th edition (vol. 9, pp 282-344, published from Maruzen). For example, it can be measured by a method of rotational disk volutammetry, specifically, by dissolving a specimen into a solution of methanol: pH 6.5, Britton-Robinson buffer=10%:90% (vol %), passing a nitrogen gIn the case of 10 min, and then measuring at 25° C. under 1000 rpm, at a sweeping velocity of 20 mV/sec while using a rotational disk electrode (RDE) made of glassy carbon as an operational electrode, using a platinum wire as a counter electrode and using a saturation calomel electrode as a reference electrode. A half-wave potential (E1/2) can be determined based on the obtained voltamogram.

The oxidation potential for the reducing group represented by B in the present invention, when measured by the measuring method described above, is preferably within a range from about −0.3 V to about 1.0 V. More preferably, it is within a range from about −0.1 V to about 0.8 V and, particularly preferably, is within a range from about 0 to about 0.7 V.

The reducing agent represented by B in formula (1) is preferably a residue, derived by removing one hydrogen atom from hydroxyl amines, hydroxamic acids, hydroxy ureas, hydroxy semi-carbazid, reductone, phenols, acyl hydrazines, carbamoyl hydrazines and 3pyrazolidones.

The compound of formula (I) of the invention may also be incorporated with a ballast group or a polymer chain used customarily as additives for static photography such as couplers. Further, the polymer can include those described, for example, in JP-A No. 1-100530.

The compound of formula (I) in the present invention may be a bis-form or tris-form. The molecular weight of the compound of formula (I) according to the invention is, preferably, between 100 to 10,000, more preferably, between 120 to 1,000 and, particularly preferably, between 150 to 500.

Compounds of formula (I) according to the invention are exemplified below but the invention is not restricted to them.

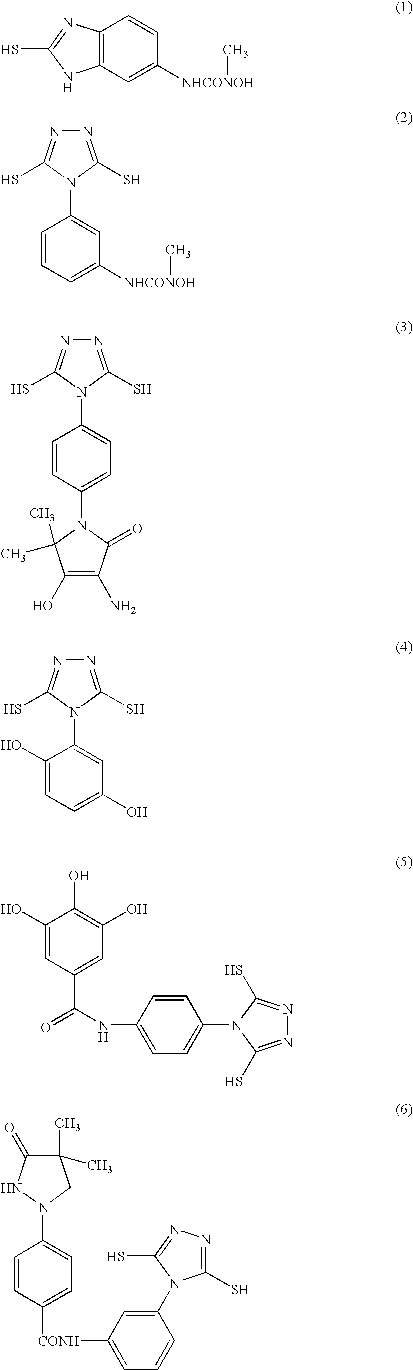

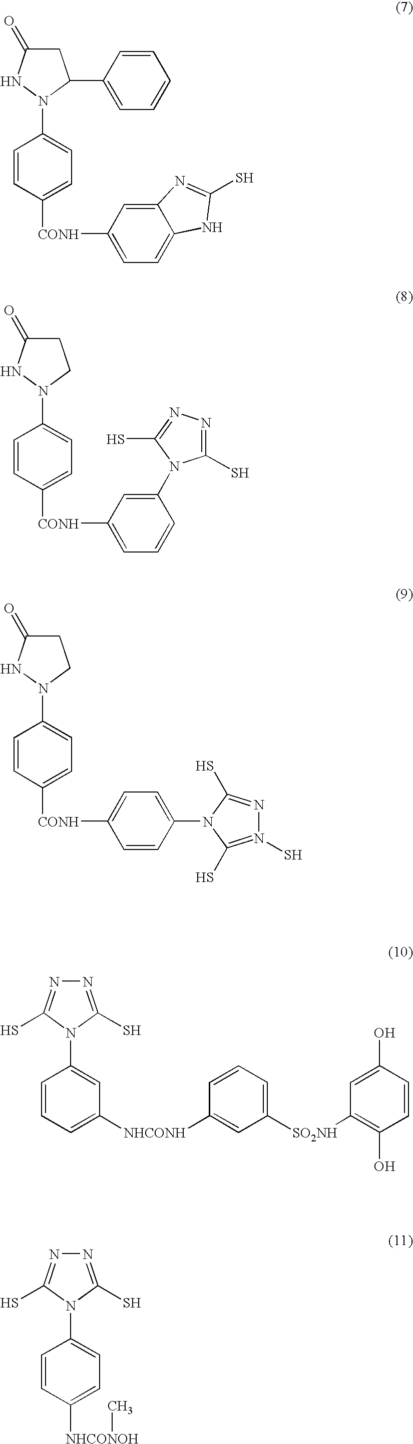

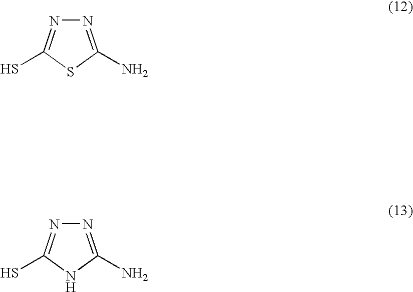

Further, also the specific compounds 1 to 30, 1″-1 to 1″-77 described in the specification of EP No. 1308776A2, pages 73 to 87 can also been mentioned as preferred examples of the compound having the adsorptive group and the reducing group in the present invention.

The compound of the invention can be synthesized easily according to the known method. The compound of formula (I) in the present invention may be used alone as a single kind of compound and it is also preferred to use two or more kinds of compounds together. In a case of using two or more kinds of compounds, they may be added to an identical layer or two separate layers, and the addition methods may be different, respectively.

The compound of formula (I) according to the invention is preferably added to a silver halide emulsion layer and it is preferably added upon preparation of the emulsion. In a case of adding upon preparation of the emulsion, it may be added at any step thereof. Examples of addition can include, for example, during the particle forming step of silver halide, before the starting the desalting step, during desalting step, before starting chemical aging, during the chemical aging step and step before preparation of complete emulsion. Further, the compound may be added divisionally for several times during the steps. Further, while it is preferably used for the image-forming layer, it may be added also to the adjacent protective layer or the intermediate layer as well as the image-forming layer, and may be diffused during coating.

A preferred addition amount greatly depends on the addition method described above or species of the compounds to be added. It is generally 1×10⁻⁶ mol or more and 1 mol or less, preferably, 1×10⁻⁵ mol or more and 5×10⁻¹ mol or less and, more preferably, 1×10⁻⁴ mol or more and 1×10⁻¹ mol or less per one mol of the photosensitive silver halide.

The compound of formula (I) in the present invention may be added by being dissolved in water, a water soluble solvent such as methanol or ethanol or a mixed solvent thereof. In this case, pH may be controlled adequately with an acid or base, or a surfactant may be present together. Further, it may be added as an emulsified dispersion being dissolved in a high boiling organic solvent. Further, it may be added also as a solid dispersion.

11) Use of a Plurality of Silver Halides in Combination

The photosensitive silver halide emulsions in the photosensitive material for use in the present invention may be used alone, or in combination of two or more thereof (e.g., the ones having different average grain sizes, the ones having different halogen compositions, the ones having different crystal habits, and the ones requiring different conditions for chemical sensitization). By using a plurality of kinds of photosensitive silver halides mutually having different sensitivities, it is possible to adjust the gradation. As the techniques on these, mention may be made of JP-A Nos. 57-119341, 53-106125, 47-3929, 48-55730, 46-5187, 50-73627, and 57-150841, and the like. In the case of the sensitivity difference, a difference of 0.2 logE or more is preferably caused between respective emulsions.

12) Coating Amount

The amount of the photosensitive silver halide to be added is preferably 0.03 g/m² or more to 0.6 g/m² or less, further preferably 0.05 g/m² or more to 0.4 g/m² or less, and most preferably 0.07 g/m² or more to 0.3 g/m² or less in terms of the amount of silver coated per square meter of the sensitive material. The photosensitive silver halide is used in an amount of preferably 0.01 mol or more to 0.5 mol or less, more preferably 0.02 mol or more to 0.3 mol or less, and further preferably 0.03 mol or more to 0.2 mol or less per mole of the organic silver salt.

13) Mixing of Photosensitive Silver Halide and Organic Silver Salt

As the mixing method and the mixing conditions of the photosensitive silver halide and the organic silver salt which have been separately prepared, there are a method for mixing silver halide grains and an organic silver salt which had been respectively prepared completely in a high-speed stirrer, a ball mill, a sand mill, a colloid mill, a shaking mill, a homogenizer, or the like; a method for mixing the photosensitive silver halide which has been completely prepared at any timing during the preparation of an organic silver salt, and preparing an organic silver salt; or other methods. However, there is no particular restriction so long as the effects of the invention are sufficiently exerted. WhereIn the case of mixing, it is a preferred method for adjusting the photographic properties that two or more kinds of aqueous dispersions of organic silver salts and two or more kinds of aqueous dispersions of photosensitive silver salts are mixed.

14) Mixing of Silver Halide to Coating Solution

The preferred timing of adding the silver halide into an image forming layer coating solution is in the period of from 180 minutes before to immediately before, and preferably 60 minutes before to 10 seconds before coating. However, the mixing process and the mixing conditions have no particular restriction so long as the effects of the invention satisfactorily occur. As specific mixing processes, there are a method in which the mixing is performed in a tank configured such that the mean residence time therein calculated from the addition flow rate and the feeding amount to a coater becomes a desirable time; a method using a static mixer described in Chapter 8 of Ekitai Kongo Gijutsu written by N. Harnby, M. F. Edwards, and A. W. Nienow, translated by Koji Takahashi, (published by Nikkan Kogyo Shinbunsha, 1989); and the like.

(Compound for Substantially Reducing Visible Light Absorption Derived From a Photosensitive Silver Halide After Heat Development)

In the present invention, for the photothermographic material having the image forming layers on the both sides, the foregoing silver halide having a high silver iodide content is preferably used. The silver halide having a high silver iodide content is preferably used in combination with a compound capable of substantially reducing the spectral absorption intensity in an ultraviolet visible region derived from a photosensitive silver halide by a heat development treatment.

In the present invention, a silver iodide complex forming agent is in particular preferably used as the compound for substantially reducing visible light absorption derived from a photosensitive silver halide after heat development

(Explanation of the Silver Iodide Complex Forming Agent)

A silver iodide complex forming agent in the present invention is capable of contributing to the Lewis acid-base reaction in which at least one of a nitrogen atom or a sulfur atom in the compound donates electrons to silver ions as a coordinating atom (electron donor: Lewis base). The stability of the complex is defined by the stepwise stability constant or the overall stability constant. However, it depends upon the combination of three, i.e., silver ions, iodine ions, and the silver complex forming agent. As a general guideline, it is possible to obtain a large stability constant by the chelate effect resulting from the chelate ring formation in the molecule, or a means such as an increase in acid-base dissociation constant of the ligand.

The mechanism of action of the silver iodide complex forming agent in the present invention has not been clearly elucidated. However, presumably, by forming a stable complex with at least ternary components including an iodine ion and a silver ion, the silver iodide is made soluble. The silver iodide complex forming agent in the present invention is poor in capability of making silver bromide or silver chloride soluble. However, it specifically acts on silver iodide.

The details of the mechanism whereby the image storage stability is improved by the silver iodide complex forming agent in the present invention are not apparent. However, the mechanism is based on the following fact. At least a part of the photosensitive silver halide and the silver iodide complex forming agent in the present invention react with each other during heat development, thereby to form a complex, resulting in a reduction or disappearance of the light sensitivity. Particularly, the image storage stability under light irradiation is conceivably largely improved. Further, it is also an important feature that the reduction of the turbidity of the film due to a silver halide results in a clear high-quality image. The turbidity of the film can be confirmed by the reduction of the ultraviolet visible absorption of the spectral absorption spectrum.

In the present invention, the ultraviolet visible absorption spectrum of the photosensitive silver halide can be measured by a transmission process or a reflection process. When the absorption derived from other compounds added to the photothermographic material overlaps with the absorption of the photosensitive silver halide, means such as the difference spectrum, and removal of the other compounds by a solvent are used alone, or in combination, which allows the observation of the ultraviolet visible absorption spectrum of the photosensitive silver halide.

The silver iodide complex forming agent in the present invention is distinctly different from a conventional silver ion complex forming agent in that an iodine ion is essential for forming a stable complex. The conventional silver ion complex forming agent performs a dissolving activity on a salt containing a silver ion such as an organic silver salt including silver bromide, silver chloride, silver behenate, or the like. In contrast, the large feature of the silver iodide complex forming agent in the present invention resides in that it does not act in the absence of silver iodide.

The silver iodide complex forming agents in the present invention are preferably 5- to 7-membered heterocyclic compounds containing at least one nitrogen atom. When it is a compound not having a mercapto group, a sulfide group, or a thione group as a substituent, the 5- to 7-membered heterocyclic rings may be either saturated or unsaturated, and may have other substituents. Further, the substituents on the heterocyclic rings may also be combined with each other to form a ring.

Preferred examples of the 5- to 7-membered heterocyclic compounds may include: pyrrole, pyridine, oxazole, isoxazole, thiazole, isothiazole, imidazole, pyrazole, pyrazine, pyrimidine, pyridazine, indole, isoindole, indolizine, quinoline, isoquinoline, benzimidazole, 1H-imidazole, quinoxaline, quinazoline, cinnoline, phthalazine, naphthyridine, purine, pteridine, carbazole, acridine, phenanthridine, phenanthroline, phenazine, phenoxazine, phenothiazine, benzothiazole, benzoxazole, benzimidazole, 1,2,4-triazine, 1,3,5-triazine, pyrrolidine, imidazolidine, pyrazolidine, piperidine, piperazine, morpholine, indoline, and isoindoline. More preferred examples thereof may include: pyridine, imidazole, pyrazole, pyrazine, pyrimidine, pyridazine, indole, isoindole, indolizine, quinoline, isoquinoline, benzimidazole, 1H-imidazole, quinoxaline, quinazoline, cinnoline, phthalazine, 1,8-naphthyridine, 1,10-phenanthroline, benzimidazole, benztriazole, 1,2,4-triazine, and 1,3,5-azine. Particularly preferred examples thereof may include: pyridine, imidazole, pyrazine, pyrimidine, pyridazine, phthalazine, triazine, 1,8-naphthyridine, and 1,10-phenanthroline.

These rings may also have substituents. Any substituents are acceptable so long as they do not adversely affect the photographic properties. Preferred examples thereof may include: a halogen atom (fluorine atom, chlorine atom, bromine atom, or iodine atom), an alkyl group (straight-chain, branched, or cyclic alkyl group, including a bicycloalkyl group or an active methine group), an alkenyl group, an alkynyl group, an aryl group, a heterocyclic group (any substitution position is acceptable), an acyl group, an alkoxycarbonyl group, an aryloxycarbonyl group, a heterocyclic oxycarbonyl group, a carbamoyl group, an N-acylcarbamoyl group, an N-sulfonylcarbamoyl group, an N-carbamoylcarbamoyl group, an N-sulfamoylcarbamoyl group, a carbazoyl group, a carboxy group or a salt thereof, an oxalyl group, an oxamoyl group, a cyano group, a carbonimidoyl group, a formyl group, a hydroxy group, an alkoxy group (including a group repeatedly containing ethyleneoxy group or propyleneoxy group units), an aryloxy group, a heterocyclic oxy group, an acyloxy group, an (alkoxy or aryloxy)carbonyloxy group, a carbamoyloxy group, a sulfonyloxy group, an amino group, an (alkyl, aryl, or heterocyclic)amino group, an acylamino group, a sulfonamido group, an ureido group, a thioureido group, an imido group, an (alkoxy or aryloxy)carbonylamino group, a sulfamoylamino group, a semicarbazido group, an ammonio group, an oxamoylamino group, an N-(alkyl or aryl)sulfonylureido group, an N-acylureido group, an N-acylsulfamoylamino group, a nitro group, a heterocyclic group containing a quaternized nitrogen atom (e.g., a pyridinio group, an imidazolio group, a quinolinio group, or an isoquinolinio group), an isocyano group, an imino group, an (alkyl or aryl)sulfonyl group, an (alkyl or aryl)sulfinyl group, a sulfo group or a salt thereof, a sulfamoyl group, an N-acylsulfamoyl group, an N-sulfonylsulfamoyl group or a salt thereof, a phosphino group, a phosphinyl group, a phosphinyloxy group, a phosphinylamino group, and a silyl group.

Incidentally, herein, the active methine group denotes a methine group substituted with two electron-attractive groups, and the electron-attractive group herein denotes an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group, or a carbonimidoyl group. Herein, the two electron-attractive groups may combine with each other to form a ring structure. The salt denotes a cation of an alkali metal, an alkaline earth metal, or a heavy metal, or an organic cation such as an ammonium ion or a phosphonium ion. These substituents may also be further substituted with these substituents.

These heterocyclic rings may also be each further condensed with other rings. Whereas, when the substituents are anionic groups (e.g., —CO₂⁻, —SO₃⁻, and —S⁻), the nitrogen-containing heterocyclic rings of the invention may become cations (e.g., pyridinium and 1,2,4-triazolium) to form an inner salt.

When the heterocyclic compound is a pyridine, pyrazine, pyrimidine, pyridazine, phthalazine, triazine, naphthyridine, or phenanthroline derivative, the acid dissociation constant (pKa) at 25° C. in a tetrahydrofuran/water (3/2) mixed solution of the conjugate acid of the nitrogen-containing heterocyclic ring moiety at acid dissociation equilibrium of the compound is further preferably 3 or 8. More preferably, it is 4 or 7.

Such a heterocyclic compound is preferably a pyridine, pyridazine, or phthalazine derivative, and in particular preferably a pyridine or phthalazine derivative.

When these heterocyclic compounds each have a mercapto group, a sulfide group, or a thione group as a substituent, they are each preferably a pyridine, thiazole, isothiazole, oxazole, isoxazole, imidazole, pyrazole, pyrazine, pyrimidine, pyridazine, triazine, triazole, thiadiazole, or oxadiazole derivative, and in particular preferably a thiazole, imidazole, pyrazole, pyrazine, pyrimidine, pyridazine, triazine, or triazole derivative.

For example, the compound represented by the following formula (21) or formula (22) can be utilized for the silver iodide complex forming agent.

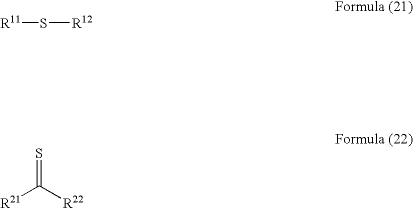

In formula (21), R¹¹ and R¹² each independently represent hydrogen atom or a substituent. In formula (22), R²¹ and R²² each independently represent hydrogen atom or a substituent, providing that both R¹¹ and R¹² are not hydrogen atom and both R²¹ and R²² are not hydrogen atom. The substituent referred to herein can include those described as the substituent for the nitrogen containing 5 to 7-nembered heterocyclic silver iodide complex forming agents described above.

Further, the compound represented by the following formula (23) can also be used preferably.

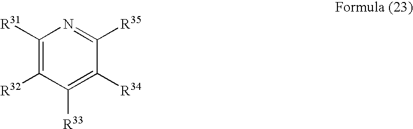

In formula (23), R³¹- R³⁵ each independently represent hydrogen atom or a substituent. The substituent represented by R³¹ to R³⁵ can include those described as the substituent for the nitrogen-containing 5 to 7-membered heterocyclic ring silver iodide complex forming agents described above. In a case where the compound represented by formula (23) has a substituent, a preferred substitution positions are at R³² to R³⁴. R³¹ to R³⁵ may join with each other to form a saturated or unsaturated ring. It is preferably, halogen atom, alkyl group, aryl group, carbamoyl group, hydroxy group, alkoxy group, aryloxy group, carbamoyloxy group, amino group, acylamino group, ureido group, (alkoxy or aryloxy) carbonylamino group.

For the compound represented by formula (23), the acid dissociation constant (pKa) of the conjugated acid for the pyridine ring portion in a mixed solution of tetrahydrofuran/water (3/2) at 25° C. is, preferably, 3 to 8 and particularly preferably, 4 to 7.

Further, the compound represented by formula (24) is also preferred.

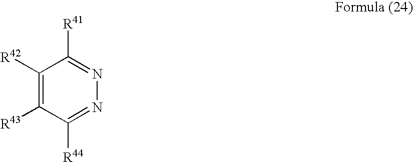

In formula (24), R⁴¹ to R⁴⁴ each independently represent hydrogen atom or a substituent. R⁴¹ to R⁴⁴ may join with each other to form a saturated or unsaturated ring. The substituent represented by R⁴¹ to R⁴⁴ can include those described as the substituent for the nitrogen-containing 5 to 7-nembered heterocyclic silver iodide complex forming agents described above. Preferred group can include an alkyl group, alkenyl group, alkinyl group, aryl group, hydroxy group, alkoxy group, aryloxy group, heterocyclicoxy group, and phthalazine ring formed by benzo ring condensation. In a case where a hydroxyl group is substituted on the carbon atom adjacent with the nitrogen atom of the compound represented by formula (24), equilibrium exists relative to pyridazinone.

The compound represented by formula (24) further preferably forms the phthalazine ring represented by the following formula (25) and, particularly preferably, the phthalazine ring may further have at least one substituent. Examples for R⁵¹ to R⁵⁶ in formula (25) can include those described as the substituent for the nitrogen containing 5 to 7-membered heterocyclic silver iodide complex forming agents. A further preferred substituent can include an alkyl group, alkenyl group, alkinyl group, aryl group, hydroxy group, alkoxy group, and aryloxy group. Preferred are alkyl group, alkenyl group, aryl group, alkoxy group, or aryloxy group. More preferred are alkyl group, alkoxy group, and aryloxy group.

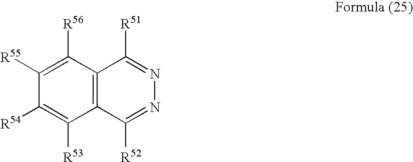

A compound represented by the following formula (26) is also a preferred form.

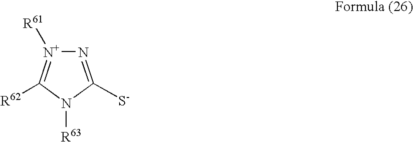

In formula (26), R⁶¹ to R⁶³ each independently represent hydrogen atom or a substituent. Examples for the substituent represented by R⁶² can include those described as the sbustituent for the nitrogen containing 5 to 7-membered heterocyclic silver iodide complex forming agent described above.

The compound used preferably can include the compound represented by the following formula (27).
R⁷¹—S—(L)ₙ—S—R⁷² Formula (27);

In formula (27), R⁷¹ to R⁷² each independently represent hydrogen atom or a substituent, L represents a bivalent connection group, n represents 0 or 1. The substituent represented by R⁷¹ to R⁷² can include, for example, an alkyl group (including cycloalkyl group), alkenyl group (including cycloalkenyl group), alkinyl group, aryl group, heterocyclic group, acyl group, aryloxycarbonyl group, alkoxycarbonyl group, carbamoyl group, or imide group, and composite substituent containing them. The bivalent connection group represented by L is a connection group having a length, preferably, for 1 to 6 atoms and, more preferably, 1 to 3 atoms, and it may have a further substituent.

A further example of the compound used preferably is the compound represented by formula (28).

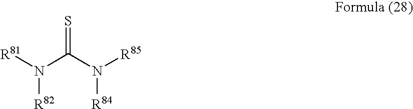

In formula (28), R⁸¹ to R⁸⁵ each independently represent hydrogen atom or a substituent. The substituent represented by R⁸¹ to R⁸⁴ can include, for example, alkyl group (including cycloalkyl group), alkenyl group (including cycloalkenyl group), alkinyl group, aryl group, heterocyclic group, acyl group, aryloxycarbonyl group, alkoxycarbonyl group, carbamoyl group, or imide group.

Among the silver iodide complex forming agents described above, more preferred are those compounds represented by formulae (23), (24), (25), (26), and (27), and the compounds represented by formulae (23) and (25) are particularly preferred.

Preferred examples for the silver iodide complex forming agent in the present invention are to be described below but the invention is not restricted to them.

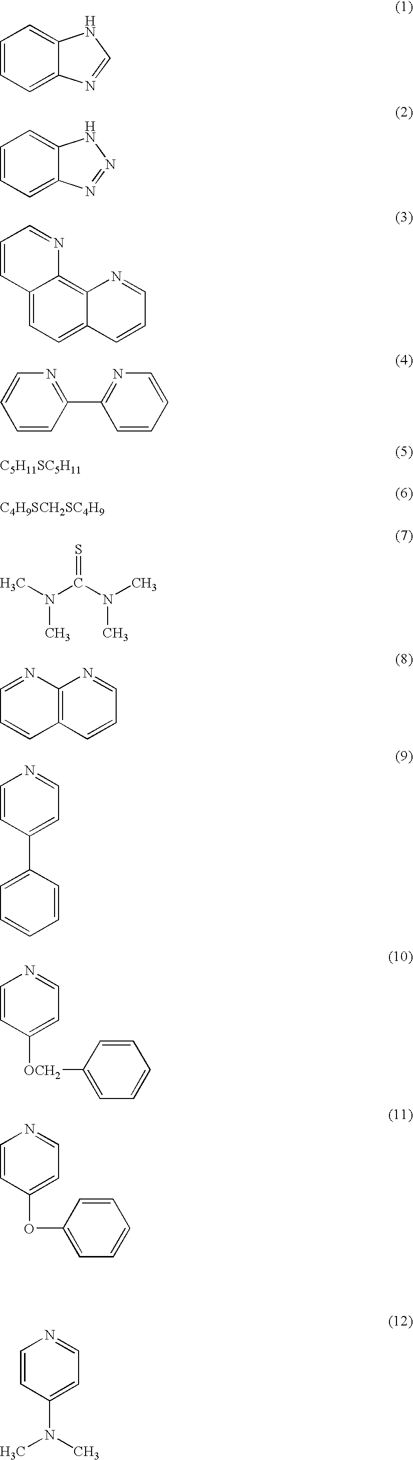

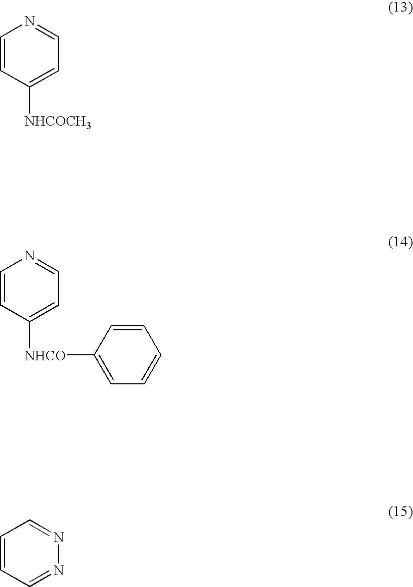

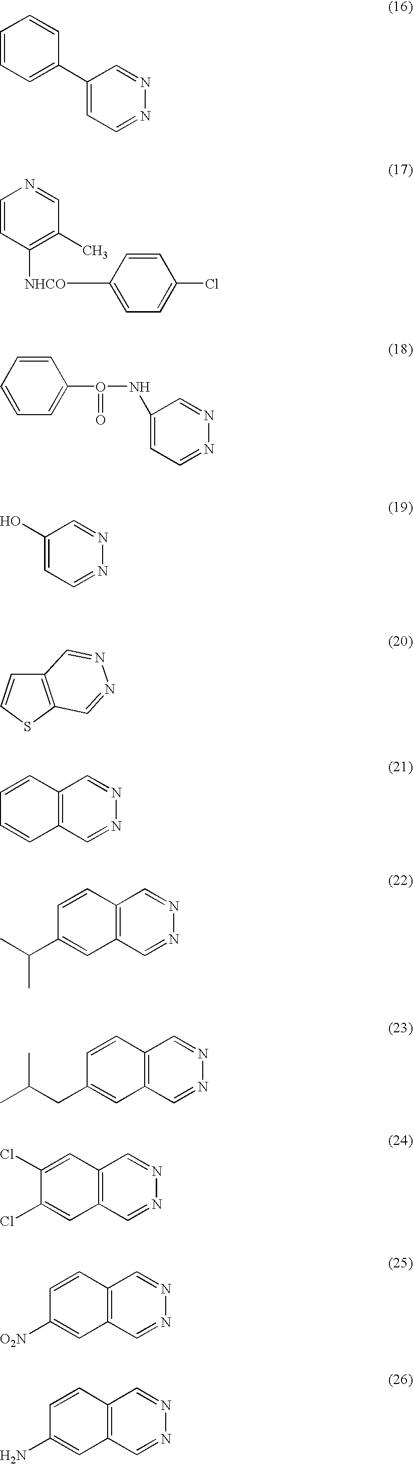

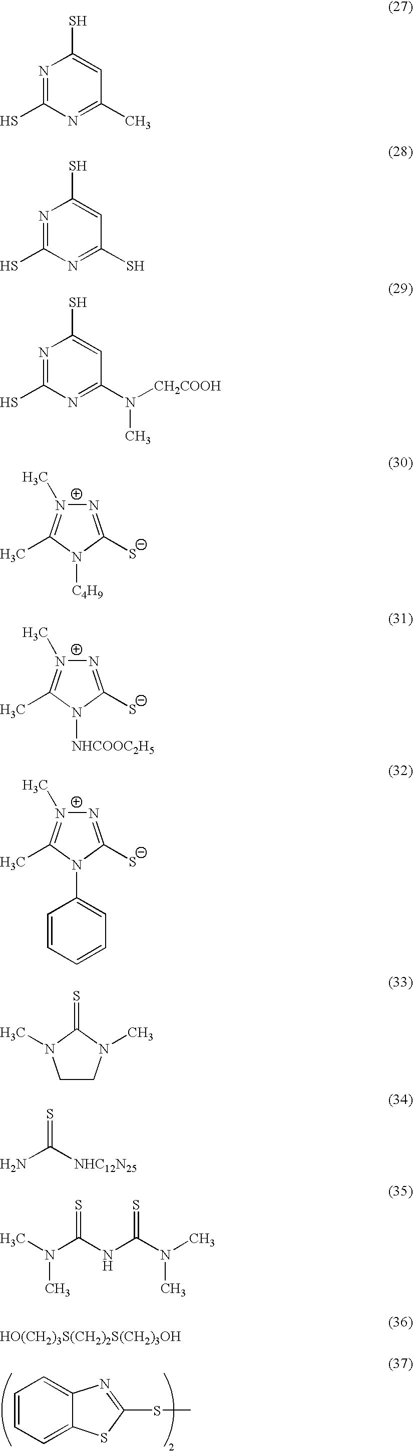

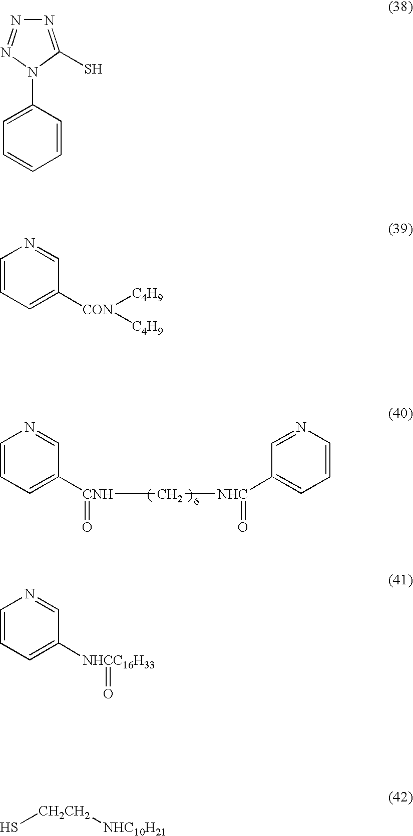

In a case where the silver iodide complex forming agent in the present invention has a function of a color-tone-adjusting agent known so far, it can also be a compound in common with the color-tone-adjusting agent. The silver iodide complex forming agent in the present invention can also be used being combined with the color-tone-adjusting agent. Further two or more kinds of silver iodide complex forming agents may be used in combination.

The silver iodide complex forming agent in the present invention is preferably present in the film in a state being separated from the photosensitive silver halide such as being present as a solid state in the film. It is also preferred to add the agent to the adjacent layer. For the silver iodide complex forming agent in the present invention, the melting point of the compound is preferably controlled within an appropriate range such that it is melted when heated to a heat development temperature.

In the present invention, it is preferable that the absorption intensity of the UV visible absorption spectrum of the photosensitive silver halide after heat development is 80% or less when compared with that before the heat development. It is more preferably 40% or less and, particularly preferably, 10% or less.

The silver iodide complex forming agent in the present invention may be incorporated into the coating solution by any method such as in the form of solution, in the form of emulsified dispersion or in the form of solid fine particle dispersion and incorporated in the photosensitive material.

The well-known emulsifying dispersion method can include a method of dissolving by using an oil such as dibutyl phthalate, tricresyl phosphate, glyceryl triacetate or and diethyl phthalate or an auxiliary solvent such as ethyl acetate and cyclohexanone, and preparing the emulsified dispersion mechanically.

Further, the fine solid particle dispersion method can include a method of dispersing a powder of the silver iodide complex forming agent in the present invention in an appropriate solvent such as water by a ball mill, colloid mill, vibration ball mill, sand mill, jet mill, roller mill or supersonic waves thereby preparing a solid dispersion. In this case, a protection colloid (for example, polyvinyl alcohol), a surfactant (for example, anionic surfactant such as sodium triisopropyl naphthalene sulfonate (mixture of those having different substitution positions for three isopropyl groups)) may be used. In the mills described above, beads of zirconia, etc. are generally used as the dispersion medium, and Zr or the like leaching from the beads may sometimes intrude into the dispersion. Depending on the dispersion condition, it is usually within a range of 1 ppm or more and 1000 ppm or less. When the content of Zr in the photosensitive material is 0.5 mg or less per 1 g of the silver, it causes no practical problem.

The liquid dispersion is preferably incorporated with a corrosion inhibitor (for example, sodium salt of benzoisothiazolinone).

The silver iodide complex forming agent in the present invention is preferably used as a solid dispersion.

The silver iodide complex forming agent in the present invention is preferably used within a range of 1 mol % or more and 5,000 mol % or less, more preferably, within a range of 10 mol % or more and 1000 mol % or less and, further preferably, within a range of 50 mol % or more and 300 mol % or less, based on the photosensitive silver halide.

(Explanation of Binder)

As the binder in the image forming layer in the present invention, any polymer may be used. Preferred binders are transparent or semi-transparent, and generally colorless, and include natural resins, or polymers and copolymers, synthetic resins, or polymers and copolymers, and other media which form a film, such as gelatins, rubbers, poly(vinyl alcohol)s, hydroxyethyl celluloses, cellulose acetates, cellulose acetate butylates, poly(vinylpyrrolidone)s, casein, starch, poly(acrylic acid)s, poly(methylmethacrylic acid)s, poly(vinyl chloride)s, poly(methacrylic acid)s, styrene-maleic anhydride copolymers, styrene-acrylonitrile copolymers, styrene-butadiene copolymers, poly(vinyl acetal)s (e.g., poly(vinyl formal) and poly(vinyl butyral)), poly(ester)s, poly(urethane)s, phenoxy resins, poly(vinylidene chloride)s, poly(epoxide)s, poly(carbonate)s, poly(vinyl acetate)s, poly(olefin)s, cellulose esters, and poly(amide)s. The binders may be coated for formation from water or an organic solvent, or an emulsion.

In the present invention, the binder usable for the layer containing an organic silver salt has a glass transition temperature of preferably 0° C. or more to 80° C. or less (which may be hereinafter referred to as a high Tg binder), more preferably 10° C. or more to 70° C. or less, and further preferably 15° C. or more to 60° C. or less.

Tg in the present specification is calculated according to the following equation.
1/Tg=Σ(Xi/Tgi)

It is assumed here monomer ingredients by the number of n (i=1 to n) are copolymerized in the polymer. Xi represents the weight ratio of the iₜₕ monomer (ΣXi=1) and Tgi represents a glass transition temperature (absolute temperature) of a homopolymer of the iₜₕ monomer. Σ is a sum for i=1 to n. For the value of the glass transition temperature for the homopolymer of each of the monomers (Tgi), values in Polymer Handbook (3rd Edition) (written by J. Brandrup, E. H. Immergut (Wiley-Interscience, 1989)) were adopted.

Two or more kinds of binders may be used together as required. Further, a binder with a glass transition temperature of 20° C. or higher and a binder with a glass transition temperature of lower than 20° C. may be used in combination. In the case of blending two or more kinds of polymers of different Tg for use, it is preferable that weight average Tg thereof is within the range described above.

In the present invention, it is preferred to form the image-forming layer by using a coating solution in which 30 mass % or more of the solvent is water and coating and drying the same to form a coating layer.

In the present invention, the performance can be improved in a case where the image-forming layer is formed by using a coating solution in which 30 mass % or more of the solvent is water and coating and drying the same, and further when the binder in the image-forming layer is soluble or dispersible to an aqueous solvent (water solvent), particularly, when it comprises a polymer latex with an equilibrium water content of 2 mass % or less at 25° C. and 60% RH. A most preferred form is prepared such that the ionic conductivity is 2.5 mS/cm or lower and the preparation method therefor can include a method of conducting purification by using a separation functional film after the synthesis of the polymer.

The aqueous solvent to which the polymer is soluble or dispersible referred to herein is water or mixture of water and 70 mass % or less of a water miscible organic solvent. The water miscible organic solvent can include, for example, alcohols such as methyl alcohol, ethyl alcohol, and propyl alcohol, cellosolves such as methyl cellosolve, ethyl cellosolve, and butyl cellosolve, ethyl acetate, and dimethylformamide.

The term “aqueous solvent” is used herein also for a system in which the polymer is not dissolved thermodynamically but is present in a so-called dispersed state.

“Equilibrium water content (mass %) at 25° C., 60% RH” can be expressed as below by using weight W1 for a polymer at a moisture controlled equilibrium under a 25° C., 60% RH atmosphere and weight W0 for the polymer at 25° C. in an absolute dried state:
Equilibrium water content at 25° C., 60% RH={(W1−W0)/W0}×100 (mass %)

For the definition and the measuring method of the water content, Polymer Engineering Course 14, Polymer Material Test Method (edited by Polymer Society, published from Chijin Shokan) can be referred to for instance.

The equilibrium water content of the binder polymer in the present invention at 25° C., 60% RH is, preferably, 2 mass % or less, more preferably, 0.01 mass % or more and 1.5 mass % or less and, further preferably, 0.02 mass % or more and 1 mass % or less.

In the present invention, a polymer dispersible in an aqueous solvent is particularly preferred. As an example of the dispersed state, either a latex in which fine particles of water insoluble hydrophobic polymer are dispersed, or a dispersion in which polymer molecules are dispersed in the state of molecules or forming micelles may be used, with the latex-dispersed particles being more preferred. The average grain size of the dispersed particles is within a range of 1 nm or more and 50000 nm or less, preferably, within a range of 5 nm or more and 1000 nm or less, more preferably, within a range from 10 nm to 500 nm and, further preferably, within a range of 50 nm or more and 200 nm or less. There is no particular restriction on the grain size distribution of the dispersed particles which may have a wide grain size distribution or a grain size distribution of mono dispersion. Use of two or more of particles having grain size distributions of mono dispersion in admixture is also a preferred method of use for controlling the physical property of the coating solution.

As a preferred embodiment of the polymers dispersible to the aqueous solvent in the present invention, hydrophobic polymers such as acrylic polymers, poly(esters), rubbers (for example SBR resin), poly(urethanes), poly(vinyl chlorides), poly(vinyl acetates), poly(vinylidene chlorides), or poly(olefins) can be used preferably. The polymer may be a linear polymer, branched polymer, or crosslinked polymer. It may be a so-called homopolymer in which single monomers are polymerized or a copolymer in which two or more kinds of monomers are polymerized. In the case of the copolymer, it may be either a random copolymer or a block copolymer. The molecular weight of the polymer, based on the number average molecular weight, is 5000 or more and 1,000,000 or less and, preferably, 10,000 or more and 200,000 or less. A polymer with excessively small molecular weight provides insufficient dynamic strength for the image-forming layer, whereas a polymer of excessively large molecular weight is not preferred since the film-deposition property is poor. Further, the crosslinking polymer latex can be used particularly preferably.

(Specific Example of Polymer Latex)

Specific examples of the preferred polymer latex are shown below. They are expressed by using starting monomers and, in each of parentheses, numerical value means mass % and the molecular weight is a number average molecular weight. In a case of using polyfunctional monomers, since they form crosslinking structures and the concept of the molecular weight can not be applied, it is indicated as “crosslinking” with description for the molecular weight being omitted. Tg represents a glass transition temperature.
P-1: -MMA (70)-EA(27)-MAA(3) latex (molecular weight 37000, Tg 61° C.)
P-2: -MMA (70)-2EHA(20)-St(5)-AA(5) latex(molecular weight 40000, Tg 59° C.)
P-3: -St(50)-Bu(47)-MAA(3) latex (crosslinking, Tg −17° C.)
P-4: -St(68)-Bu(29)-AA(3) latex (crosslinking, Tg 17° C.)
P-5: -St(71)-Bu(26)-AA(3) latex (crosslinking, Tg 24° C.)
P-6: -St(70)-Bu(27)-IA(3) latex (crosslinking),
P-7: -St(75)-Bu(24)-AA(1) latex (crosslinking, Tg 29° C.).
P-8: -St(60)-Bu(35)-DVB(3)-MAA(2) latex (crosslinking),
P-9: -St(70)-Bu(25)-DVB(2)-AA (3) latex (crosslinking),
P-10: -VC(50)-MMA(20)-EA(20)-AN(5)-AA(5) latex (molecular weight 80000),
P-11: -VDC(85)-MMA(5)-EA(5)-MAA(5) latex (molecular weight 67000),
P-12: -Et(90)-MAA(10) latex (molecular weight 12000),
P-13: -St(70)-2EHA(27)-AA(3) latex (molecular weight 130000, Tg 43° C.)
P-14: -MMA(63)-EA(35)-AA(2) latex (molecular weight of 33000, Tg 47° C.),
P-15: -St(70.5)-Bu(26.5)-AA(3) latex (crosslinking, Tg 23° C.),
P-16: -St(69.5)-Bu(27.5)-AA (3) latex (crosslinking, Tg 20.5° C.).

The abbreviations for the structure represent the following monomers. MMA; methyl methacrylate, EA; ethyl acrylate, MAA: methacrylic acid, 2EHA: 2-ethylhexylacrylate, St; styrene, Bu; butadiene, AA; acrylic acid, DVB; divinyl benzene, VC; vinyl chloride, AN; acrylonitrile, VDC; vinylidene chloride, Et; ethylene, IA; itaconic acid.

The polymer latexes described above are also commercially available and the following polymers can be utilized. They can include CEBIAN A-4635, 4718, 4601 (all manufactured by Dicel Chemical Industry Co. Ltd.), and Nipol Lx 811, 814, 821, 820, 857 (manufactured by Nippon Zeon Co.) as examples for the acrylic polymer; FINETEX, ES 650, 611, 675, 850 (manufactured by Dainippon Ink and Chemicals Incorporated), WD-size, and WMS (manufactured by Eastman Chemical Co.) as examples for polyesters, HYDRAN AP 10, 20, 30 and 40 (manufactured by Dainippon Ink and Chemicals Incorporated) as examples for polyurethanes, LACSTAR 7310K, 3307B, 4700H and 7132C (manufactured by Dainippon Ink and Chemicals Incorporated), and Nipol Lx 416, 410, 438C and 2507 (manufactured by Nippon Zeon Co.) as examples for rubbers, G 351, G576 (manufactured by Nippon Zeon Co.) as examples for polyvinyl chlorides, L 502, L513 (manufactured by Asahi Kasei Industry Co.) as examples for polyvinylidene chlorides, and CHEMIPAL S120, SA100 (manufactured by Mitsui Petrochemical Co.) as examples for polyolefins.

The polymer latexes described above may be used alone or two or more of them may be blended as required.

(Preferred Latex)

As the polymer latex used in the present invention, latex of styrene-butadiene copolymer is particularly preferred. The weight ratio between the styrene monomer unit and the butadiene monomer unit in the styrene-butadiene copolymer is, preferably, 40:60 to 95:5. Further, the ratio of the styrene monomer unit and the butadiene monomer unit in the copolymer is, preferably, 60 mass % or more and 99 mass % or less. Further, the polymer latex in the present invention contains acrylic acid or methacrylic acid, preferably, by 1 mass % or more and 6 mass % or less and, more preferably, 2 mass % or more and 5 mass % or less based on the sum of styrene and butadiene. The polymer latex in the present invention preferably contains acrylic acid. A preferred range for the molecular weight is identical with that described previously.

The latex of the styrene-butadiene copolymer preferably used in the present invention can include, for example, P-3 to P-8 and 15 described above, and LACSTAR-3307B, 7132C, Nipol Lx416 as commercial products.

A hydrophilic polymer such as gelatin, polyvinyl alcohol, methyl cellulose, hydroxypropyl cellulose or carboxymethyl cellulose may be added optionally to the image-forming layer of the photosensitive material in the present invention. The addition amount of the hydrophilic polymer is, preferably, 30 mass % or less and, more preferably, 20 mass % or less based on the entire binder for the image-forming layer.

The organic silver salt containing layer (that is, image-forming layer) in the present invention is preferably formed by using the polymer latex. The amount of the binder in the image-forming layer as the weight ratio of the entire binder/organic silver salt is preferably within a range from 1/10 to 10/1, more preferably, within a range from 1/3 to 5/1 and, further preferably, within a range from 1/1 to 3/1.

Further, the image-forming layer is usually also a photosensitive layer containing the photosensitive silver halide as the photosensitive silver salt (image-forming layer), in which the weight ratio for the entire binder/silver halide is, preferably, within a range from 400 to 5 and, more preferably, within a range from 200 to 10.

The entire amount of the binder in the image-forming layer of the invention is within a range, preferably, from 0.2 to 30 g/m², more preferably, 1 to 15 g/m² and, further preferably, 2 to 10 g/m². In the image-forming layer of the invention, a crosslinker for the closslinking and a surfactant for the improvement of the coatability may also be added.

Solvent for Preferred Coating Solution

(Preferred Solvent for Coating Solution)

A solvent for the image-forming layer coating solution of the photosensitive material in the present invention (for the sake of simplicity, the solvent and the dispersant are collectively referred to as the solvent) is preferably an aqueous solvent containing 30 mass % or more of water. As the ingredient other than water, any water miscible organic solvent such as methyl alcohol, ethyl alcohol, isopropyl alcohol, methyl cellosolve, ethyl cellosolve, dimethyl formamide, and ethyl acetate may be used. The water content in the solvent for the coating solution is, preferably, 50 mass % or more and, more preferably, 70 mass % or more. Examples of the preferred solvent composition can include, in addition to water, water/methyl alcohol=90/10, water/methyl alcohol=70/30, water/methyl alcohol/dimethylformamide=80/15/5, water/methyl alcohol/ethyl cellosolve=85/10/5, and water/methyl alcohol/isopropyl alcohol=85/10/5 (numerical value based on mass %). The solvents applicable to the invention are described in paragraph No. 0133 of JP-A No. 11-65021.

(Other Additives)

1) Mercapto, Disulfide and Thions

In the present invention, for controlling the development by suppressing or promoting development, for improving the spectral sensitizing efficiency and improving the storability before and after development, mercapto compounds, disulfide compounds and thion compounds can be incorporated. They are described in JP-A No. 10-62899, in column Nos. 0067 to 0069, the compound represented by formula (I) in JP-A No. 10-186572 and specific examples thereof, in column Nos. 0033 to 0052, and EP-A No. 0803764A1, page 20, lines 36 to 56. Among them, mercapto substituted heterocyclic aromatic compounds described in JP-A Nos. 9-297367, 9-304875, 2001-100358, 2002-303954 and 2002-303951 are preferred.

2) Color-Tone-Adjusting Agent

In the photothermographic material of the invention, the color-tone-adjusting agent is added preferably and the color-tone-adjusting agent is described in JP-A No. 10-62899, in column Nos. 0054 to 0055, EP-A No. 0803764A1, in page 21, lines 23-48, JP-A Nos. 2000-356317 and 2000-187298. Particularly, phthalazinones (phthalazinone, phthalazinone derivatives or metal salts; for example, 4-(1-naphthyl) phthalazinone, 6-chlorophthalazinone, 5,7-dimetoxyphthalazinone and 2,3-dihydro-1,4-phthalazione); combinations of phthalazinones and phthalic acids (for example, phthalic acid, 4-methyl phthalic acid, 4-nitro phthalic acid, diammonium phthalate, sodium phthalate, potassium phthalate, and tetrachloro phthalic acid anhydride); phthalazines (phthalazine, phthalazine derivative or metal salts; for example, 4-(1-naphthyl)phthalazine, 6-isopropyl phthalazine, 6-t-butyl phthalazine, 6-chlorophthalazine, 5,7-dimethoxyphthalazine and 2,3-dihydrophthalazine); and, a combination of phthalazines and phthalic acids is preferred. The combination of phthalazines and phthalic acids is particularly preferred. Among them, particularly preferred combination is that of 6-isopropyl phthalazine and phthalic acid or 4-methylphthalic acid.

3) Plasticizer and Lubricant

In the present invention, known platicizers and lubricants can be used for improving the film property. Particularly, for improving the handlability during production and scratch resistance upon heat development, a lubricant such as liquid paraffin, long chained fatty acid, fatty acid amid, or fatty acid esters is used preferably. Particularly, liquid paraffin removed with low boiling point ingredients or fatty acid esters of a molecular weight of 1000 or more having a branched structure is preferred.

For the plasticizer and the lubricant usable in the image-forming layer and the non-photosensitive layer, those compounds described, in JP-A No. 11-65021, in column No. 0117, JP-A Nos. 2000-5137, 2004-219794, 2004-219802, and 2004-334077 are preferred.

4) Dye and Pigment

For the image-forming layer of the invention, various kinds of dyes and pigments can be used with a view point of improving the color tone, preventing occurrence of interference fringe upon laser exposure and prevention of irradiation (for example, C.I. Pigment Blue 60, C.I. Pigment Blue 64, C.I. Pigment Blue 15:6). They are specifically described, for example, in WO98/36322, and JP-A Nos. 10-268465 and 11-338098.

5) Super Hard Toner

For the formation of a super hard image suitable for printing plate making, a super hard toner is preferably added to the image forming layer. The super hard toners, the incorporation process, and the amount thereof are described in paragraph No. 0118 of JP-A No. 11-65021, paragraph Nos. 0136 to 0193 of JP-A No. 11-223898, as the compounds of the formula (H), formulae (1) to (3). The hardness enhancement promoters are described in paragraph No. 0102 of JP-A No. 11-65021, and paragraph Nos. 0194 and 0195 of JP-A No. 11-223898.

In order to use formic acid or a formic acid salt as a strongly fogging substance, it is preferably contained on the side having the image forming layer containing a photosensitive silver halide in an amount of 5 mmol or less, and more preferably 1 mmol or less, per mole of silver.

When the super hard toner is used in the photothermographic material of the invention, an acid formed by hydration of diphosphorus pentoxide or a salt thereof is preferably used in combination. Examples of the acid formed by hydration of diphosphorus pentoxide or a salt thereof may include metaphosphoric acid (salt), pyrophosphoric acid (salt), orthophosphoric acid (salt), triphosphoric acid (salt), tetraphosphoric acid (salt), and hexametaphosphoric acid (salt). Examples of acids formed by hydration of diphosphorus pentoxide or salts thereof, to be in particular preferably used may include orthophosphoric acid (salt) and hexametaphosphoric acid (salt). Specific examples of the salt include sodium orthophosphate, sodium dihydrogen orthophosphate, sodium hexametaphosphate, and ammonium hexametaphosphate.

The amount of the acid formed by hydration of diphosphorus pentoxide or a salt thereof to be added (the coating amount per square meter of the photosensitive material) may be a desired amount according to the performances including sensitivity, fog, and the like. However, it is preferably 0.1 mg/m² or more to 500 mg/m² or less, and more preferably 0.5 mg/m² or more to 100 mg/m² or less.

The reducing agent, the hydrogen bonding compound, the development accelerator, and the polyhalogen compound in the present invention are preferably used in the form of solid dispersions. The preferred manufacturing methods of the solid dispersions are described in JP-A No. 2002-55405.

(Preparation of Coating Solution and Coating)

The preparation temperature of the image forming layer coating solution in the present invention is preferably 30° C. or more to 65° C. or less. The more preferable temperature is 35° C. or more to less than 60° C. The furthermore preferable temperature is 35° C. or more to 55° C. or less. Whereas, the temperature of the image forming layer coating solution immediately after the addition of a polymer latex is preferably kept at 30° C. or more to 65° C. or less.

(Other Layer Structure and Constituent Components)

1) Surface Protective Layer

The photothermographic material in the present invention may be provided with a surface protective layer for the purpose of preventing adhesion of the image forming layer, and for other purposes. The surface protective layer may be formed in a monolayered structure or in a multilayered structure.

The surface protective layer is described in paragraph Nos. 0119 to 0120 of JP-A Nos. 11-65021, and 2000-171936.

As the binder for the surface protective layer in the present invention, gelatin is preferred. It is also preferably to use polyvinyl alcohol (PVA), or to use it in combination. Usable gelatin is inert gelatin (e.g., Nitta gelatin 750), phthalated gelatin (e.g., Nitta gelatin 801), or the like. As PVA, mention may be made of the ones described in paragraph Nos. 0009 to 0020 of JP-A No. 2000-171936. Preferably, mention may be made of PVA-105 of a completely saponified product, PVA-205 and PVA-335 of partially saponified products, and MP-203 of modified polyvinyl alcohol (all are trade names from Kuraray Co., Ltd.), and the like. The coating amount (per square meter of the support) of polyvinyl alcohol of the protective layer (per one layer) is preferably 0.3 g/m² or more to 4.0 g/m² or less, and more preferably 0.3 g/m² or more to 2.0 g/m² or less.

The coating amount (per square meter of the support) of the total binder (including a water-soluble polymer and a latex polymer) of the protective layer (per one layer) is preferably 0.3 g/m² or more to 5.0 g/m² or less, and more preferably 0.3 g/m² or more to 2.0 g/m² or less.

WhereIn the case of the surface protective layer, a lubricant such as liquid paraffin or aliphatic ester is preferably used. The lubricant is used in an amount in the range of 1 mg/m² or more to 200 mg/m² or less, and in the range of preferably 10 mg/m² or more to 150 mg/m² or less, and more preferably 20 mg/m² or more to 100 mg/m² or less

2) Antihalation Layer

In the photothermographic material of the invention, an antihalation layer can be disposed on the side distant from an exposure light source relative to the image forming layer.

The antihalation layer is described in paragraph Nos. 0123 and 0124 of JP-A Nos. 11-65021, 11-223898, 9-230531, 10-36695, 10-104779, 11-231457, 11-352625, and 11-352626, and the like.

The antihalation layer contains an antihalation dye having an absorption in the exposure wavelength. When the exposure wavelength falls within the infrared region, an infrared-absorbing dye is desirably used. In such a case, the dye having no absorption in the visible region is preferred.

When antihalation is achieved using a dye having an absorption in the visible region, it is preferably configured such that the color of the dye will not substantially remain after image formation; a means for performing decolorizing by the heat from heat development is preferably used; and in particular, a heat color fading dye and a base precursor are preferably added to a non-photosensitive layer so that the layer functions as an antihalation layer. These techniques are described in JP-A No. 11-231457, and the like.

The amount of the color fading dye to be added is determined according to the intended purpose of the dye. In general, the dye is used in an amount such that the optical density (absorbance) measured at an intended wavelength is more than 0.1. The optical density is preferably 0.15 to 2, and more preferably 0.2 to 1. The amount of the dye to be used for obtaining such an optical density is generally about 0.001 g/m² to 1 g/m².

Incidentally, when the dye is color faded in this manner, it is possible to lower the optical density after heat development to 0.1 or less. Two or more kinds of color fading dyes may also be used in combination in the heat decolorizing type recording materials or the photothermographic materials. Similarly, two or more kinds of base precursors may also be used in combination.

In heat color fading using such a color fading dye and the base precursor, it is preferable to use a substance (e.g., diphenylsulfone, or 4-chlorophenyl (phenyl) sulfone) which decreases the melting point by 3° C. (deg) or more when mixed with the base precursor as described in JP-A No. 11-352626, 2-naphthyl benzoate, and the like in combination, from the viewpoint of the heat decolorization property, and the like.

3) Back Layer

The back layer applicable to the invention is described in paragraph Nos. 0128 to 0130 of JP-A No. 11-65021.

In the present invention, a coloring agent having an absorption maximum at 300 to 450 nm can be added for the purposes of improving the silver color tone, and the change with time of images. Such coloring agents are described in JP-A Nos. 62-210458, No. 63-104046, 63-103235, 63-208846, 63-306436, 63-314535, 01-61745, and 2001-100363, and the like.

Such a coloring agent is generally added in an amount in the range of 0.1 mg/m² or more to 1 g/m² or less. As a layer to which it is added, a back layer disposed on the opposite side of the image forming layer is preferred.

Dyes each having an absorption peak at 580 to 680 nm are preferably used in order to control the base color tone. The dyes for this purpose are preferably azomethine type oil-soluble dyes described in JP-A Nos. 4-359967 and 4-359968, and phthalocyanine type water-soluble dyes described in JP-A No. 2003-295388, each having a small absorption intensity on the shorter wavelength side. The dyes for this purpose may be added to any of the layers. However, they are preferably added to the non-photosensitive layer on the image forming layer surface side or on the back surface side.

The photothermographic material in the present invention is preferably a so-called one-sided photosensitive material having at least one layer of an image forming layer containing a silver halide emulsion on one side of the support and having a back layer on the other side.

4) Matting Agent

In the present invention, it is preferable to add a matting agent for improving the transportability. The matting agents are described in paragraph Nos. 0126 and 0127 of JP-A No. 11-65021. The matting agent is coated in an amount of preferably 1 mg/m² or more to 400 mg/m² or less, and more preferably 5 mg/m² or more to 300 mg/m² or less when expressed in terms of the coating amount per square meter of the photosensitive material.

In the present invention, the matting agent may be shaped either in a definite form or in an indefinite form. However, it is preferably shaped in a definite form, and the spherical form is preferably employed.

The volume weighted mean of the sphere equivalent diameter of the matting agent for use in the image forming layer side is preferably 0.3 μm or more to 10 μm or less, and further preferably 0.5 μm or more to 7 μm or less. Whereas, the variation coefficient of the size distribution of the matting agent is preferably 5% or more to 80% or less, and further preferably 20% or more to 80% or less. Herein, the variation coefficient denotes the value expressed as: (standard deviation of particle diameter)/(average value of particle diameter)×100. Further, as the matting agent for the image forming layer side, two or more kinds of matting agents having different average particle sizes can be used. In such a case, the difference in particle size between the matting agent with the largest average particle size and the matting agent with the smallest average particle size is preferably 2 μm or more to 8 μm or less, and further preferably 2 μm or more to 6 μm or less.

The volume weighted mean of the sphere equivalent diameter of the matting agent for use in the back side is preferably 1 μm or more to 15 μm or less, and further preferably 3 μm or more to 10 μm or less. Whereas, the variation coefficient of the size distribution of the matting agent is preferably 3% or more to 50% or less, and further preferably 5% or more to 30% or less. Further, as the matting agent for the back side, two or more kinds of matting agents having different average particle sizes can be used. In such a case, the difference in particle size between the matting agent with the largest average particle size and the matting agent with the smallest average particle size is preferably 2 μm or more to 14 μm or less, and further preferably 2 μm or more to 9 μm or less.

Further, any matting degree of the image forming layer side is acceptable so long as stardust defects will not occur. However, Beck smoothness is preferably 30 seconds or more to 2000 seconds or less, and in particular preferably 40 seconds or more and 1500 seconds or less. Beck smoothness can be determined with ease by Japanese Industrial Standard (JIS) P8119 “Testing Method for Smoothness of Paper and Paperboard by Beck Tester” and TAPPI Standard Method T479.

As the matting degree of the back layer in the present invention, the Beck smoothness is preferably 1200 seconds or less and 10 seconds or more, more preferably 800 seconds or less and 20 seconds or more, and furthermore preferably 500 seconds or less and 40 seconds or more.

In the present invention, the matting agent is preferably contained in the outermost surface layer or a layer functioning as the outermost surface layer of the photosensitive material, or in a layer near the outer surface thereof, or preferably contained in a layer serving as a so-called protective layer.

5) Polymer Latex

When the photothermographic material of the invention is used for printing use in which dimensional change is particularly critical, a polymer latex is preferably used in a surface protective layer or a back layer. Such a polymer latex is described in Gosei Jushi Emulsion, (compiled by Taira Okuda and Hiroshi Inagaki, issued by Kobunshi Kanko Kai (1978)); Gosei Latex no Oyo, (compiled by Takaaki Sugimura, Yasuo Kataoka, Souichi Suzuki, and Keishi Kasahara, issued by Kobunshi Kanko Kai (1993); Gosei Latekkusu no Kagaku (written by Soichi Muroi, issued by Kobunshi Kanko Kai (1970)), and the like. Specific examples thereof may include latex of methyl methacrylate (33.5 mass %)/ethyl acrylate (50 mass %)/methacrylic acid (16.5 mass %) copolymer, latex of methyl methacrylate (47.5 mass %)/butadiene (47.5 mass %)/itaconic acid (5 mass %) copolymer, latex of ethyl acrylate/methacrylic acid copolymer, latex of methyl methacrylate (58.9 mass %)/2-ethylhexyl acrylate (25.4 mass %)/styrene (8.6 mass %)/2-hydroxyethyl methacrylate (5.1 mass %)/acrylic acid (2.0 mass %) copolymer, and latex of methyl methacrylate (64.0 mass %)/styrene (9.0 mass %)/butyl acrylate (20.0 mass %)/2-hydroxyethyl methacrylate (5.0 mass %)/acrylic acid (2.0 mass %) copolymer. Further, as the binder for the surface protective layer, the technique described in paragraph Nos. 0021 to 0025 of JP-A No. 2000-267226, and the technique described in paragraph Nos. 0023 to 0041 of JP-A No. 2000-19678 may also be applied. The ratio of the polymer latex of the surface protective layer is preferably 10 mass % or more and 90 mass % or less, and in particular preferably 20 mass % or more and 80 mass % or less based on the total amount of binder.

6) Film Surface pH

The photothermographic material of the invention preferably has a film surface pH of 7.0 or less, and more preferably 6.6 or less, before heat development treatment. The film surface pH has no particular restriction on the lower limit, but it is about 3. The pH is most preferably in the range of 4 to 6.2. For controlling the film surface pH, an organic acid such as a phthalic acid derivative or a nonvolatile acid such as sulfuric acid, and a volatile base such as ammonia are preferably used from the viewpoint of reducing the film surface pH. In particular, ammonia is preferred to achieve a low film surface pH, because it tends to volatilize, and therefore it can be removed before the coating step or heat development.

Whereas, the process in which a nonvolatile base such as sodium hydroxide, potassium hydroxide, or lithium hydroxide and ammonia are used in combination is also preferably employed. Incidentally, a method for measuring the film surface pH is described in paragraph No. 0123 of JP-A No. 2000-284399.

7) Film Hardener

A film hardener may be used in each of the layers such as the image-forming layer, the protective layer and the back layer.

Examples of the film hardener can include various methods described in “THE THEORY OF THE PHOTOGRAPHIC PROCESS FOURTH EDITION”, written by T. H. James (Published from Macmillan Publishing Co., Inc. in 1977), in pages 77 to 87, and they can include chrome alum, sodium salt of 2,4-dichloro-6-hydroxy-s-trazine, N,N-ethylenebis (vinylsulfone acetoamide), N,N-propylenebis(vinylsulfone acetoamide), as well as polyvalent metal ions described in page 78 of the literature, polyisocyanates described, for example, in U.S. Pat. No. 4,281,060 and JP-A No. 6-208193, epoxy compounds described, for example, in U.S. Pat. No. 4,791,042, and vinylsulfonic compounds described, for example, in JP-A No. 62-89048.

The film hardener is added as a solution and the addition timing of the solution into the protective layer coating solution is from 180 min before to just before the coating and, preferably, from 60 min to 10 sec before the coating. The coating method and the coating condition have no particular restrictions so long as the effect of the invention can be attained sufficiently.

The specific mixing method can include a method of mixing in a tank adapted such that the average staying time calculated based on the addition flow rate and the liquid delivery amount to the coater is controlled to a desired time, or a method of using a static mixer as described in “Liquid Mixing Technology”, written by N. Harnby, M. F. Edwards, A. W. Nienow, and translated by Koji Takahashi (published from Nikkan Kogyo Shinbun-sha in 1989), in Chapter 8.

8) Surface Active Agent

The surface active agents applicable to the invention are described in paragraph No. 0132 of JP-A No. 11-65021

In the present invention, a fluorine-containing surface active agent is preferably used. Specific examples of the fluorine-containing surface active agent may include the compounds described in JP-A Nos. 10-197985, 2000-19680, and 2000-214554. Further, the polymer fluorine-containing surface active agents described in JP-A No. 9-281636 are also preferably used. For the photothermographic material of the invention, the fluorine-containing surface active agents described in JP-A Nos. 2002-82411, and 2003-057780 are preferably used. In particular, the fluorine-containing surface active agents described in JP-A No. 2003-057780 are preferred in terms of the charging control ability, the stability of the coated surface conditions, and the slipping property when coated in the form of an aqueous coating solution for production. The fluorine-containing surface active agents described in JP-A No. 2003-149766 are most preferred in terms of its high charging control ability and small required amount.

In the present invention, the fluorine-containing surface active agent can be used on either side of the image forming layer side and the back side, and preferably used on both the surface sides. Further, it is in particular preferably used in combination with the foregoing conductive layer containing the metal oxide. In this case, even when the amount of the fluorine-containing surface active agent to be used for the side having the conductive layer is reduced or nulled, it is possible to obtain satisfactory performances.

The fluorine-containing surface active agent is used in an amount preferably in the range of 0.1 mg/m² or more to 100 mg/m² or less, more preferably in the range of 0.3 mg/m² or more to 30 mg/m² or less, and furthermore preferably in the range of 1 mg/m² or more to 10 mg/m² or less, respectively for the image forming layer side and the back side.

9) Antistatic Agent

In the present invention, the photothermographic material preferably has a conductive layer containing a metal oxide or a conductive polymer. An antistatic layer may also serve as an undercoat layer, a back layer surface protective layer, or the like, or may also be separately provided. As the conductive material of the antistatic layer, a metal oxide increased in conductivity by introducing an oxygen defect or a different kind of metal atoms in the metal oxide is preferably used. Preferred examples of the metal oxide include ZnO, TiO₂, and SnO₂. Addition of Al or In to ZnO, addition of Sb, Nb, P, a halogen element, or the like to SnO₂, addition of Nb, Ta, or the like to TiO₂ are preferred. In particular, SnO₂ incorporated with Sb is preferred. The amount of a different kind of atoms is preferably in the range of 0.01 mol % or more to 30 mol % or less, and more preferably in the range of 0.1 mol % or more to 10 mol % or less. The metal oxide may be shaped in any of the forms of sphere, needle, and tablet. However, a needle-shaped particles each having a ratio of the major axis/the minor axis of 2.0 or more, and preferably 3.0 to 50 are desirable in terms of the effect of imparting the conductivity. The amount of the metal oxide to be added is preferably in the range of 1 mg/m² or more to 1000 mg/m² or less, more preferably in the range of 10 mg/m² or more to 500 mg/m² or less, and furthermore preferably in the range of 20 mg/m² or more to 200 mg/m² or less. The antistatic layer of the invention may be disposed on any of the image forming layer surface side and the back surface side. However, it is preferably disposed between the support and the back layer. The specific examples of the antistatic layer are described in paragraph No. 0135 of JP-A Nos. 11-65021, 6-143430, 56-143431, 58-62646, and 56-120519, paragraph Nos. 0040 to 0051 of JP-A No. 11-84573, U.S. Pat. No. 5,575, 957, and paragraph Nos. 0078 to 0084 of JP-A No. 11-223898.

10) Support

For a transparent support, polyester, in particular, polyethylene terephthalate, subjected to a heat treatment at a temperature in the range of 130 to 185° C. is preferably used in order to relax the internal distortion remaining in the film during the biaxial stretching, and thereby to eliminate the thermal shrinkage distortion occurring during the heat development treatment. In the case of the photothermographic material for medical use, the transparent support may be colored by a blue dye (e.g., Dye-1 described in Example of JP-A No. 8-240877), or may be colorless. To the support, the undercoating techniques of the water-soluble polyester of JP-A No. 11-84574, the styrene-butadiene copolymer of JP-A No. 10-186565, the vinylidene chloride copolymer of JP-A No. 2000-39684, and the like are preferably applied. The water content of the support is preferably 0.5 mass % or less when the image forming layer or the back layer is coated onto the support.

11) Other Additives

To the photothermographic material, further, an antioxidant, a stabilizing agent, a plasticizer, an UV absorbent, a slipping agent, or a coating aid may also be added. The slipping agent applicable to the invention is described in paragraph Nos. 0061 to 0064 of JP-A No. 11-84573, and paragraph Nos. 0049 to 0062 of JP-A No. 2001-83679. Various additives are added to any of the image forming layers or non-photosensitive layers. With regard to these, WO 98/36322, EP No. 803764A1, JP-A No. 10-186567 and JP-A No. 10-18568, and the like can serve as references.

12) Coating Method

The photothermographic material in the present invention may be coated by any method. Specifically, various coating operations including: extrusion coating, slide coating, curtain coating, dip coating, knife coating, flow coating, and extrusion coating using a hopper of the type described in U.S. Pat. No. 2,681,294 are used. Extrusion coating or slide coating described in LIQUID FILM COATING, written by Stephen F. Kistler, and Petert M. Schweizer, (published by CHAPMAN & HALL Co., Ltd., 1997), pp. 399 to 536 are preferably used. In particular, slide coating is preferably used. An example of the shape of a slide coater for use in the slide coating is shown in FIG. 11b. 1, on page 427 of the same reference. Whereas, if desired, two layers or more layers may be formed at the same time with the method described from page 399 to page 536 of the same reference, and the methods described in U.S. Pat. No. 2,761,791 and GB No. 837,095. In the present invention, the particularly preferred coating methods are the methods described in JP-A Nos. 2001-194748, 2002-153808, No. 2002-153803, and 2002-182333.

The image forming layer coating solution in the present invention is preferably a so-called thixotropy fluid. With regard to this technique, JP-A No. 11-52509 can serve as a reference. The image forming layer coating solution in the present invention has a viscosity at a shear rate of 0.1 S⁻¹ of preferably 400 mPa.s or more and 100,000 mPa.s or less, and more preferably 500 mPa.s or more and 20,000 mPa.s or less. Whereas, at a shear rate of 1000 S⁻¹, the viscosity is preferably 1 mPa.s or more and 200 mPa.s or less, and more preferably 5 mPa.s or more and 80 mPa.s or less.

When the coating solutions are prepared, known inline mixers or in-plant mixers are preferably used for mixing two types of solutions. The preferred inline mixers and in-plant mixers in the present invention are described in JP-A Nos. 2002-85948 and 2002-40940, respectively.

The coating solution in the present invention is preferably subjected to a defoaming treatment for keeping the resulting coated surface conditions favorable. The preferred defoaming treatment method of the invention is the method described in JP-A No. 2002-66431.

When the coating solution is coated, electric charge removal is preferably carried out in order to prevent the deposition of dust, dirt, and the like due to the charging of the support. In the present invention, preferred examples of the charge removal method are described in JP-A No. 2002-143747.

In the present invention, it is important to control the drying air and the drying temperature with precision in order to dry the image forming layer coating solution of a non-setting property. The preferred drying methods in the present invention are described in details in JP-A Nos. 2001-194749 and 2002-139814.

The photothermographic material of the invention is preferably heat treated immediately after coating and drying in order to improve the film-forming property. The temperature of the heat treatment is preferably within the range of 60° C. to 100° C. in terms of the film surface temperature, and the heating time is preferably within 1 second to 60 seconds. The more preferred ranges are 70 to 90° C. for the film surface temperature, and 2 to 10 seconds for the heating time. The preferred heat treatment methods of the invention are described in JP-A No. 2002-107872.

Whereas, the manufacturing methods described in JP-A Nos. 2002-156728 and 2002-182333 are preferably used in order to continuously manufacture the photothermographic materials of the invention with stability.

The photothermographic material is preferably of a mono-sheet type (the type capable of forming images on the photothermographic material without using other sheets such as an image-receiving material).

13) Packaging Material

The photosensitive material of the invention is preferably packaged in a packaging material with a low oxygen permeability and/or moisture permeability in order to suppress the fluctuations in photographic performance during unprocessed stock storage, or in order to improve curling or rolling habit. The oxygen permeability is preferably 50 ml/atm.m².day or less, more preferably 10 ml/atm.m².day or less, and furthermore preferably 1.0 ml/atm.m².day or less at 25° C. The moisture permeability is preferably 10 g/atm.m².day or less, more preferably 5 g/atm.m².day or less, and furthermore preferably 1 g/atm.m².day or less.

Specific examples of the packaging material with a low oxygen permeability and/or moisture permeability are the packaging materials described in, for example, JP-A Nos. 8-254793 and 2000-206653.

14) Other Utilizable Technique

The techniques that can be used for the photothermographic material of the invention can include those described in, EP Nos. 803764A1 and 883022A1, WO98/36322, JP-A Nos. 56-62648, 58-62644, 09-43766, 09-281637, 09-297367, 09-304869, 09-311405, 09-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2001-200414, 2001-234635, 2002-020699, 2001-275471, 2001-275461, 2000-313204, 2001-292844, 2000-324888, 2001-293864, 2001-348546, 2000-187298.

In the case of multicolor photothermographic material, respective image forming layers are kept in such a relation as to be distinct from each other by using a functional or non-functional barrier layer between the respective photosensitive layers as described in U.S. Pat. No. 4,460,681.

A multicolor photothermographic material is configured such that it may contain a combination of these two layers for each color, or may contain all ingredients in a single layer as described in U.S. Pat. No. 4,708,928.

The method for obtaining color images applicable to the invention are described in paragraph No. 0136 of JP-A No. 11-65021.

The photothermographic material of the invention can also be exposed to light with the following method, other than being exposed by means of an X-ray intensifying screen 1.

(Image Forming Method)

1) Exposure

Usable lasers are a He-Ne laser for red to infrared emission, a red semiconductor laser, an Ar⁺, He-Ne, and He-Cd lasers for blue to green emission, and a blue semiconductor laser. They are preferably red to infrared semiconductor lasers. The peak wavelength of the laser light falls within 600 nm to 900 nm, and preferably 620 nm to 850 nm.

On the other hand, in recent years, particularly, a module integrally composed of a SHG (second harmonic generator) device and a semiconductor laser and a blue semiconductor laser have been developed, and a laser output apparatus for a short wavelength region has become a focus of attention. A blue semiconductor laser is capable of high definition image recording, the increase in recording density, and providing a long-life and stable output, and hence it is expected to grow in demand toward the future. The peak wavelength of a blue laser light is 300 nm to 500 nm, and in particular preferably 400 nm to 500 nm.

The laser light oscillated in longitudinal multimode by a process of high frequency superposition or the like is also preferably used.

2) Heat Development

The photothermographic material of the invention may be developed in any manner. However, in general, the imagewise exposed photothermographic material is developed by heating. The preferred development temperature is 80° C. or more to 250° C. or less, preferably 100° C. or more to 140° C. or less, and further preferably 110° C. or more to 130° C. or less. The development time is preferably 1 second or more to 60 seconds or less, more preferably 3 seconds or more to 30 seconds or less, furthermore preferably 5 seconds or more to 25 seconds or less, and most preferably 7 seconds or more to 15 seconds or less.

As a system for heat development, any of a drum type heater and a plate type heater may be used. However, the plate type heater system is more preferred. For a heat development system by the plate type heater system, the method described in JP-A No. 11-133572 is preferred. The system is a heat development apparatus whereby a photothermographic material on which a latent image has been formed is brought in contact with a heating unit in a heat development unit to obtain a visible image. The heat development apparatus is characterized in that the heating unit is composed of a plate heater, a plurality of presser rollers are disposed along one surface of the plate heater and in positions opposite thereto, and that heat development is performed by allowing the photothermographic material to pass between the pressing rollers and the plate heater. Preferably, the plate heater is sectioned into 2 to 6 stages, and the tip is reduced in temperature by about 1 to 10° C. For example, mention may be made of the example in which 4 sets of plate heaters capable of independent temperature control are used, and the respective heaters are controlled so as to be at 112° C., 119° C., 121° C., and 120° C. Such a method is also described in JP-A No. 54-30032. This can remove the moisture and the organic solvent contained in the photothermographic material out of the system, and can suppress the change in shape of the support of the photothermographic material caused by rapidly heating the photothermographic material.

A heat development apparatus is preferably capable of more stable heater control for the size reduction thereof and the shortening of the heat development time. Further, desirably, exposure of one sheet of a sensitive material is started from the front end, and heat development is started before the completion of the exposure to the rear end. Preferred imagers capable of rapid processing in the present invention are described in, for example, JP-A Nos. 2002-289804 and 2002-287668. When this imager is used, for example, it is possible to perform a heat development treatment for 14 seconds by a three-stage plate type heater controlled at 107° C.-121° C.-121° C. This can shorten the output time of the first sheet to about 60 seconds. For such a rapid development treatment, it is preferable to use Photothermographic material-2 of the invention which is high in sensitivity and less susceptible to the environmental temperature in combination.

3) System

As a laser imager having an exposure part and a heat development part for the medical use, Fuji Medical Dry Laser Imager FM-P L or Dry PIX 7000 can be mentioned. FM-DP L are described in Fuji Medical Review No. 8, pp. 39 to 55. It is needless to say that these techniques are applicable to the laser imager for the photothermographic material of the invention. Whereas, these techniques are also applicable as the photothermographic material for the laser imager in “AD network” proposed by Fuji Film Medical Co., Ltd., as a network system adapted to the DICOM Standards.

(Intended Purposes of the Invention)

The photothermographic material of the invention forms a black and white image based on a silver image. It is preferably used as a photothermographic material for the medical diagnosis, as a photothermographic material for the industrial photography, as a photothermographic material for the printing use, and as a photothermographic material for the COM use.

### EXAMPLES

Below, the invention will be specifically described by way of examples, which should not be construed as limiting the scope of the invention.

### [Example 1]

(Preparation of PET Support)

1) Film Formation

PET having an intrinsic viscosity IV=0.66 (measured at 25° C. in phenol/tetrachloroethane=6/4 (weight ratio)) was obtained according to an ordinary method by using terephthalic acid and ethylene glycol. This was pelletized, and then dried at 130° C. for 4 hours, followed by melting at 300° C. Then, the molten PET was extruded through a T-die, and cooled rapidly to prepare an unstreched film.

Using rolls different in circumferential speed, this was longitudinally stretched to 3.3 times, and then laterally stretched to 4.5 times by means of a tenter. The temperatures at this step were 110° C. and 130° C., respectively. Thereafter, the stretched film was thermally fixed at 240° C. for 20 seconds, and then subjected to relaxation in the lateral direction by 4% at the same temperature. Then, after slitting the chuck portion of the tenter, the opposite ends were subjected to knurl processing, and the film was wound at 4 kg/cm² to obtain a 175 μm-thick roll.

2) Surface Corona Discharge Treatment

Using a 6-KVA model of solid state corona discharge treatment apparatus manufactured by Pillar Corporation, the opposite surfaces of the support were treated at 20 m/minute under room temperature. From the read values of current and voltage at this step, it was confirmed that the support was treated at 0.375 kV.A.minute/m². The treatment frequency at this step was 9.6 kHz, and the gap clearance between the electrode and a dielectric roll was 1.6 mm.

3) Undercoating

Formulation (1) (for undercoat layer on the image forming layer side)

| | | |
|---|---|---|
| PESRESIN A-520 (30 mass % solution) | 46.8 | g |
| manufactured by Takamatsu Oil & Fat Co., Ltd., | | |
| Vylonal MD-1200 | 10.4 | g |
| manufactured by Toyobo Co., Ltd., | | |
| Polyethylene glycol monononylphenyl ether | 11.0 | g |
| (average ethylene oxide number = 8.5) 1 mass % solution | | |
| MP-1000 | 0.91 | g |
| (PMMA polymer fine particles, average particle | | |
| diameter = 0.4 μm), manufactured by | | |
| Soken Chemical & Engineering Co., Ltd. | | |
| Distilled water | 931 | ml |

Formulation (2) (for a first layer on the back side)

| | | |
|---|---|---|
| Styrene-butadiene copolymer latex | 130.8 | g |
| (solid content: 40 mass %, styrene/butadiene | | |
| weight ratio = 68/32) | | |
| 2,4-Dichloro-6-hydroxy-S-triazine sodium salt | 5.2 | g |
| 8 mass % aqueous solution | | |
| 1 mass % aqueous solution of sodium laurylbenzenesulfonate | 10 | ml |
| Polystyrene particle dispersion | 0.5 | g |
| (Average particle diameter 2 μm, 20 mass %) | | |
| Distilled water | 854 | ml |

Formulation (3) (for a second layer on the back side)

| | | |
|---|---|---|
| SnO₂/SbO | 84 | g |
| (9/1 mass ratio, average particle diameter: 0.5 μm, | | |
| 17 mass % dispersion) | | |
| Gelatin | 7.9 | g |
| METOLOSE TC-5 (2 mass % aqueous solution) | 10 | g |
| manufactured by Shin-Etsu Chemical Co., Ltd. | | |
| 1 mass % aqueous solution of sodium | 10 | ml |
| dodecylbenzenesulfonate | | |
| NaOH (1 mass %) | 7 | g |
| Proxel (manufactured by Avecia Co.) | 0.5 | g |
| Distilled water | 881 | ml |

Both surfaces of the 175 μm-thick biaxially stretched polyethylene terephthalate support were respectively subjected to the corona discharge treatment. Then, one surface (image forming layer side) thereof was coated with the undercoating solution formulation (1) by a wire bar in a wet coating amount of 6.6 ml/m² (per side), and dried at 180° C. for 5 minutes. Then, the back surface (back side) thereof was coated with the undercoating solution formulation (2) by a wire bar in a wet coating amount of 5.7 ml/m², and dried at 180° C. for 5 minutes. The back surface (back side) was further coated with the undercoating solution formulation (3) by a wire bar in a wet coating amount of 8.4 ml/m², and dried at 180° C. for 6 minutes to prepare an undercoated support.

(Back Layer)

1. Preparation of Back Layer Coating Solution

(Preparation of Solid Fine Particle Dispersion (a) of Base Precursor)

2.5 kg of Base precursor compound 1, 300 g of a surface active agent (trade name: Demol N, manufactured by Kao Corp., Ltd.), 800 g of diphenylsulfone, 1.0 g of benzisothiazolinone sodium salt, and distilled water in an amount such that the total amount become 8.0 kg were mixed. The resulting mixed solution was subjected to beads dispersion using a sand mill of horizontal type (UVM-2: manufactured by Imex Co., Ltd.). The dispersion was accomplished in the following manner. The mixed solution was fed through a diaphragm pump to UVM-2 filled with zirconia beads with an average diameter of 0.5 mm, and dispersed with an internal pressure at 50 hPa or more until a desirable average particle diameter was obtained.

The dispersion was dispersed to the point where upon performing the spectral absorption measurement, the ratio of absorbance at 450 nm to absorbance at 650 nm (D450/D650) in the spectral absorption of the dispersion was 3.0 or more. The dispersion thus obtained was diluted with distilled water so as to be in a concentration of 25 wt % in terms of the concentration of the base precursor. The diluted dispersion was filtrated (through a polypropylene filter with an average pore diameter: 3 μm) for removing dust, and subjected to practical use.

2) Preparation of Dye Solid Fine Particle Dispersion

6.0 kg of Cyanine dye compound-1, 3.0 kg of sodium p-dodecylbenzenesulfonate, and 0.6 kg of a surface active agent, Demol SNB manufactured by Kao Corp., Ltd., and 0.15 kg of an antifoaming agent (trade name: Surfynol 104 E, manufactured by Nissin Chemical Industry, Co., Ltd.) were mixed with distilled water, thereby to make the total solution amount 60 kg. The mixed solution was dispersed by 0.5-mm zirconia beads by means of a sand mill of horizontal type (UVM-2: manufactured by Imex Co., Ltd.).

The dispersion was dispersed to the point where upon performing the spectral absorption measurement, the ratio of absorbance at 650 nm to absorbance at 750 nm (D650/D750) in the spectral absorption of the dispersion was 5.0 or more. The dispersion thus obtained was diluted with distilled water so as to be in a concentration of 6 mass % in terms of the concentration of Cyanine dye. The diluted dispersion was filtrated through a filter (average pore diameter: 1 μm) for removing dust, and subjected to practical use.

3) Preparation of Antihalation Layer Coating Solution

In a vessel kept at 40° C., 40 g of gelatin, 0.1 g of benzothiazolinone, and 490 ml of water were added to dissolve gelatin. Further, 2.3 ml of a 1 mol/l aqueous solution of sodium hydroxide, 40 g of the dye solid fine particle dispersion, 90 g of the solid fine particle dispersion (a) of the base precursor, 12 ml of a 3 mass % aqueous solution of sodium polystyrenesulfonate, and 180 g of a 10 mass % solution of an SBR latex were mixed. Immediately before coating, 80 ml of a 4 mass % aqueous solution of N,N-ethylenebis (vinylsulfonacetamide) was mixed thereto, resulting in an antihalation layer coating solution.

4) Preparation of Back-Side Protective Layer Coating Solution

<<Preparation of Back-Side Protective Layer Coating Solution-1>>

In a vessel kept at 40° C., 40 g of gelatin, 35 mg of benzothiazolinone, and 840 ml of water were added to dissolve gelatin. Further, 5.8 ml of a 1 mol/l aqueous solution of sodium hydroxide, 5 g of a 10 mass % emulsion of a liquid paraffin, 5 g of a 10 mass % emulsion of trimethylolpropane triiostearate, 10 ml of a 5 mass % aqueous solution of sodium di(2-ethylhexyl) sulfosuccinate, 20 ml of a 3 mass % aqueous solution of sodium polystyrenesulfonate, 2.4 ml of a 2 mass % solution of a fluorine-containing surface active agent (F-1), 2.4 ml of a 2 mass % solution of a fluorine-containing surface active agent (F-2), and 32 g of a 19 mass % solution of methyl methacrylate/styrene/butyl acrylate/hydroxyethyl methacrylate/acrylic acid copolymer (copolymerization weight ratio: 57/8/28/5/2) latex, were mixed. Immediately before coating, 25 ml of a 4 mass % aqueous solution of N,N-ethylenebis (vinylsulfonacetamide) was added thereto, resulting in a back side protective layer coating solution.

4) Coating of Back Layer

On the back surface side of the undercoated support, the antihalation layer coating solution and the back-side protective layer coating solution were simultaneously coated in multilayer so that the gelatin coating amount became 0.52 g/m² and the gelatin coating amount became 1.7 g/m², respectively, and dried, to prepare a back layer.

(Image Forming Layer, Intermediate Layer, and Surface Protective Layer)

1. Preparation of Coating Materials

1) Silver Halide Emulsion

<<Preparation of Silver Halide Emulsion 1>>

To 1421 ml of distilled water, 3.1 ml of a 1 mass % potassium iodide solution was added, and further, 3.5 ml of sulfuric acid with a concentration of 0.5 mol/L and 31.7 g of phthalated gelatin were added. The resulting solution was kept at a temperature of 30° C. with stirring in a reaction jar made of stainless steel. Solution A was prepared by diluting 22.22 g of silver nitrate with the addition of distilled water to 95.4 ml, and Solution B was prepared by diluting 15.3 g of potassium bromide and 0.8 g of potassium iodide with the addition of distilled water to a volume of 97.4 ml. The whole amount of Solutions A and B were added thereto at a constant flow rate over 45 seconds. Then, 10 ml of a 3.5 mass % hydrogen peroxide aqueous solution was added thereto, and further, 10.8 ml of a 10 mass % aqueous solution of benzimidazole was added thereto. Further, Solution C was prepared by diluting 51.86 g of silver nitrate with the addition of distilled water to 317.5 ml, and Solution D was prepared by diluting 44.2 g of potassium bromide and 2.2 g of potassium iodide to a volume of 400 ml with distilled water. The whole amount of Solution C was added at a given flow rate over 20 minutes. Whereas, Solution D was added while keeping the pAg at 8.1 with a controlled double jet method. Potassium hexachloroiridate (III) was added in an amount of 1×10⁻⁴ mol per mole of silver all at once after 10 minutes from the start of addition of Solutions C and D. Whereas, an aqueous solution of potassium iron (II) hexacyanide was added in an amount of 3×10⁻⁴ mol per mole of silver all at once after 5 seconds from the completion of addition of Solution C. The pH was adjusted to 3.8 using sulfuric acid with a concentration of 0.5 mol/L, and stirring was stopped. Then, steps of sedimentation/desalting/washing with water were carried out. The resulting mixture was adjusted to pH 5.9 with sodium hydroxide with a concentration of 1 mol/L. Thus, a silver halide dispersion with a pAg 8.0 was prepared.

The silver halide dispersion was kept at 38° C. with stirring, to which was added 5 ml of a 0.34 mass % methanol solution of 1,2-benzisothiazolin-3-one. After 40 minutes, the mixture was heated to 46° C. After 20 minutes from the heating, sodium benzenethiosulfonate was added in an amount of 7.6×10⁻⁵ mol per mole of silver in the form of methanol solution. Further, after 5 minutes, Tellurium sensitizer C was added thereto in an amount of 2.9×10⁻⁴ mol per mole of silver in the form of methanol solution, followed by ripening for 91 minutes. Thereafter, a methanol solution of Spectral sensitizing dye A and Spectral sensitizing dye B in a molar ratio of 3:1 was added thereto in a total amount of Sensitizing dyes A and B of 1.2×10⁻³ mol per mole of silver. After 1 minute, 1.3 ml of a 0.8 mass % methanol solution of N,N′-dihydroxy-N″-diethylmelamine was added thereto, and after another 4 minutes, thereto were added 5-methyl-2-mercaptobenzimidazole in the form of methanol solution in an amount of 4.8×10⁻³ mol per mole of silver, 1-phenyl-2-heptyl-5-mercapto-1,3,4-triazole in the form of methanol solution in an amount of 5.4×10⁻³ mol per mole of silver, and 1-(3-methylureidophenyl)-5-mercaptotetrazole in the form of aqueous solution in an amount of 8.5×10⁻³ mol per mole of silver. As a result, Silver halide emulsion 1 was prepared.

The grains in the prepared silver halide emulsion were silver iodobromide grains uniformly containing iodine in an amount of 3.5 mol %, and having a mean sphere equivalent diameter of 0.038 μm, and a variation coefficient of sphere equivalent diameter of 20%. The grain size and the like were determined from the average of 1000 grains by using an electron microscope. The {100} plane proportion of these grains was determined to be 80% by using the Kubelka-Munk method.

<<Preparation of Silver Halide Emulsion 2>>

Silver halide emulsion 2 was prepared in the same manner as with the preparation of Silver halide emulsion 1, except that the solution temperature of 30° C. during grain formation was changed to 46° C., that Solution B was prepared by diluting 15.9 g of potassium bromide to a volume of 97.4 ml with distilled water, that Solution D was prepared by diluting 45.8 g of potassium bromide to a volume of 400 ml with distilled water, that the length of time over which Solution C was added was changed to 30 minutes, and that the potassium iron (II) hexacyanide was removed. The sedimentation/desalting/washing with water/dispersion were carried out in the same manner as with Silver halide emulsion 1. Further, Silver halide emulsion 2 was obtained by performing spectral sensitization, chemical sensitization, and addition of 5-methyl-2-mercaptobenzimidazole and 1-phenyl-2-heptyl-5-mercapto-1,3,4-triazole in the same manner as with Emulsion 1, except for the following changes: the amount of Tellurium sensitizer C to be added was changed to 1.1×10⁻⁴ mol per mole of silver; the amount of the methanol solution of Spectral sensitizing dye A and Spectral sensitizing dye B in a molar ratio of 3:1 to be added was changed to 7.0×10⁻⁴ mol in terms of the total amount of Sensitizing dyes A and B of per mole of silver; the amount of 1-phenyl-2-heptyl-5-mercapto-1,3,4-triazole was changed to 3.3×10⁻³ mol per mole of silver; and the amount of 1-(3-methylureidophenyl)-5-mercaptotetrazole was changed to 4.7×10⁻³ mol per mole of silver. The emulsion grains of Silver halide emulsion 2 were pure silver bromide cuboidal grains with a mean sphere equivalent diameter of 0.075 μm and a variation coefficient of sphere equivalent diameter of 20%.

<<Preparation of Silver Halide Emulsion 3>>

Silver halide emulsion 3 was prepared in the same manner as with the preparation of Silver halide emulsion 1, except that the solution temperature of 30° C. during grain formation was changed to 26° C. Further, the sedimentation/desalting/washing with water/dispersion were carried out as with Silver halide emulsion 1. Silver halide emulsion 3 was obtained in the same manner as with Emulsion 1, except that Spectral sensitizing dye A and Spectral sensitizing dye B were added in a molar ratio of 1:1 in the form of a solid dispersion (gelatin aqueous solution) in a total amount of Sensitizing dyes A and B of 6×10⁻³ mol per mole of silver, that the amount of Tellurium sensitizer C to be added was changed to 5.2×10⁻⁴ mol per mole of silver, and that after 3 minutes from the addition of the tellurium sensitizer, auric bromide in an amount of 5×10⁻⁴ mol per mole of silver, and potassium thiocyanate in an amount of 2×10⁻³ mol per mole of silver were added. The emulsion grains of Silver halide emulsion 3 were silver iodobromide grains uniformly containing iodine in an amount of 4.0 mol %, and having a mean sphere equivalent diameter of 0.028 μm, and a variation coefficient of sphere equivalent diameter of 20%.

<<Preparation of Mixed Emulsion A for Coating Solution>>

Silver halide emulsion 1 in an amount of 70 mass %, Silver halide emulsion 2 in an amount of 15 mass %, and Silver halide emulsion 3 in an amount of 15 mass % were mixed and dissolved together. Thereto, benzothiazolium iodide was added in the form of a 1 mass % aqueous solution in an amount of 7×10⁻³ mol per mole of silver.

Further, Compounds 1, 2, and 3 each capable of being one-electron oxidized to become a one-electron oxidation product, and releasing one electron or more electrons were each added thereto in an amount of 2×10⁻³ mol per mole of silver of the silver halide.

Adsorptive redox compounds 1 and 2 each having an adsorbing group and a reducing group were each added thereto in an amount of 5×10⁻³ mol per mole of silver of the silver halide.

Further, water was added so that the silver halide content per kilogram of the mixed emulsion for coating solution in terms of silver was 38.2 g. 1-(3-methylureidophenyl)-5-mercaptotetrazole was added thereto in an amount of 0.34 g per kilogram of the mixed emulsion for the coating solution.

<<Preparation of Mixed Emulsions 1 to 3 for Coating Solution>>

Mixed emulsions 1 to 3 for coating solution were prepared in the same manner as with the preparation of Mixed emulsion A for coating solution, except that any one of Silver halide emulsions 1 to 3 was used in place of using Silver halide emulsions 1 to 3.

2) Preparation of Fatty Acid Silver Dispersion

<<Preparation of Fatty Acid Silver Dispersion B>>

(Preparation of Recrystallized Behenic Acid)

100 kg of behenic acid (trade name: Edenor C22-85R) manufactured by Cognis Co., was mixed with 1200 kg of isopropyl alcohol, and dissolved at 50° C. The resulting mixture was filtrated through a 10-μm filter, and then cooled to 30° C. to perform recrystallization. The cooling speed for performing recrystallization was controlled to 3° C./hour. The obtained crystals were subjected to centrifugal filtration, and applied and washed with 100 kg of isopropyl alcohol, followed by drying. The obtained crystals were subjected to esterification and a GC-FID measurement. This indicated that the behenate content was 96 mol %, and that, other than this, lignoceric acid in an amount of 2 mol %, arachidic acid in an amount of 2 mol %, and erucic acid in an amount of 0.001 mol % were contained therein.

<Preparation of Fatty Acid Silver Salt Dispersion B>

88 kg of recrystallized behenic acid, 422 L of distilled water, 49.2 L of an aqueous solution of NaOH with a concentration of 5 mol/L, and 120 L of t-butyl alcohol were mixed, and stirred at 75° C. for 1 hour to effect the reaction, thereby obtaining Sodium behenate solution B. Separately, 206.2 L of an aqueous solution of 40.4 kg of silver nitrate (pH 4.0) was prepared, and kept at a temperature of 10° C. A reaction vessel containing 635 L of distilled water and 30 L of t-butyl alcohol therein was kept at a temperature of 30° C., and the whole amount of Sodium behenate solution B previously prepared and the whole amount of the aqueous solution of silver nitrate were added with sufficient stirring thereto at a constant flow rate over 93 minutes and 15 seconds and over 90 minutes, respectively. This step was carried out in the following manner. Only the aqueous solution of silver nitrate was added for 11 minutes after the start of addition of the aqueous solution of silver nitrate. Thereafter, addition of Sodium behenate solution B was started, and only Sodium behenate solution B was added for 14 minutes and 15 seconds after completion of the addition of the aqueous solution of silver nitrate. At this step, the temperature in the reaction vessel was set at 30° C., and the temperature of the outside was controlled so that the liquid temperature was maintained constant. Further, the piping of the addition system for Sodium behenate solution B was heat-insulated by circulating warm water outside the double pipe, and adjusted so that the liquid temperature at the outlet of the tip of the addition nozzle became 75° C. Whereas, the piping of the addition system for the aqueous solution of silver nitrate was heat-insulated by circulating cool water outside the double pipe. The position of adding Sodium behenate solution B and the position of adding the aqueous solution of silver nitrate were arranged symmetrically with respect to the stirring shaft as the center, and adjusted at such a height as not to cause contact with the reaction solution.

After completion of the addition of Sodium behenate solution B, the mixture was allowed to stand with stirring for 20 minutes with the temperature unchanged, and heated to 35° C. over 30 minutes, followed by ripening for 210 minutes. Immediately after completion of ripening, the solid content was separated by centrifugal filtration, and then the solid content was washed with water until the conductivity of the filtrate water became 30 μS/cm. A fatty acid silver salt was obtained in this manner. The obtained solid content was not dried, and stored in the form of a wet cake.

The shapes of the obtained silver behenate grains were evaluated by an electron microscopic photography, so that the grains were found to be crystals having a=0.21 μm, b=0.4 μm, and c=0.4 μm, in average values, an average aspect ratio of 2.1, and a variation coefficient of sphere equivalent diameter of 11% (a, b, and c are defined in this specification).

To the wet cake corresponding to 260 kg of the dry solid content, 19.3 kg of polyvinyl alcohol (trade name: PVA-217) and water were added to make the total amount 1000 kg. Then, the resulting mixture was made into a slurry by means of a dissolver blade, and further pre-dispersed by means of a pipeline mixer (PM-10 model: manufactured by MIZUHO Industrial Co., Ltd.).

Then, the pre-dispersed stock dispersion was treated three times by means of a dispersing machine (trade name: Microfluidizer-M-610, manufactured by Microfluidex International Corporation, using Z model interaction chamber) with the pressure controlled to be 1150 kg/cm² to obtain a silver behenate dispersion. During the cooling operation, the dispersion temperature was set at 18° C. by providing coiled heat exchangers fixed before and after the interaction chamber, and controlling the temperature of the refrigerant.

3) Preparation of Reducing Agent Dispersion

(Preparation of Reducing Agent-1 Dispersion)

To 10 kg of Reducing agent-1 (6,6′-di-t-butyl-4,4′-dimethyl-2,2′-butylidene diphenol), and 16 kg of a 10 mass % aqueous solution of modified polyvinyl alcohol (POVAL MP203 manufactured by Kuraray Co., Ltd.), 10 kg of water was added, and well mixed, resulting in a slurry. The slurry was fed through a diaphragm pump to a sand mill of horizontal type (UVM-2: manufactured by Imex Co., Ltd.) filled with zirconia beads having an average diameter of 0.5 mm, and dispersed therein for 3 hours and 30 minutes. Then, 0.2 g of benzoisothiazolinone sodium salt and water were added thereto, so that the concentration of the reducing agent was adjusted to 25 mass %. The resulting dispersion was heat treated at 40° C. for 1 hour, and subsequently further heat-treated at 80° C. for 1 hour to obtain Reducing agent-1 dispersion. The reducing agent grains contained in the reducing agent dispersion thus obtained had a median diameter of 0.50 μm and a maximum grain diameter of 1.6 μm or less. The reducing agent dispersion obtained was filtered through a filter made of polypropylene, having a pore size of 3.0 μm, to remove foreign matters such as dusts, and stored.

<<Preparation of Reducing Agent-2 Dispersion>>

To 10 kg of Reducing agent-2 (6.6′-di-t-butyl-4,4′-diethyl-2,2′-methylidene diphenol), and 16 kg of a 10 mass % aqueous solution of modified polyvinyl alcohol (POVAL MP203 manufactured by Kuraray Co., Ltd.), 10 kg of water was added, and well mixed, resulting in a slurry. The slurry was fed through a diaphragm pump to a sand mill of horizontal type (UVM-2: manufactured by Imex Co., Ltd.) filled with zirconia beads having an average diameter of 0.5 mm, and dispersed therein for 3 hours and 30 minutes. Then, 0.2 g of benzoisothiazolinone sodium salt and water were added thereto, so that the concentration of the reducing agent was adjusted to 25 mass %. The resulting dispersion was heat treated at 40° C. for 1 hour, and subsequently further heat treated at 80° C. for another hour to obtain Reducing agent-2 dispersion. The reducing agent grains contained in the reducing agent dispersion thus obtained had a median diameter of 0.45 μm and a maximum grain diameter of 1.4 μm or less. The reducing agent dispersion obtained was filtered through a filter made of polypropylene, having a pore size of 3.0 μm, to remove foreign matters such as dusts, and stored.

<<Preparation of Other Reducing Agent Dispersions>>

Reducing agent dispersions were prepared in the same manner as with the preparation of Reducing-1 dispersion, except that Reducing agent-1 was changed to the reducing agents shown in Table 1.

4) Preparation of Hydrogen Bonding Compound-1 Dispersion

To 10 kg of Hydrogen bonding compound-1 (tri(4-t-butylphenyl)phosphine oxide), and 16 kg of a 10 mass % aqueous solution of modified polyvinyl alcohol (POVAL MP203 manufactured by Kuraray Co., Ltd.), 10 kg of water was added, and well mixed, resulting in a slurry. The slurry was fed through a diaphragm pump to a sand mill of horizontal type (UVM-2: manufactured by Imex Co., Ltd.) filled with zirconia beads having an average diameter of 0.5 mm, and dispersed therein for 4 hours. Then, 0.2 g of benzoisothiazolinone sodium salt and water were added thereto, so that the concentration of the hydrogen bonding compound was adjusted to 25 mass %. The dispersion was heated at 40° C. for 1 hour, and subsequently further warmed at 80° C. for another hour to obtain Hydrogen bonding compound-1 dispersion. The hydrogen bonding compound grains contained in the hydrogen bonding compound dispersion thus obtained had a median diameter of 0.45 μm and a maximum grain diameter of 1.3 μm or less. The hydrogen bonding compound dispersion obtained was filtered through a filter made of polypropylene, having a pore size of 3.0 μm, to remove foreign matters such as dusts, and stored.

5) Preparation of Development Accelerator-1 Dispersion

To 10 kg of Development accelerator-1, and 20 kg of a 10 mass % aqueous solution of modified polyvinyl alcohol (POVAL MP203 manufactured by Kuraray Co., Ltd.), 10 kg of water was added, and well mixed, resulting in a slurry. The slurry was fed through a diaphragm pump to a sand mill of horizontal type (UVM-2, manufactured by Imex Co., Ltd.) filled with zirconia beads having an average diameter of 0.5 mm, and dispersed therein for 3 hours and 30 minutes. Then, 0.2 g of benzoisothiazolinone sodium salt and water were added thereto, so that the concentration of the development accelerator was adjusted to 20 mass %. Thus, Development accelerator-1 dispersion was obtained. The development accelerator grains contained in the development accelerator dispersion thus obtained had a median diameter of 0.48 μm and a maximum grain diameter of 1.4 μm or less. The development accelerator dispersion obtained was filtered through a filter made of polypropylene, having a pore size of 3.0 μm, to remove foreign matters such as dusts, and stored.

6) Preparation of Dispersions of Development Accelerator-2 and Tone Modifier-1

Also for the solid dispersions of Development accelerator-2 and Tone modifier-1, dispersion was carried out in the same manner as with Development accelerator-1, to obtain 20 mass % and 15 mass % dispersions, respectively.

7) Preparation of Polyhalogen Compound

<<Preparation of Organic Polyhalogen Compound-1 Dispersion>>

10 kg of Organic polyhalogen compound-1 (tribromomethane sulfonylbenzene), 10 kg of a 20 mass % aqueous solution of modified polyvinyl alcohol (POVAL MP203 manufactured by Kuraray Co., Ltd.), 0.4 kg of a 20 mass % aqueous solution of sodium triisopropyl naphthalene sulfonate, and 14 kg of water were added together, and well mixed, resulting in a slurry. The slurry was fed through a diaphragm pump to a sand mill of horizontal type (UVM-2, manufactured by Imex Co., Ltd.) filled with zirconia beads having an average diameter of 0.5 mm, and dispersed therein for 5 hours. Then, 0.2 g of benzoisothiazolinone sodium salt and water were added thereto, so that the concentration of the organic polyhalogen compound was adjusted to 26 mass %. Thus, Organic polyhalogen compound-1 dispersion was obtained. The organic polyhalogen compound grains contained in the organic polyhalogen compound dispersion thus obtained had a median diameter of 0.41 μm and a maximum grain diameter of 2.0 μm or less. The organic polyhalogen compound dispersion obtained was filtered through a filter made of polypropylene having a pore size of 10.0 μm to remove foreign matters such as dusts, and stored.

<<Preparation of Organic Polyhalogen Compound-2 Dispersion>>

10 kg of Organic polyhalogen compound-2 (N-butyl-3-tribromomethane sulfonyl benzamide), 20 kg of a 10 mass % aqueous solution of modified polyvinyl alcohol (POVAL MP203 manufactured by Kuraray Co., Ltd.), and 0.4 kg of a 20 mass % aqueous solution of sodium triisopropyl naphthalene sulfonate, were added together, and well mixed, resulting in a slurry. The slurry was fed through a diaphragm pump to a sand mill of horizontal type (UVM-2, manufactured by Imex Co., Ltd.) filled with zirconia beads having an average diameter of 0.5 mm, and dispersed therein for 5 hours. Then, 0.2 g of benzoisothiazolinone sodium salt and water were added thereto, so that the concentration of the organic polyhalogen compound was adjusted to 30 mass %. The resulting dispersion was warmed at 40° C. for 5 hours to obtain Organic polyhalogen compound-2 dispersion. The organic polyhalogen compound grains contained in the organic polyhalogen compound dispersion thus obtained had a median diameter of 0.40 μm and a maximum grain diameter of 1.3 μm or less. The organic polyhalogen compound dispersion obtained was filtered through a filter made of polypropylene, having a pore size of 3.0 μm, to remove foreign matters such as dusts, and stored.

8) Preparation of Phthalazine Compound-1 Solution

8 kg of modified polyvinyl alcohol MP203 manufactured by Kuraray Co., Ltd., was dissolved in 174.57 kg of water. Then, 3.15 kg of a 20 mass % aqueous solution of sodium triisopropyl naphthalene sulfonate and 14.28 kg of a 70 mass % aqueous solution of Phthalazine compound-1 (6-isopropyl phthalazine) were added thereto to prepare a 5 mass % solution of Phthalazine compound-1.

9) Preparation of Mercapto Compound

<<Preparation of Mercapto Compound-2 Aqueous Solution>>

20 g of Mercapto compound-2 (1-(3-methylureidophenyl)-5-mercaptotetrazole) was dissolved in 980 g of water, resulting in a 2.0 mass % aqueous solution.

10) Preparation of Pigment-1 Dispersion

To 64 g of C.I. Pigment Blue 60 and 6.4 g of Demol N manufactured by Kao Corp., Ltd., 250 g of water was added, and well mixed, resulting in a slurry. 800 g of zirconia beads with an average diameter of 0.5 mm were prepared, and injected together with the slurry in a vessel. Dispersion was carried out for 25 hours by means of a disperser (1/4 G sand grinder mill: manufactured by Imex Co., Ltd.). To the resulting dispersion, water was added so that the concentration of pigment was adjusted to 5 mass %, to obtain Pigment-1 dispersion. The pigment grains contained in the pigment dispersion thus obtained had an average grain diameter of 0.21 μm.

11) Preparation of SBR Latex Solution

A SBR latex was prepared in the following manner.

A polymerizer of a gas monomer reaction apparatus (TAS-2J model, manufactured by TAIATS TECHNO CORPORATION, Ltd.) was charged with 287 g of distilled water, 7.73 g of a surface active agent (PAIONIN A-43-S (produced by TAKEMOTO Oil & Fat Co., Ltd.): solid content 48.5 mass %), 14.06 ml of 1 mol/l NaOH, 0.15 g of tetrasodium ethylenediaminetetraacetate, 255 g of styrene, 11.25 g of acrylic acid, and 3.0 g of tert-dodecylmercaptane. The reaction vessel was closed, and the contents were stirred at a stirring rate of 200 rpm. Degassing was carried out by a vacuum pump to repeat nitrogen gas replacement several times. Then, 108.75 g of 1,3-butadiene was injected therein, and the internal temperature was raised up to 60° C. A solution of 1.875 g of ammonium persulfate dissolved in 50 ml of water was added thereto, and stirred as it wIn the case of 5 hours. Further, the temperature was raised up to 90° C. Stirring was carried out for 3 hours, and the internal temperature was decreased down to room temperature after the completion of the reaction. Then, 1 mol/l NaOH and NH₄OH were added in a molar ratio of Na⁺ions: NH4⁺ions=1:5.3 to adjust the pH to 8.4. Thereafter, the solution was filtered through a filter made of polypropylene, having a pore size of 1.0 μm, to remove foreign matters such as dusts, and stored. As a result, 774.7 g of a SBR latex was obtained. The resulting latex was analyzed for halogen ions with ion chromatography, and as a result, the chloride ion concentration was found to be 3 ppm. The chelating agent concentration was determined with high performance liquid chromatography, and as a result, it was found to be 145 ppm.

The foregoing latex has the following characteristics: average particle diameter, 90 nm; Tg=17° C.; solid content concentration, 44 mass %; equilibrium moisture content at 25° C. and 60% RH, 0.6 mass %; and ionic conductivity, 4.80 mS/cm (the ionic conductivity measurement was carried out for a latex stock solution (44 mass %) at 25° C. using a conductivity meter CM-30S manufactured by TOA Electronics Ltd.).

2. Preparation of Coating Solution

1) Preparation of Image Forming Layer Coating Solution-1 (to be used for a Single Image Forming Layer)

900 g of the Fatty acid silver dispersion B obtained above, 135 ml of water, 36 g of Pigment-1 dispersion, 25 g of Organic polyhalogen compound-1 dispersion, 39 g of Organic polyhalogen compound-2 dispersion, 171 g of Phthalazine compound-l solution, 1060 g of a SBR latex (Tg: 17° C.) solution, 153 g of Reducing agent-1 dispersion, 55 g of Hydrogen bonding compound-1 dispersion, 4.8 g of Development accelerator-1 dispersion, 5.2 g of Development accelerator-2 dispersion, 2.1 g of Tone modifier-1 dispersion, and 8 ml of Mercapto compound-2 aqueous solution were successively added. Immediately before coating, to the resulting mixture, 100 g of Silver halide mixed emulsion A was added, and well mixed to prepare an image forming layer coating solution. The resulting solution was fed as it was to a coating die for coating.

The viscosity of the image forming layer coating solution was determined by means of a B-model viscometer from Tokyo Instrument Co., Ltd., and was found to be 40 [mPa.s] at 40° C. (No. 1 rotor, 60 rpm).

The viscosities of the coating solution at 38° C. determined by means of a Rheo Stress RS150 produced by Haake Co., were 30, 43, 41, 28, and 20 [mPa.s] at shear rates of 0.1, 1, 10, 100, and 1000 [1/sec], respectively.

The amount of zirconium in the coating solution was 0.30 mg per gram of silver.

2) Preparation of Image Forming Layer Coating Solution for a Plurality of Image Forming Layers

<<Preparation of Image Forming Layer Coating Solution-2>> (to be Used for a High Sensitivity Layer)

Image forming layer coating solution-2 was prepared in the same manner as with Image forming layer coating solution-1, except that Reducing agent-1 dispersion was changed to Reducing agent-2 dispersion, that Development accelerator-1 was removed, that the amount of Development accelerator-2 was changed to the two-fold amount, and further that Silver halide emulsions 1 to 3 of Silver halide mixed emulsion A were changed to 100 mass % of Silver halide emulsion-2 alone, for Image forming layer coating solution-1. The coating solution was used as the coating solution for the high sensitivity layer when the image forming layer is configured in a two-layered structure.

<<Preparation of Image Forming Layer Coating Solution-3>> (to be Used for a Low Sensitivity Layer)

Image forming layer coating solution-3 was prepared in the same manner as with Image forming layer coating solution-i, except that the amount of Polyhalogen compounds-1 and -2 was changed to the half amount, that Development accelerator-1 was removed, that the amount of Development accelerator-2 was changed to the two-fold amount, and further that Silver halide emulsions 1 to 3 of Silver halide mixed emulsion A were changed to a 50 mass %/50 mass % mixture of Silver halide emulsions-1 and -3, for Image forming layer coating solution-1. The coating solution was used as the coating solution for the low sensitivity layer when the image forming layer is configured in a two-layered structure.

The other high sensitivity layer and low sensitivity layer coating solutions were respectively prepared in the same manner as described above, except that Image forming layer coating solution-2 or the reducing agent of 3 was changed to the designated reducing agent.

3) Preparation of Intermediate Layer Coating Solution

To 1000 g of polyvinyl alcohol PVA-205 (manufactured by Kuraray Co., Ltd.), 163 g of Pigment-1 dispersion, 33 g of a 18.5 mass % aqueous solution of Blue dye compound-1 (manufactured by Nippon Kayaku Co.: Kayafect Turquoise RN Liquid 150), 27 ml of a 5 mass % aqueous solution of sodium di(2-ethylhexyl) sulfosuccinate, and 4200 ml of a 19 mass % solution of methyl methacrylate/styrene/butyl acrylate/hydroxyethyl methacrylate/acrylic acid copolymer (copolymerization weight ratio 57/8/28/5/2) latex, 27 ml of a 5 mass % aqueous solution of Aerosol OT (manufactured by American Cyanamide Co.), and 135 ml of a 20 mass % aqueous solution of diammonium phthalate were added, and water was added to make the total amount 10000 g. The mixture was adjusted to pH 7.5 with NaOH, resulting in an intermediate layer coating solution. The solution was fed to a coating die so as to achieve 8.9 ml/m².

The viscosity of the coating solution was determined by means of a B-model viscometer, and found to be 58 [mPa.s] at 40° C. (No. 1 rotor, 60 rpm).

4) Preparation of Surface Protective Layer First Layer Coating Solution

100 g of inert gelatin and 10 mg of benzisothiazolinone were dissolved in 840 ml of water. To the resulting solution, 180 g of a 19 mass % solution of methyl methacrylate/styrene/butyl acrylate/hydroxyethyl methacrylate/acrylic acid copolymer (copolymerization weight ratio 57/8/28/5/2) latex, 46 ml of a 15 mass % methanol solution of phthalic acid, and 5.4 ml of a 5 mass % aqueous solution of sodium di(2-ethylhexyl) sulfosuccinate were added and mixed. 40 ml of 4 mass % chrome alum was mixed therein by a static mixer immediately before coating. The resulting mixture was fed to a coating die so as to achieve a coating solution amount of 26.1 ml/m².

The viscosity of the coating solution was determined by means of a B-model viscometer, and found to be 20 [mPa.s] at 40° C. (No. 1 rotor, 60 rpm).

5) Preparation of Surface Protective Layer Second Layer Coating Solution

100 g of inert gelatin and 10 mg of benzisothiazolinone were dissolved in 800 ml of water. To the resulting solution, 40 g of a 10 mass % emulsion of liquid paraffin, 40 g of a 10 mass % emulsion of dipentaerythrityl hexaisostearate, 180 g of a 19 mass % solution of methyl methacrylate/styrene/butyl acrylate/hydroxyethyl methacrylate/acrylic acid copolymer (copolymerization weight ratio 57/8/28/5/2) latex, 40 ml of a 15 mass % methanol solution of phthalic acid, 5.5 ml of a 1 mass % solution of fluorine-containing surface active agent (F-1), 5.5 ml of a 1 mass % aqueous solution of fluorine-containing surface active agent (F-2), 28 ml of a 5 mass % aqueous solution of sodium di(2-ethylhexyl) sulfosuccinate, 4 g of polymethyl methacrylate fine particles (average particle diameter 0.7 μm, volume weighted mean distribution 30%), and 21 g of polymethyl methacrylate fine particles (average particle diameter 3.6 μm, volume weighted mean distribution 60%) were mixed, resulting in a surface protective layer coating solution. The solution was fed to a coating die so as to achieve 8.3 ml/m².

The viscosity of the coating solution was determined by means of a B-model viscometer, and found to be 19 [mPa.s] at 40° C. (No. 1 rotor, 60 rpm).

3. Preparation of Photothermographic Material

1) Preparation of Photothermographic Material-101

On the surface opposite to the back surface, the image forming layer coating solution-1, the intermediate layer coating solution, the surface protective layer first layer coating solution, and the surface protective layer second layer coating solution were simultaneously coated in multilayer by a slide bead coating process in this order from the undercoated surface, thereby to prepare a sample of the photothermographic material. At this step, the image forming layers and the intermediate layer were temperature controlled to 31° C.; the surface protective layer first layer coating solution, 36° C.; and the surface protective layer second layer coating solution, 37° C.

The coating amount (g/m²) of each compound of the image forming layer at this step is as follows.

| | |
|---|---|
| Fatty acid silver | 4.74 |
| Pigment (C.I. Pigment Blue 60) | 0.036 |
| Polyhalogen compound-1 | 0.14 |
| Polyhalogen compound-2 | 0.28 |
| Phthalazine compound-1 | 0.18 |
| SBR latex | 9.43 |
| Reducing agent-1 | 0.77 |
| Hydrogen bonding compound-1 | 0.28 |
| Development accelerator-1 | 0.019 |
| Development accelerator-2 | 0.016 |
| Tone modifier-1 | 0.006 |
| Mercapto compound-2 | 0.003 |
| Silver halide (in terms of Ag) | 0.10 |

The coating and drying conditions were as follows.

The coating was carried out at a speed of 160 m/min., and the clearance between the tip of the coating die and the support was set at 0.10 to 0.30 mm. The pressure in a reduced pressure chamber was set at a pressure lower than atmospheric pressure by 196 to 882 Pa. Electrostatic charges were eliminated from the support by ionic air before coating. In a subsequent chilling zone, the coating solutions were cooled by air having a dry-bulb temperature of 10 to 20° C., followed by non-contact type transfer. Then, the sample was dried by dry air having a dry-bulb temperature of 23 to 45° C., and a wet-bulb temperature of 15 to 21° C. in a helical type contactless drying apparatus.

After drying, the sample was subjected to moisture conditioning at 25° C. and humidify 40% to 60% RH, and then, heated so that the temperature of the film surface was elevated to 70 to 90° C. After heating, the film surface was cooled to 25° C.

2) Preparation of Photothermographic Materials-102 and -103

Photothermographic material-102 was manufactured in the same manner as with the preparation of Photothermographic material-101, except that Image forming layer coating solutions-2 and -3 were used in place of using Image forming layer coating solution-1. The coating amount (g/m²) of the organic acid silver of the image forming layer at this step is the same as in Photothermographic material-101.

3) Preparation of Photothermographic Materials-104 to -111

Photothermographic materials-104 to -111 were manufactured in the same manner as with the preparation of Photothermographic material-101, except that in place of using Image forming layer coating solution-1, any two of Image forming layer coating solutions-2 to -4 were respectively coated in a coating amount of 50 mass % to be configured in a two-layered structure. The coating amount (g/m²) of the organic acid silver of the image forming layer at this step is the same as in Photothermographic material-101. Two Image forming layers were disposed adjacent to each other. The Image forming layer with a high sensitivity was disposed closer to an exposure light source.

Below, the chemical structure of the compounds used in Examples of the invention will be shown.

Spectral sensitizing pigment A

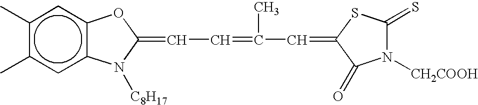

Spectral sensitizing pigment B

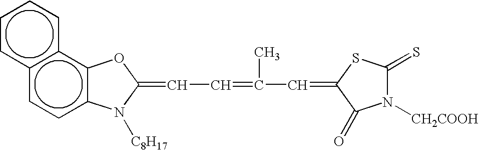

Tellurium sensitizer C

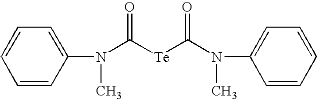

Compound 1 whose one electron oxidized
form produced by one electron oxidation c
an release one or more electrons

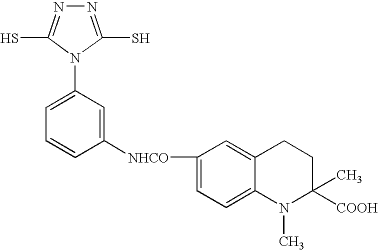

Compound 2 whose one electron oxidized
form produced by one electron oxidation c
an release one or more electrons.

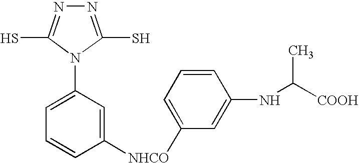

Compound 3 whose one electron oxidized
form produced by one electron oxidation c
an release one or more electrons.

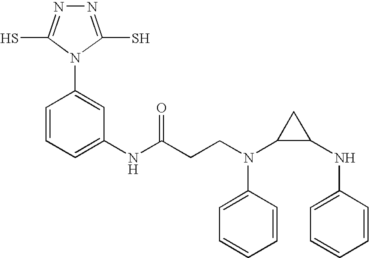

Adsorptive redox compound 1 having an
adsorptive group and a reducing group

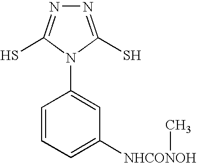

Adsorptive redox compound 2 having an
adsorptive group and a reducing group

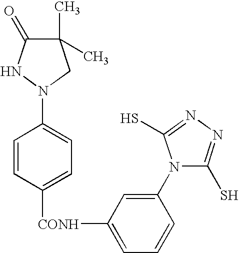

Base precursor compound-1

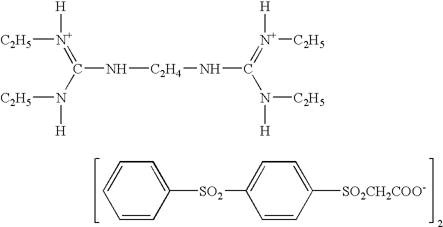

Cyanine dye compound-1

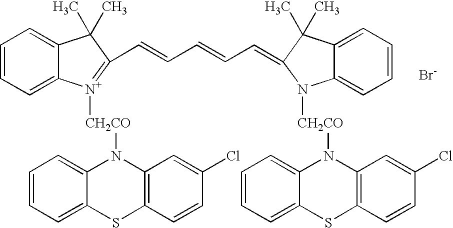

Blue dye compound-1

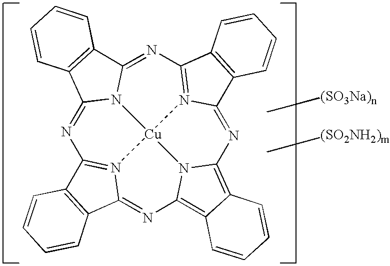

n = 0.5 to 2.0
m = 0.5 to 2.5
(Reducing agent-1)

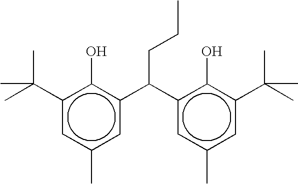

(Reducing agent-2)

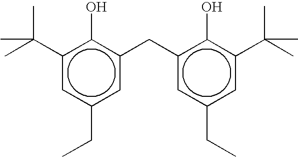

(Organic polyhalogenated compound-1)

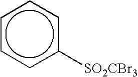

(Organic polyhalogenated compound-2)

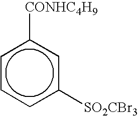

(Mercapto compound-2)

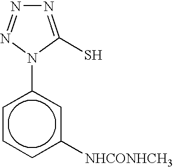

(Hydrogen bonding compound-1)

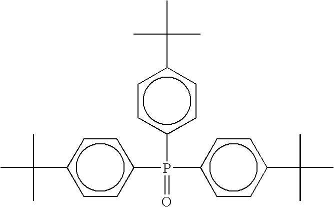

(Phthalazine compound-1)

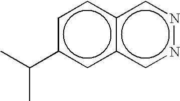

(Development accelerator-1)

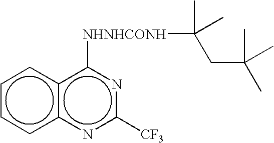

(Development accelerator-2)

| | |
|---|---|
| 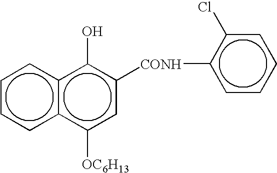 | (F-1) |
| 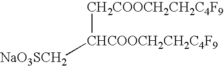 | (F-2) |

(Color tone-adjusting agent-1)

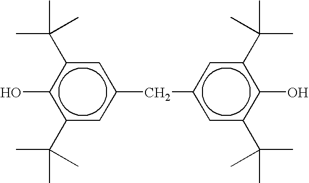

Mixture of

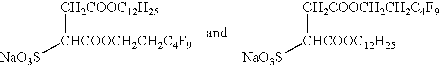

4. Evaluation of Photographic Performance

1) Preparation

Each sample obtained was cut into a size of 14×17-in (43 cm in length×35 cm in width), and each cut sample was packaged in the following packaging material under the environment of 25° C. and 50% RH, and stored at ordinary temperatures for 2 weeks. Then, the following evaluations were carried out.

2) Packaging Material

PET 10 μm/PE 12 μm/aluminum foil 9 μm/Ny 15 μm/3 mass % carbon-containing polyethylene 50 μm

Oxygen permeability: 0.02 ml/atm.m².25° C.day, moisture permeability: 0.10 g/atm.m².25° C.day.

3) Exposure/Development of Photosensitive Material

Photothermographic materials-101 to -111 were subjected to exposure/heat development (by 3 panel heaters respectively set at 107° C. - 121° C.-121° C. for a total of 14 seconds) by means of Dry Laser Imager DRY PIX 7000 from Fuji Film Medical Co., Ltd., (equipped with a 660-nm semiconductor laser with an output of a maximum of 50 mW (IIIB), plate heater type). Each resulting image was evaluated by means of a densitometer.

4) Evaluation of Photographic Performance

<Determination of Image Density (Dmax)>

The resulting images were each determined for the density by means of a Macbeth densitometer, and the characteristic curve of the density versus the logarithm of the exposure amount wIn the case of med, wherein the density of the portion exposed with the maximum exposure amount was taken as Dmax.

<Evaluation of Graininess of Image Quality>

Each sample was subjected to uniform exposure providing a density of 1.0 by means of DRY PIX 7000, so that a heat development treatment was carried out. The resulting sample was visually observed on a Schaukasten, and evaluated for the graininess. The evaluation results are expressed on a 1 to 3 scale of ◯, Δ, and x. The mark ◯ denotes that the graininess is inconspicuous and excellent; Δ, the graininess is a little conspicuous, but presents no problem in image reading and falls within the allowable range; and x, the graininess is remarkably conspicuous, and presents an obstacle in image reading.

The evaluation results are shown in Table 1.

TABLE 1

| | | | | Image Forming Layer | | | | | |
|---|---|---|---|---|---|---|---|---|---|
| Photothermographic | Image Forming Layer | | | (on the support side) | | | | | |
| Material | | Silver Halide Size | | | Silver Halide Size | | | | |
| No. | No. | (μm), | Reducing Agent | No. | (μm) | Reducing Agent | Dmax | Graininess | Remark |
| 101 | 1 | 0.038 | Reducing | — | — | — | 3.46 | Δ | Comparative |
| | | 0.075 | Agent-1 | | (Monolayer) | | | | Example |
| | | 0.028 | | | | | | | |
| 102 | 2 | 0.075 | Reducing | — | — | — | 3.15 | ◯ | Comparative |
| | | | Agent-2 | | (Monolayer) | | | | Example |
| 103 | 3 | 0.038 | Reducing | — | — | — | 4.14 | X | Comparative |
| | | 0.028 | Agent-1 | | (Monolayer) | | | | Example |
| 104 | 2 | 0.075 | Reducing | 3 | 0.038 | Reducing | 4.12 | ◯ | Invention |
| | | | Agent-2 | | 0.028 | Agent-1 | | | |
| 105 | 3 | 0.038 | Reducing | 2 | 0.075 | Reducing | 3.91 | ◯ | Invention |
| | | 0.028 | Agent-1 | | | Agent-2 | | | |
| 106 | 2 | 0.075 | Reducing | 4 | 0.038 | R1 - 1 and | 4.15 | ◯ | Invention |
| | | | Agent-2 | | 0.028 | Reducing Agent-2 | | | |
| | | | | | | (1:1) | | | |
| 107 | 2 | 0.075 | Reducing | 5 | 0.038 | R1 - 13 | 4.08 | ◯ | Invention |
| | | | Agent-2 | | 0.028 | | | | |
| 108 | 2 | 0.075 | Reducing | 6 | 0.038 | R1 - 20 | 4.12 | ◯ | Invention |
| | | | Agent-2 | | 0.028 | | | | |
| 109 | 7 | 0.075 | R - 1 | 3 | 0.038 | Reducing | 4.01 | ◯ | Invention |
| | | | | | 0.028 | Agent-1 | | | |
| 110 | 8 | 0.075 | R - 2 | 3 | 0.038 | Reducing | 4.06 | ◯ | Invention |
| | | | | | 0.028 | Agent-1 | | | |
| 111 | 9 | 0.075 | R - 17 | 3 | 0.038 | Reducing | 4.03 | ◯ | Invention |
| | | | | | 0.028 | Agent-1 | | | |

As shown in Table 1, the samples are the photothermographic materials each including at least two image forming layers disposed therein, and providing an image having a high image density and being excellent in graininess, when in at least the two layers of the image forming layers, at least one layer of the image forming layers is incorporated with the reducing agent represented by the following formula (I), and at least one layer of the other image forming layers is incorporated with the reducing agent represented by the formula (II).

### [Example 2]

(Preparation of PET Support)

In place of coating the undercoating solution formulation (1) on one side of the support and coating the other side with the undercoating solution formulations (2) and (3) for undercoating in the preparation of the PET support of Example 1, both the sides were coated with the undercoating solution formulation (1) in a wet coating amount of 6.6 ml/m² (per side), and dried at 180° C. for 5 minutes. Thus, the undercoated support was prepared.

(Back Layer)

In Example 1, the back layer was provided, but in Example 3, no back layer was provided.

(Image Forming Layer, Intermediate Layer, and Surface Protective Layer)

2. Preparation of Materials for Coating

1) Silver Halide Emulsion

<<Preparation of Silver Halide Emulsion A>>

To 1421 ml of distilled water, 4.3 ml of a 1 mass % potassium iodide solution was added, and further, 3.5 ml of 0.5 mol/L sulfuric acid, 36.5 g of phthalated gelatin, and 160 ml of a 5 mass % methanol solution of 2,2′-(ethylenedithio)diethanol were added. The resulting solution was kept at a temperature of 75° C. with stirring in a reaction jar made of stainless steel. Solution A was prepared by diluting 22.22 g of silver nitrate with the addition of distilled water to 218 ml, and Solution B was prepared by diluting 36.6 g of potassium iodide with the addition of distilled water to a volume of 366 ml. The whole amount of Solution A was added thereto at a constant flow rate over 16 minutes. Solution B was added thereto while keeping the pAg at 10.2 with a controlled double jet method. Then, 10 ml of a 3.5 mass % hydrogen peroxide aqueous solution was added thereto, and further, 10.8 ml of a 10 mass % aqueous solution of benzimidazole was added thereto. Further, Solution C was prepared by diluting 51.86 g of silver nitrate with the addition of distilled water to 508.2 ml, and Solution D was prepared by diluting 63.9 g of potassium iodide to a volume of 639 ml with distilled water. The whole amount of Solution C was added at a given flow rate over 80 minutes. Whereas, Solution D was added while keeping the pAg at 10.2 with a controlled double jet method. Potassium hexachloroiridate (III) was added in an amount of 1×10⁻⁴ mol per mole of silver all at once after 10 minutes from the start of addition of Solutions C and D. Whereas, an aqueous solution of potassium iron (II) hexacyanide was added in an amount of 3×10⁻⁴ mol per mole of silver all at once after 5 seconds from the completion of addition of Solution C. The pH was adjusted to 3.8 using a sulfuric acid with a concentration of 0.5 mol/L, and stirring was stopped. Then, steps of sedimentation/desalting/washing with water were carried out. The resulting mixture was adjusted to a pH of 5.9 with sodium hydroxide with a concentration of 1 mol/L. Thus, a silver halide dispersion with a pAg of 11.0 was prepared.

Silver halide emulsion A was a pure silver iodide emulsion. The tabular grains having a mean projection area diameter of 0.93 μm, a variation coefficient of the mean projection area diameter of 17.7%, a mean thickness of 0.057 μm, and a mean aspect ratio of 16.3 accounted for 80% or more of the whole projection area. The sphere equivalent diameter was 0.42 μm. The results of an X-ray powder diffraction analysis indicated that 90% or more of the silver iodide was present in the γ phase form.

<<Preparation of Silver Halide Emulsion B>>

One mole of a tabular grain AgI emulsion prepared with Silver halide emulsion A was placed in a reaction vessel. The pAg was measured at 38° C., and found to be 10.2. Then, by double jet addition, a 0.5 mol/l KBr solution and a 0.5 mol/l AgNO₃ solution were added at 10 ml/min over 20 minutes, thereby to substantially precipitate a 10 mol % silver bromide in the epitaxial form on a AgI host emulsion. During the operation, the pAg was maintained at 10.2. Further, the pH was adjusted to 3.8 using a sulfuric acid with a concentration of 0.5 mol/L, and stirring was stopped. Then, steps of sedimentation/desalting/washing with water were carried out. The resulting mixture was adjusted to a pH of 5.9 with sodium hydroxide with a concentration of 1 mol/L. Thus, a silver halide dispersion with a pAg of 11.0 was prepared.

The silver halide dispersion was kept at 38° C. with stirring, to which was added 5 ml of a 0.34 mass % methanol solution of 1,2-benzisothiazolin-3-one, and the mixture was heated to 47° C. after 40 minutes. After 20 minutes from the heating, sodium benzenethiosulfonate was added in an amount of 7.6×10⁻⁵ mol per mole of silver in the form of methanol solution. Further, after 5 minutes, Tellurium sensitizer C was added thereto in an amount of 2.9×10⁻⁵ mol per mole of silver in the form of methanol solution, followed by ripening for 91 minutes. Then, 1.3 ml of a 0.8 mass % methanol solution of N,N′-dihydroxy-N″-diethylmelamine was added thereto, and after another 4 minutes, thereto were added 5-methyl-2-mercaptobenzimidazole in the form of methanol solution in an amount of 4.8×10⁻³ mol per mole of silver, 1-phenyl-2-heptyl-5-mercapto-1,3,4-triazole in the form of methanol solution in an amount of 5.4×10⁻³ mol per mole of silver, and 1(3-methylureidophenyl)-5-mercaptotetrazole in the form of aqueous solution in an amount of 8.5×10⁻³ mol per mole of silver. As a result, Silver halide emulsion B was prepared.

<<Preparation of Silver Halide Emulsion C>>

Silver halide emulsion C was prepared in the same manner as with Silver halide emulsion A, except for appropriately changing the amount of the 5 mass % methanol solution of 2,2′-(ethylenedithio)diethanol to be added, the temperature for grain formation, and the addition time of Solution A. Silver halide emulsion C was a pure silver iodide emulsion. The tabular grains having a mean projection area diameter of 1.369 μm, a variation coefficient of the mean projection area diameter of 19.7%, a mean thickness of 0.130 μm, and a mean aspect ratio of 11.1 accounted for 80% or more of the whole projection area. The sphere equivalent diameter was 0.71 μm. The results of an X-ray powder diffraction analysis indicated that 90% or more of the silver iodide was present in the γ phase form.

<<Preparation of Silver Halide Emulsion D>>

Silver halide emulsion D containing a silver bromide epitaxial in an amount of 10 mol % was prepared entirely in the same manner as with Silver halide emulsion B, except that Silver halide emulsion C was used.

<<Preparation of Mixed Emulsion B for Coating Solution>>

To Silver halide emulsion B, benzothiazolium iodide was added in the form of a 1 mass % aqueous solution in an amount of 7×10⁻³ mol per mole of silver.

Further, Compounds 1, 2, and 3 capable of being one-electron oxidized to become a one-electron oxidation product, and releasing one electron or more electrons were each added in an amount of 2×10⁻³ mol per mole of silver of the silver halide.

Compounds 1 and 2 having an adsorbing group and a reducing group were each added in an amount of 8×10⁻³ mol per mole of silver of the silver halide.

Further, water was added so that the content of the silver halide per liter of the mixed emulsion for coating solution became 15.6 g as silver.

<<Preparation of Mixed Emulsion D for Coating Solution>>

Mixed emulsion D for coating solution was prepared in the same manner as with the preparation of Mixed emulsion B for coating solution, except that Silver halide emulsion D was used in place of Silver halide emulsion B.

<<Preparation of Other Additives>>

The other additives in the image forming layer, the intermediate layer, and the surface protective layer were prepared in the same manner as in Example 1.

2. Preparation of Coating Solution

1) Preparation of Image Forming Layer Coating Solution

<<Preparation of Image Forming Layer Coating Solution-10>> (Coating Solution for Monolayer)

To 1000 g of the fatty acid silver dispersion B obtained above and 276 ml of water, Organic polyhalogen compound-1 dispersion, Organic polyhalogen compound-2 dispersion, a SBR latex (Tg: 17° C.) solution, Reducing agent-1 dispersion, Reducing agent-2 dispersion, Hydrogen bonding compound-1 dispersion, Development accelerator-1 dispersion, Development accelerator-2 dispersion, Tone modifier-1 dispersion, Mercapto compound-1 aqueous solution, and Mercapto compound-2 aqueous solution were successively added. Then, a silver iodide complex forming agent was added thereto. Then, immediately before coating, to the resulting mixture, Mixed emulsions B and D for coating solution of silver halide were added in a ratio of 1:1 and in an amount of 0.22 mol per mole of a fatty acid silver in terms of silver, and well mixed. The resulting solution was fed as it was to a coating die.

<<Preparation of Image Forming Layer Coating Solution-11>> (Coating Solution for Low Sensitivity Layer)

Image forming layer coating solution-1 was prepared entirely in the same manner as with Image forming layer coating solution-10, except that Reducing agents-1 and -2 dispersions were all changed to Reducing agent-1 dispersion, and the silver halide was all changed to Mixed emulsion B for coating solution for Image forming layer coating solution-10.

<<Preparation of Image Forming Layer Coating Solution-12>> (Coating Solution for High Sensitivity Layer)

Image forming layer coating solution-12 was prepared entirely in the same manner as with Image forming layer coating solution-10, except that Reducing agents-1 and -2 dispersions were all changed to Reducing agent-2 dispersion, and the silver halide was all changed to Mixed emulsion D for coating solution for Image forming layer coating solution-10.

The viscosity of the image forming layer coating solution was determined by means of a B-model viscometer from Tokyo Instrument Co., Ltd., and was found to fall within the range of 20 to 30 [mPa.s] at 40° C. (No. 1 rotor, 60 rpm).

The viscosities of the coating solution at 25° C. determined by means of a RFS fluid spectrometer produced by Rheometrics Far East Co., Ltd., fall within the range of ±10% from 242, 65, 48, 26, and 20 [mPa.s] at shear rates of 0.1, 1, 10, 100, and 1000 [1/sec], respectively.

The amount of zirconium in the coating solution was within the range of 0.4 to 6 mg per gram of silver.

2) Preparation of Intermediate Layer Coating Solution-2

To 1000 g of polyvinyl alcohol PVA-205 (manufactured by Kuraray Co., Ltd.), and 4200 ml of a 19 mass % solution of methyl methacrylate/styrene/butyl acrylate/hydroxyethyl methacrylate/acrylic acid copolymer (copolymerization weight ratio 64/9/20/5/2) latex, 27 ml of a 5 mass % aqueous solution of Aerosol OT (manufactured by American Cyanamide Co.), and 135 ml of a 20 mass % aqueous solution of diammonium phthalate were added, and water was added to make the total amount 10000 g. The mixture was adjusted to pH 7.5 with NaOH, resulting in an intermediate layer coating solution. The solution was fed to a coating die so as to achieve 9.1 ml/m².

The viscosity of the coating solution was determined by means of a B-model viscometer, and found to be 58 [mPa.s] at 40° C. (No. 1 rotor, 60 rpm).

3) Preparation of Surface Protective-Layer First Layer Coating Solution-2

64 g of inert gelatin was dissolved in water. To the resulting solution, 112 g of a 19.0 mass % solution of methyl methacrylate/styrene/butyl acrylate/hydroxyethyl methacrylate/acrylic acid copolymer (copolymerization weight ratio 64/9/20/5/2) latex, 30 ml of a 15 mass % methanol solution of phthalic acid, 23 ml of a 10 mass % aqueous solution of 4-methylphthalic acid, 28 ml of sulfuric acid with a concentration of 0.5 ml/L, 5 ml of a 5 mass % aqueous solution of Aerosol OT (manufactured by American Cyanamide Co.), 0.5 g of phenoxy ethanol, and 0.1 g of benzisothiazolinone were added. To the mixture, water was added to make the total amount 750 g, resulting in a coating solution. 26 ml of 4 mass % chrome alum was mixed therein by a static mixer immediately before coating. The resulting mixture was fed to a coating die so as to achieve 18.6 ml/m². The viscosity of the coating solution was determined by means of a B-model viscometer, and found to be 20 [mPa.s] at 40° C. (No. 1 rotor, 60 rpm).

3. Preparation of Photothermographic Material

1) Preparation of Photothermographic Material-201

On the one side (side A), Image forming layer coating solution-10, Intermediate layer coating solution-2, Surface protective layer first layer coating solution-2, and Surface protective layer second layer coating solution-2 were simultaneously coated in multilayer by a slide bead coating process in this order from the undercoated surface. At this step, the image forming layer coating solution and the intermediate layer coating solution were temperature controlled to 31° C.; the surface protective layer first layer coating solution, 36° C.; and the surface protective layer second layer coating solution, 37° C. The amount (g/m²) of silver coated in the image forming layer was 0.821 g/m² in terms of the total amount of fatty acid silver and silver halide per side.

On the other side (side B), Image forming layer coating solution-10, Intermediate layer coating solution-2, Surface protective layer first layer coating solution-2, and Surface protective layer second layer coating solution-2 were simultaneously coated in multilayer by a slide bead coating process in this order from the undercoated surface.

The coating amount (g/m²) of each compound per side of the image forming layer at this step is as follows.

| | |
|---|---|
| Fatty acid silver | 2.80 |
| Polyhalogen compound-1 | 0.028 |
| Polyhalogen compound-2 | 0.094 |
| Silver iodide complex forming agent | 0.46 |
| SBR latex | 5.20 |
| Reducing agent-1 | 0.23 |
| Reducing agent-2 | 0.23 |
| Hydrogen bonding compound-1 | 0.15 |
| Development accelerator-1 | 0.005 |
| Development accelerator-2 | 0.035 |
| Tone modifier-1 | 0.002 |
| Mercapto compound-1 | 0.001 |
| Mercapto compound-2 | 0.003 |
| Silver halide (in terms of Ag) | 0.146 |

The coating and drying conditions were as follows.

The coating was carried out at a speed of 160 m/min., and the clearance between the tip of the coating die and the support was set at 0.10 to 0.30 mm. The pressure in a reduced pressure chamber was set at a pressure lower than atmospheric pressure by 196 to 882 Pa. Electrostatic charges were eliminated from the support by ionic air before coating.

In a subsequent chilling zone, the coating solutions were cooled by air having a dry-bulb temperature of 10 to 20° C., followed by non-contact type transfer. Then, the sample was dried by dry air having a dry-bulb temperature of 23 to 45° C., and a wet-bulb temperature of 15 to 21° C. in a helical type contactless drying apparatus.

After drying, the sample was subjected to moisture conditioning at 25° C. and humidify 40% to 60% RH, and then, heated so that the temperature of the film surface was elevated to 70 to 90° C. After heating, the film surface was cooled to 25° C.

2) Preparation of Photothermographic Materials-202 and -203

Photothermographic materials-202 and -203 were manufactured in the same manner as with the preparation of Photothermographic material-201, except that in place of Image forming layer coating solution-10, Image forming layer coating solutions-11 and -12 were respectively coated in a coating amount of 50 mass % of Image forming layer-4, simultaneously in multilayer between the undercoated surface and the intermediate layer (i.e., coated so that both sides have each two image forming layers).

3) Preparation of Photothermographic Material-204

Photothermographic material-204 was manufactured in the same manner as with the preparation of Photothermographic material-201, except that Image forming layer coating solution-11 in place of Image forming layer coating solution-10 on the front side and Image forming layer coating solution-12 in place of Image forming layer coating solution-10 on the back side were respectively coated between the undercoated side and the intermediate layer (i.e., front side has one image forming layer, and back side has another image forming layer. Thus Photothermographic material-204 has two image forming layers).

4. Evaluation of Photographic Performance

Each sample obtained was cut into a size of 14×17-in (43 cm in length×35 cm in width), and each cut sample was packaged in the following packaging material under the environment of 25° C. and 50% RH, and stored at ordinary temperatures for 2 weeks. Then, the following evaluations were carried out.

(Packaging Material)

PET 10 μm /PE 12 μm/aluminum foil 9 μm /Ny 15 μm/3 mass % carbon-containing polyethylene 50 μm

Oxygen permeability: 0.02 ml/atm.m².25° C.day, moisture permeability: 0.10 g/atm.m².25° C.day.

The double-sided coated photosensitive material prepared in this manner was evaluated in the following manner.

Two X-ray regular screens HI-SCREEN B3 (using CaWO₄ as a phosphor; emission peak wavelength 425 nm) manufactured by Fuji Photo film Co., Ltd., were used. The sample was interposed therebetween, thereby to form an assembly for image formation. To the assembly, 0.05-second X-ray exposure was applied to carry out X-ray sensitometry. The X-ray device used was DRX-3724HD manufactured by Toshiba Corporation, and a tungsten target was used. A voltage of 80 kVp was applied in three phases by means of a pulse generator. The X ray which had been allowed to pass through a 7-cm water filter having an absorption roughly equivalent with a human body was used as a light source. Light exposure was carried out so as to achieve the density of 1.2 by changing the distance. After exposure, a heat development treatment was carried out under the following heat development treatment conditions. The evaluation of the obtained image was carried out by means of a densitometer.

Photothermographic materials-201 to -203 subjected to screen exposure were developed for 24 seconds by means of a dry laser imager FM-DP-L manufactured by Fuji Film Medical Co., Ltd., with the laser output set at OFF. Further, the heat development unit of FM-DP-L was changed to a drum type heat development unit, so that development was carried out at 116° C. for 24 seconds. In the drum type heat development unit used, the diameter of the drum is 320 mm, and the drum surface with which a film comes in contact is covered with a 0.5-mm thick fluorocarbon rubber. As the transfer roller, a roller made of stainless steel and with a diameter of 12 mm was used.

Further, the heat development unit was changed to a heat development unit composed of zigzag heating rollers, so that development was carried out at 123° C. for 24 seconds. The zigzag heating rollers used were the rollers composed of metal rollers made of stainless steel and with a diameter of 12 mm, and coated with a 0.5-m fluorocarbon rubber thereon.

The method of evaluation of photographs is the same as in Example 1. The results are shown in Table 2.

TABLE 2

| Photothermographic | | Silver halide size | | | Silver halide size | | | | |
|---|---|---|---|---|---|---|---|---|---|
| material | | (μm) | Reducing agent | | (μm) | Reducing agent | Dmax | Graininess | Remarks |
| | Image forming layer | | | Image forming layer (on the support side) | | | | | |
| 201 | 10 | 0.42 | Reducing agent-1 | — | — | — | 3.22 | X | Comparative |
| | | 0.71 | Reducing agent-2 | | (monolayer) | | | | |
| 202 | 12 | 0.71 | Reducing agent-2 | 11 | 0.42 | Reducing agent-1 | 3.64 | ◯ | Invention |
| 203 | 11 | 0.42 | Reducing agent-1 | 12 | 0.71 | Reducing agent-2 | 3.38 | Δ | Invention |
| | Image forming layer (front side) | | | Image forming layer (back side) | | | | | |
| 204 | 12 | 0.71 | Reducing agent-2 | 11 | 0.42 | Reducing agent-1 | 3.55 | ◯ | Invention |

As shown in Table 2, also when the samples are the photosensitive materials each including image forming layers on both side of the support, they are the photothermographic materials each including at least two image forming layers disposed therein, and providing an image having a high image density and being excellent in graininess, when in at least the two layers of the image forming layers, at least one layer of the image forming layers is incorporated with the reducing agent represented by the following formula (I), and at least one layer of the other image forming layers is incorporated with the reducing agent represented by the formula (II).

1. A photothermographic material, comprising: a support; and image forming layers containing a photosensitive silver halide, a non-photosensitive organic silver salt, a reducing agent, and a binder, provided on the support, wherein:
the number of the image forming layers provided is at least two,
different layers of the image forming layers each independently contain a different reducing agent,
at least one layer of the image forming layers contains a reducing agent represented by the following formula (I); and
at least one layer of the other image forming layers contains a reducing agent represented by the following formula (II): 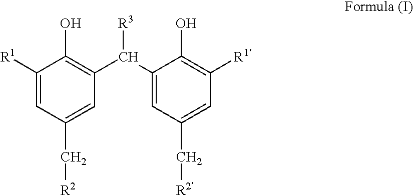
where in the formula (I), R¹ and R^{1′} each independently represent a secondary or tertiary alkyl group having 3 to 20 carbon atoms; R² and R^{2′} each independently represent hydrogen atom or a group linked via a nitrogen, oxygen, phosphorus, or sulfur atom; and R³ denotes hydrogen atom or an alkyl group having 1 to 20 carbon atoms: 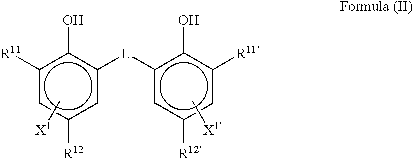
where in the formula (II), R¹¹ and R^{11′} each independently represent an alkyl group having 1 to 20 carbon atoms; R¹² and R^{12′} each independently represent hydrogen atom or a substituent substitutable on a benzene ring; L represents an —S— group or a —CHR¹³— group; R¹³ represents hydrogen atom or an alkyl group having 1 to 20 carbon atoms; and X¹ and X^{1′} each independently represent hydrogen atom or a group substitutable on a benzene ring.

2. The photothermographic material according to claim 1, wherein:
at least two layers of the image forming layers are a low sensitivity layer and a high sensitivity layer having different sensitivities,
the low sensitivity layer and the high sensitivity layer each independently contain a different reducing agent,
the low sensitivity layer contains the reducing agent represented by the formula (I); and
the high sensitivity layer contains the reducing agent represented by the formula (II).

3. The photothermographic material according to claim 1, further comprising a development accelerator.

4. The photothermographic material according to claim 2, further comprising a development accelerator.

5. The photothermographic material according to claim 1, further comprising a polyhalogen compound.

6. The photothermographic material according to claim 2, further comprising a polyhalogen compound.

7. The photothermographic material according to claim 1, wherein the photosensitive silver halide contains silver iodide in an amount of 40 mol % or more to 100 mol % or less.

8. The photothermographic material according to claim 1, wherein 50% or more of the photosensitive silver halide in a projected area are tabular grains with an aspect ratio of 2 or more.

9. The photothermographic material according to claim 1, wherein the image forming layers are provided on both sides of the support.

10. The photothermographic material according to claim 2, wherein the difference in sensitivity between the low sensitivity layer and the high sensitivity layer is 2 times or more to 15 times or less.

11. The photothermographic material according to claim 2, wherein the high sensitivity layer is provided closer to an exposure light source than the low sensitivity layer.

12. The photothermographic material according to claim 2, wherein the grain size of the silver halide grains contained in the low sensitivity layer is smaller than the grain size of the silver halide grains contained in the high sensitivity layer.

13. The photothermographic material according to claim 1, where in the formula (I), R¹ and R^{1′} each represent ter-butyl, R² and R^{2′} each represent hydrogen atom, and R¹³ represents hydrogen atom, methyl, ethyl, propyl, or isopropyl.

14. The photothermographic material according to claim 2, where in the formula (I), R¹ and R^{1′} each represent tert-butyl, R² and R^{2′} each represent hydrogen atom, and R¹³ represents hydrogen atom, methyl, ethyl, propyl, or isopropyl.
